(19) United States
(12) Patent Application Publication
(10) Pub. No.: US 2024/0404189 A1
(43) Pub. Date: Dec. 5, 2024

(54) Devices, Methods, and Graphical User Interfaces for Viewing and Interacting with Three-Dimensional Environments

(71) Applicant: Apple Inc., Cupertino, CA (US)

(72) Inventors: James J. Owen, San Francisco, CA (US); Miquel Estany Rodriguez, San Francisco, CA (US); William A. Sorrentino, III, Mill Valley, CA (US)

(21) Appl. No.: 18/676,171

(22) Filed: May 28, 2024

Related U.S. Application Data
(60) Provisional application No. 63/470,785, filed on Jun. 2, 2023.

(51) Int. Cl. G06T 15/60; G06F 3/04845; G06T 19/00

(52) U.S. Cl. CPC G06T 15/60; G06F 3/04845; G06T 19/006

(57) ABSTRACT

While a view of a three-dimensional environment is visible, a computer system displays a user interface object with a first orientation in the three-dimensional environment and displays a simulated shadow, corresponding to the user interface object, at a first shadow position in the three-dimensional environment. The simulated shadow at the first shadow position has a first spatial relationship to the user interface object. In response to detecting a user input directed to the user interface object, the computer system changes an orientation of the user interface object from the first orientation to a different, second orientation, including: displaying the user interface object with the second orientation; and displaying the simulated shadow at a second shadow position in the three-dimensional environment, different from the first shadow position, at which the simulated shadow has a second spatial relationship to the user interface object that is different from the first spatial relationship.

### RELATED APPLICATIONS

This application claims priority to U.S. Provisional Patent Application No. 63/470,785, filed Jun. 2, 2023, which is hereby incorporated by reference in its entirety.

### TECHNICAL FIELD

The present disclosure relates generally to computer systems that are in communication with a display generation component and one or more sensors, and optionally one or more input devices, that provide computer-generated experiences, including, but not limited to, electronic devices that provide virtual reality and mixed reality experiences via a display.

### BACKGROUND

The development of computer systems for augmented reality has increased significantly in recent years. Example augmented reality environments include at least some virtual elements that replace or augment the physical world. Input devices, such as cameras, controllers, joysticks, touch-sensitive surfaces, and touch-screen displays for computer systems and other electronic computing devices are used to interact with virtual/augmented reality environments. Example virtual elements include virtual objects, such as digital images, video, text, icons, and control elements such as buttons and other graphics.

### SUMMARY

While advancements have been made in the accuracy and visual fidelity of virtual reality and augment reality environments (e.g., to simulate real-world physics and/or real-world lighting effects), less attention has been given to modifying virtual and/or augmented reality environments to have nonintuitive behavior (e.g., behaviors that do not reflect real-world behavior of objects, lights, and/or shadows) that can be leveraged to increase device performance, to increase the level of immersion, and/or to preserve visual clarity of displayed virtual content. For example, highly accurate simulations of real-world lighting effects, such as light reflections and shadows, can result in large reflection effects (e.g., along the entire length of a border of a user interface window) which reduce visibility (e.g., because based on real-world lighting, the displayed reflection would be too bright for comfortable viewing) and can cause (e.g., or magnify and/or accentuate) performance issues or hardware limitations (e.g., distortion artifacts and/or aliasing, based on technical and/or physical limitations of a display generation component of a computer system). Leveraging nonintuitive behaviors (e.g., for light sources and/or visual effects such as reflections and shadows) allows the computer system to maintain visibility of displayed content while minimizing the effects of performance and/or hardware limitations. For example, visual effects such as reflections can be removed from certain regions (e.g., to prevent a reflection from being displayed along an entire edge or side of a user interface), but can also retain some behaviors which follow real-world lighting (e.g., the reflections change in position and/or size, as the user interface is moved and/or the viewpoint of the user changes). This allows for balancing between high performance and visual clarity (e.g., by avoiding or eliminating performance issues, and/or compensating for hardware limitation, by including unintuitive behaviors which do not reflect real-world behavior of objects, lights, and/or shadows), while maintaining a baseline level of immersion (e.g., by retaining some behaviors that are intuitive and are consistent with real-world behavior of objects, lights, and/or shadows).

Accordingly, there is a need for computer systems with improved methods and interfaces for providing computer-generated experiences to users that make viewing extended reality environments and interacting with the computer systems more efficient and intuitive for a user. Such methods and interfaces optionally complement or replace conventional methods for providing extended reality experiences to users. Such methods and interfaces reduce the number, extent, and/or nature of the inputs from a user by helping the user to understand the connection between provided inputs and device responses to the inputs, thereby creating a more efficient human-machine interface.

The above deficiencies and other problems associated with user interfaces for computer systems are reduced or eliminated by the disclosed systems. In some embodiments, the computer system is a desktop computer with an associated display. In some embodiments, the computer system is portable device (e.g., a notebook computer, tablet computer, or handheld device). In some embodiments, the computer system is a personal electronic device (e.g., a wearable electronic device, such as a watch, or a head-mounted device). In some embodiments, the computer system has a touchpad. In some embodiments, the computer system has one or more cameras. In some embodiments, the computer system has a touch-sensitive display (also known as a “touch screen” or “touch-screen display”). In some embodiments, the computer system has one or more eye-tracking components. In some embodiments, the computer system has one or more hand-tracking components. In some embodiments, the computer system has one or more output devices in addition to the display generation component, the output devices including one or more tactile output generators and/or one or more audio output devices. In some embodiments, the computer system has a graphical user interface (GUI), one or more processors, memory and one or more modules, programs or sets of instructions stored in the memory for performing multiple functions. In some embodiments, the user interacts with the GUI through a stylus and/or finger contacts and gestures on the touch-sensitive surface, movement of the user's eyes and hand in space relative to the GUI (and/or computer system) or the user's body as captured by cameras and other movement sensors, and/or voice inputs as captured by one or more audio input devices. In some embodiments, the functions performed through the interactions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a transitory and/or non-transitory computer readable storage medium or other computer program product configured for execution by one or more processors.

There is a need for electronic devices with improved methods and interfaces for viewing and interacting with a three-dimensional environment. Such methods and interfaces may complement or replace conventional methods for viewing and interacting with a three-dimensional environment. Such methods and interfaces reduce the number, extent, and/or the nature of the inputs from a user and produce a more efficient human-machine interface. For battery-operated computing devices, such methods and interfaces conserve power and increase the time between battery charges.

In accordance with some embodiments, a method is performed at a computer system that is in communication with a display generation component and one or more sensors. The method includes displaying, via the display generation component, a first view of a three-dimensional environment, the first view of the three-dimensional environment including a first user interface at a first position in the three-dimensional environment. The first user interface is displayed with a first simulated lighting effect at a first location on the first user interface. The first location is a location within a first subregion of the first user interface. The method includes detecting an event corresponding to movement of the first user interface; and, in response to detecting the event, moving the first user interface from the first position in the three-dimensional environment to a second position in the three-dimensional environment. Moving the first user interface includes: in accordance with a determination that a distance between the first position and the second position is less than a threshold distance, displaying the first user interface with a second simulated lighting effect at a second location on the first user interface, wherein the second location is different from the first location on the first user interface and wherein the second location is within the first subregion of the first user interface; and, in accordance with a determination that the distance between the first position and the second position is at least the threshold distance, displaying the first user interface with a third simulated lighting effect at a third location on the first user interface. The third location on the first user interface is different from the first location on the first user interface and the second location on the first user interface. The third location is within a second subregion of the first user interface. The second subregion of the first user interface is different from the first subregion of the first user interface; and the first user interface includes a third subregion, between the first and second subregions of the first user interface, wherein the third subregion is a region in which a simulated lighting effect is not displayed when the first user interface is stationary relative to the three-dimensional environment.

In accordance with some embodiments, a method is performed at a computer system that is in communication with a display generation component and one or more sensors. The method includes displaying, via the display generation component, a first user interface in a first view of a three-dimensional environment. The first user interface has a simulated three-dimensional effect while the first view of the three-dimensional environment is visible, and the first user interface has a first spatial relationship to a viewpoint of a user. The method includes detecting an input corresponding to a request to change the viewpoint of the user to have a second spatial relationship to the first user interface. The second spatial relationship is different from the first spatial relationship, and a first portion of the input corresponds to a respective amount of change in the viewpoint and a second portion that follows the first portion corresponds to the respective amount of change in the viewpoint. The method includes, in response to detecting the first portion of the input: displaying a second view of the three-dimensional environment different from the first view of the three-dimensional environment; and changing the simulated three-dimensional effect by a first amount. The method includes, in response to detecting the second portion of the input: displaying a third view of the three-dimensional environment that is different from the first view of the three-dimensional environment and from the second view of the three-dimensional environment; and changing the simulated three-dimensional effect by a second amount, wherein the second amount is different from the first amount.

In accordance with some embodiments, a method is performed at a computer system that is in communication with a display generation component and one or more sensors. The method includes, while a first view of a three-dimensional environment is visible via the display generation component, displaying a first user interface object with a first orientation and at a first object position in the three-dimensional environment, and displaying a first simulated shadow, corresponding to the first user interface object, at a first shadow position in the three-dimensional environment. The first simulated shadow at the first shadow position has a first spatial relationship to the first user interface object. The method includes detecting a user input directed to the first user interface object. The method includes, in response to detecting the user input, changing an orientation of the first user interface object from the first orientation to a second orientation, including: displaying the first user interface object with the second orientation; and displaying the first simulated shadow at a second shadow position in the three-dimensional environment. The second shadow position in the first view of the three-dimensional environment is different from the first shadow position in the first view of the three-dimensional environment. The first simulated shadow at the second shadow position has a second spatial relationship to the first user interface object; and the second spatial relationship is different from the first spatial relationship.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating an operating environment of a computer system for providing extended reality (XR) experiences in accordance with some embodiments.

FIGS. 1B-1P are examples of a computer system for providing XR experiences in the operating environment of FIG. 1A.

FIG. 2 is a block diagram illustrating a controller of a computer system that is configured to manage and coordinate an XR experience for the user in accordance with some embodiments.

FIG. 3 is a block diagram illustrating a display generation component of a computer system that is configured to provide a visual component of the XR experience to the user in accordance with some embodiments.

FIG. 4 is a block diagram illustrating a hand tracking unit of a computer system that is configured to capture gesture inputs of the user in accordance with some embodiments.

FIG. 5 is a block diagram illustrating an eye tracking unit of a computer system that is configured to capture gaze inputs of the user in accordance with some embodiments.

FIG. 6 is a flow diagram illustrating a glint-assisted gaze tracking pipeline in accordance with some embodiments.

FIGS. 7A-7L illustrate example techniques for changing displayed visual effects as user interfaces and/or user interface elements are repositioned and/or as a viewpoint of a user relative to the user interfaces and/or user interface elements is changed, in accordance with some embodiments.

FIGS. 8A-8M illustrate example techniques for repositioning a shadow corresponding to a user interface as the user interface is reoriented, in accordance with some embodiments.

FIG. 9 is a flow diagram of methods of updating display of visual effects as user interfaces and/or user interface elements are repositioned, in accordance with various embodiments.

FIG. 10 is a flow diagram of methods of updating display of visual effects applied to a user interface and/or user interface element, as a viewpoint of a user is changed, in accordance with various embodiments.

FIG. 11 is a flow diagram of methods of repositioning a shadow corresponding to a user interface as the user interface is reoriented, in accordance with various embodiments.

### DESCRIPTION OF EMBODIMENTS

The present disclosure relates to user interfaces for providing an extended reality (XR) experience to a user, in accordance with some embodiments.

The systems, methods, and GUIs described herein improve user interface interactions with virtual/augmented reality environments in multiple ways.

In some embodiments, a computer system displays a first user interface with a first simulated lighting effect in a first subregion of the first user interface. In response to detecting movement of the first user interface, the computer system moves the first user interface and displays a respective simulated lighting effect in either the first subregion of the first user interface, or a second subregion of the first user interface that is separated from first subregion by a third subregion, depending on an amount of movement of the first user interface. Conditionally displaying the first user interface with a visual effect in a respective subregion provides improved visual feedback about the spatial relationship between the user interface and the three-dimensional environment, which improves the user's context awareness of the three-dimensional environment and improves user physiological comfort by avoiding physiological discomfort associated with physical motion of the user that is not matched with environmental response in an a three-dimensional environment that is visible to the user, and also avoids displaying visual effects (e.g., simulated lighting effects) in a manner that can cause visual artifacts and/or aliasing on the display of the computer system.

In some embodiments, a computer system displays a first user interface with a simulated three-dimensional effect. In response to detecting a change in viewpoint of a user, the computer system changes the simulated three-dimensional effect by a first amount during a first portion of the change in viewpoint, and changes the simulated three-dimensional effect by a second amount different from the first amount during a second portion of the change in viewpoint. Changing the simulated three-dimensional effect by different amounts (e.g., progressively less or more) as the movement of the viewpoint relative to the user interface progresses causes the computer system to automatically provide visual feedback about the spatial relationship between the user interface and the three-dimensional environment and, in the case of moving the simulated three-dimensional effect progressively less as the movement of the viewpoint progresses, reduces motion and parallax in the three-dimensional environment, which improves the user's context awareness of the three-dimensional environment and reduces the likelihood of motion sickness when using the computer system.

In some embodiments, a computer system displays a simulated shadow that has a first spatial relationship to a user interface object. In response to detecting a change in orientation of the user interface object, the computer system displays the user interface object with an updated orientation, and displays the simulated shadow with a second spatial relationship, different from the first spatial relationship, to the user interface object. Changing a spatial relationship between the simulated shadow and the user interface object in accordance with changes in the orientation of the user interface object relative to the three-dimensional environment, provides improved visual feedback about the spatial relationship between the user interface object and the three-dimensional environment, which improves the user's context awareness of the three-dimensional environment and improves user physiological comfort by avoiding physiological discomfort associated with physical motion of the user that is not matched with environmental response in an a three-dimensional environment that is visible to the user.

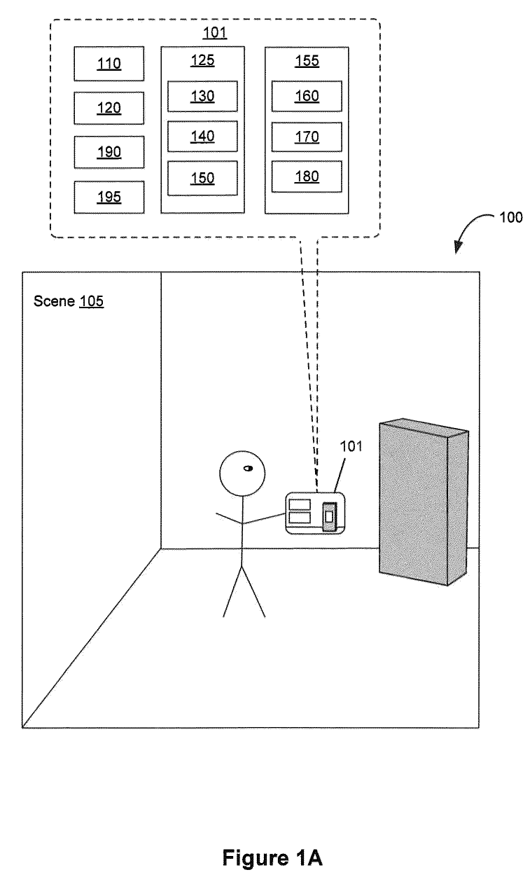

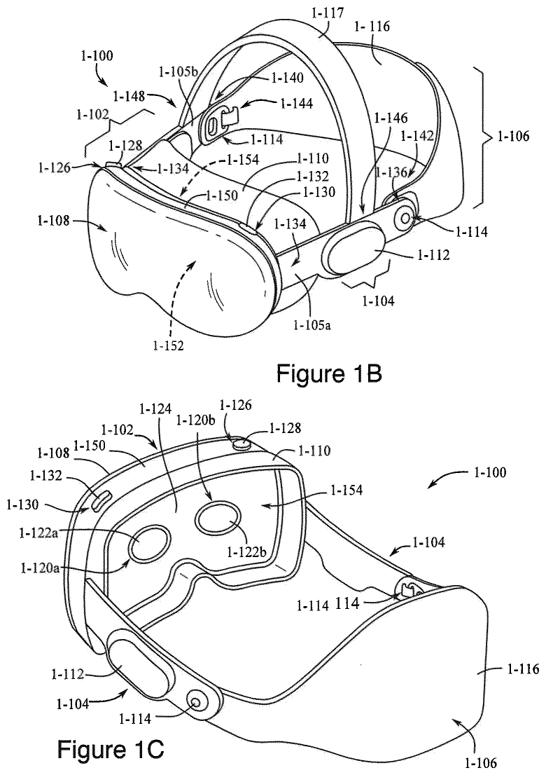

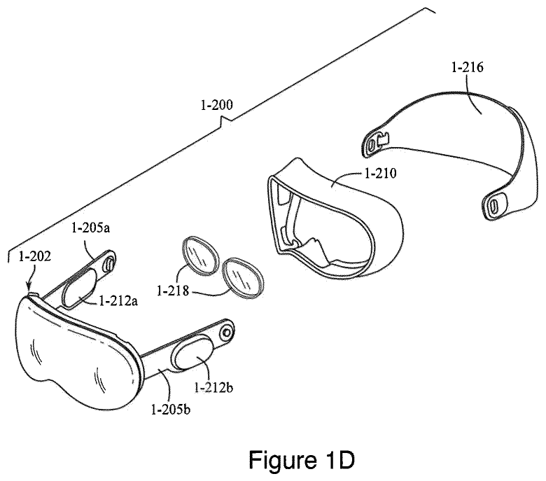

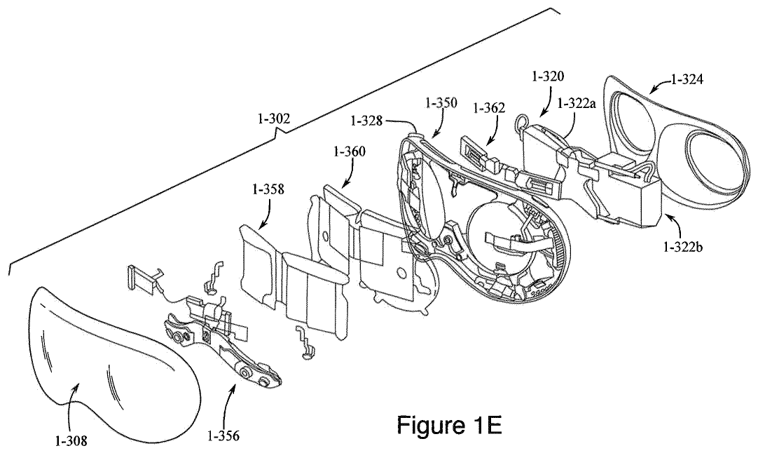

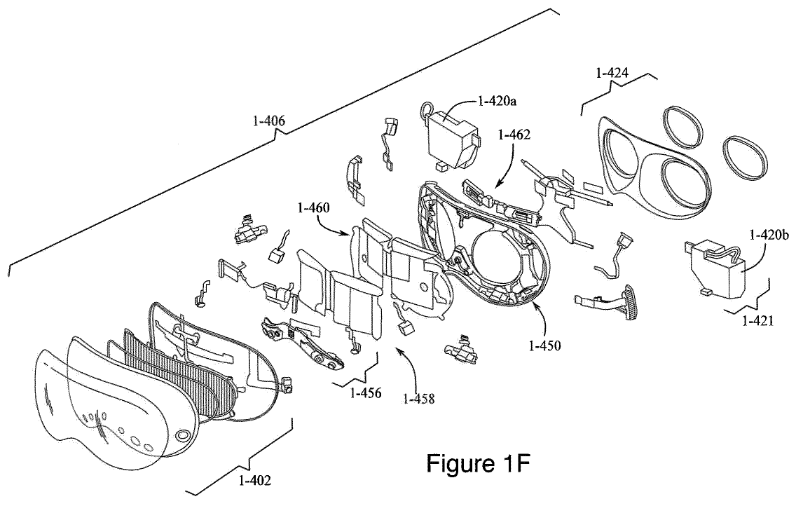

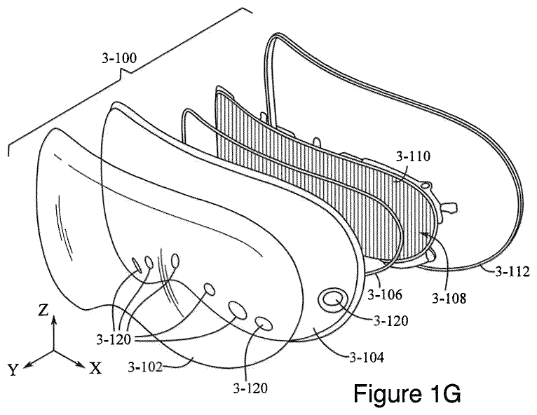

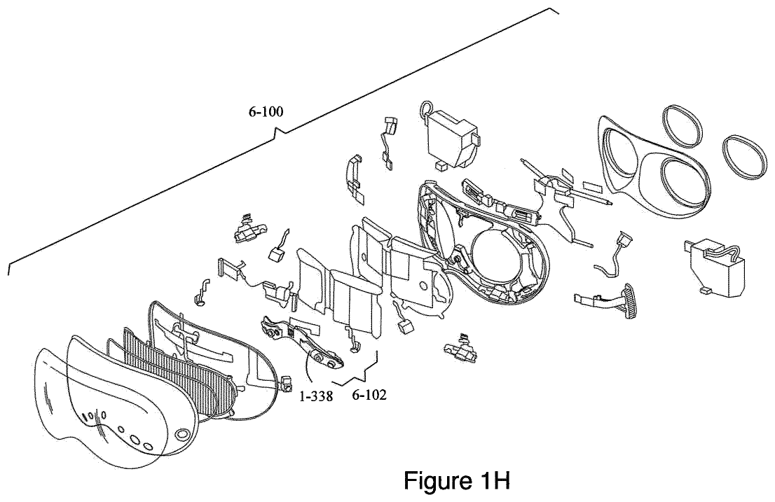

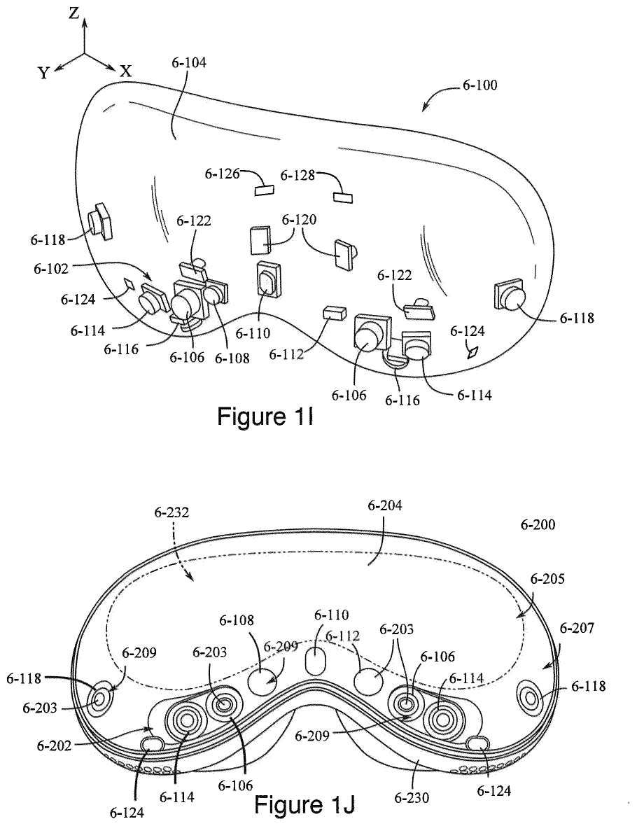

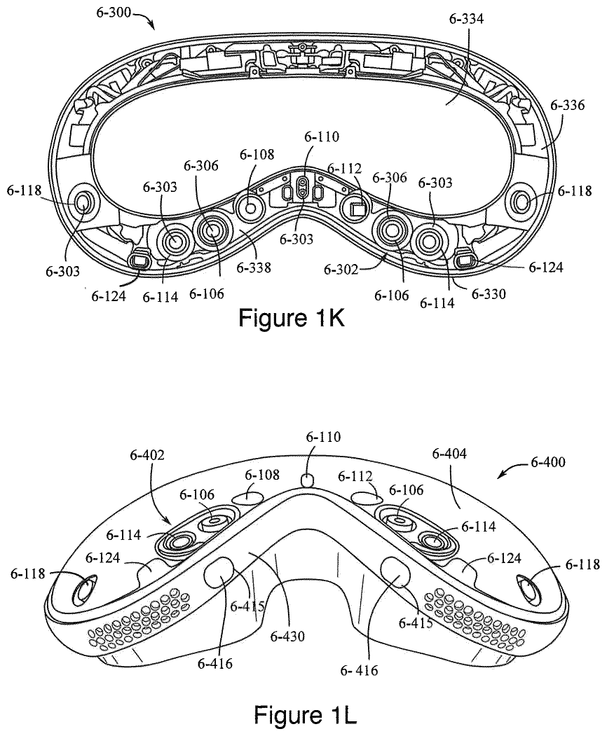

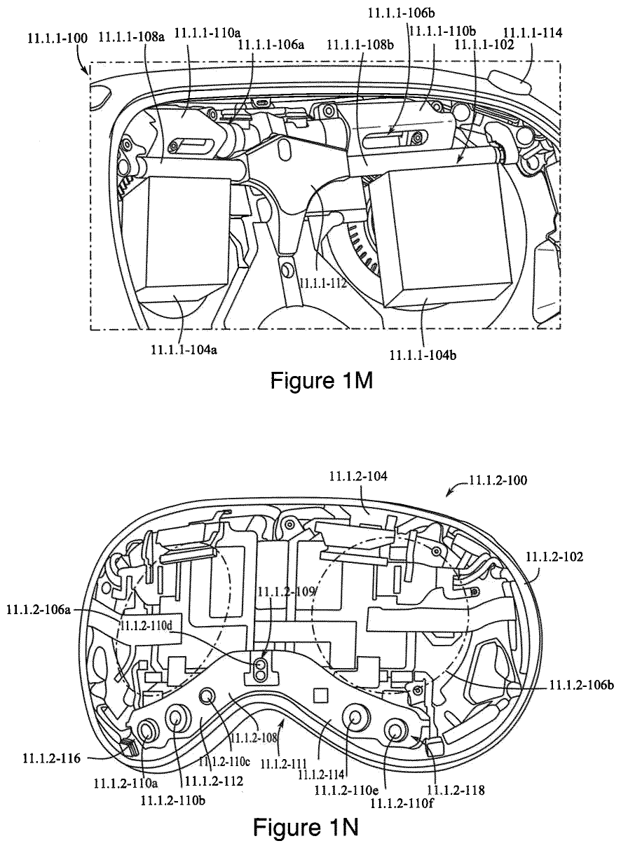

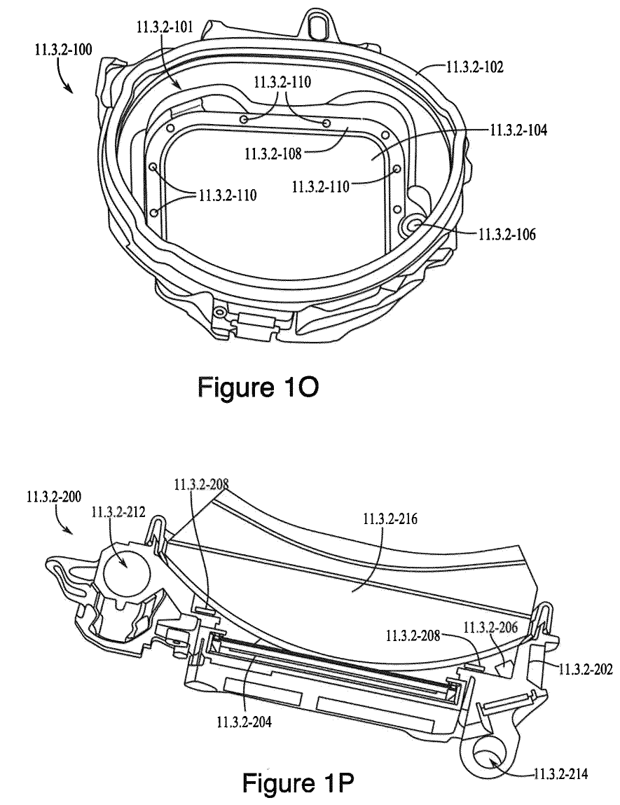

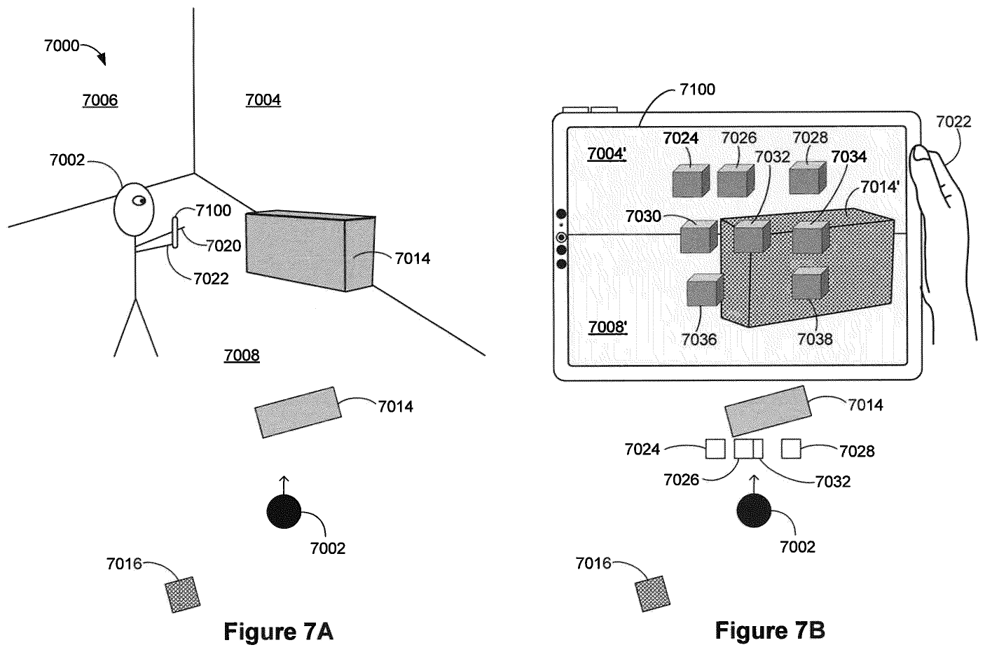

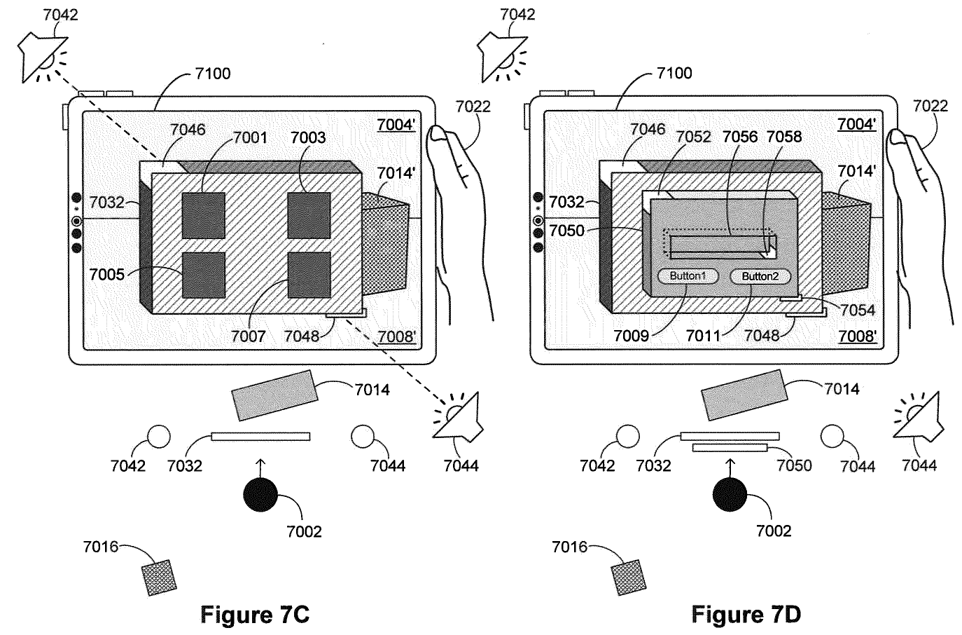

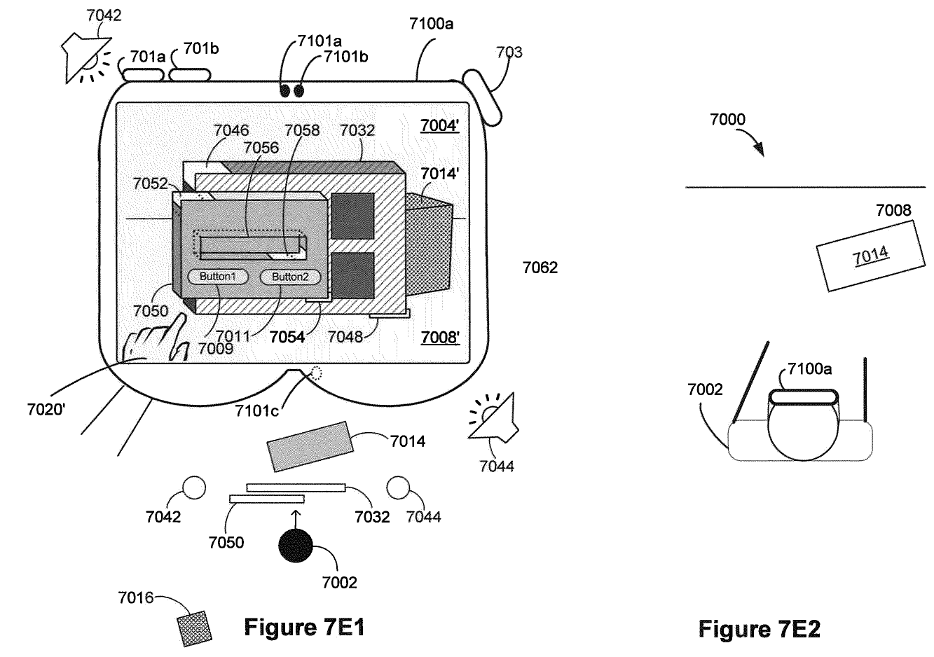

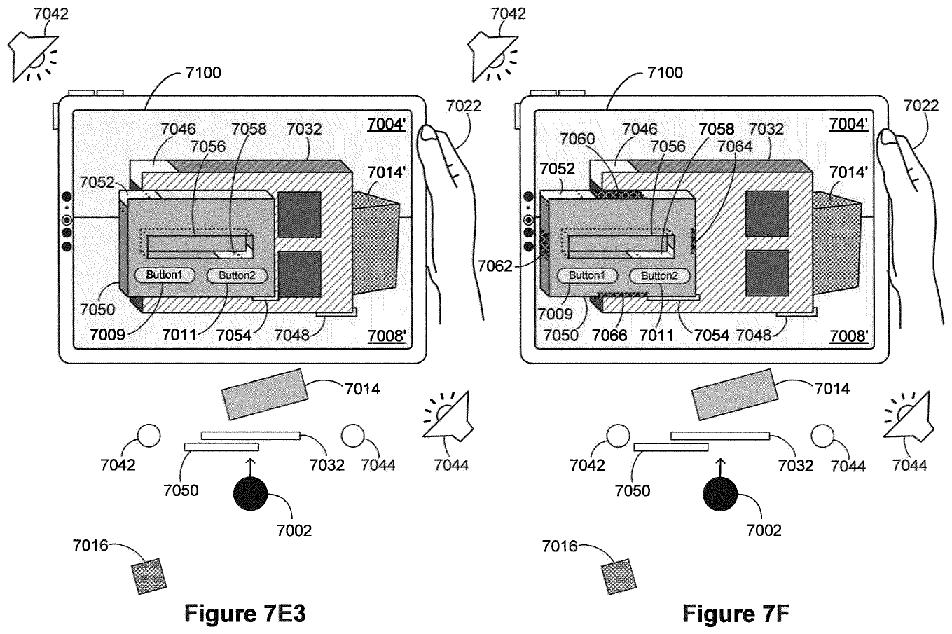

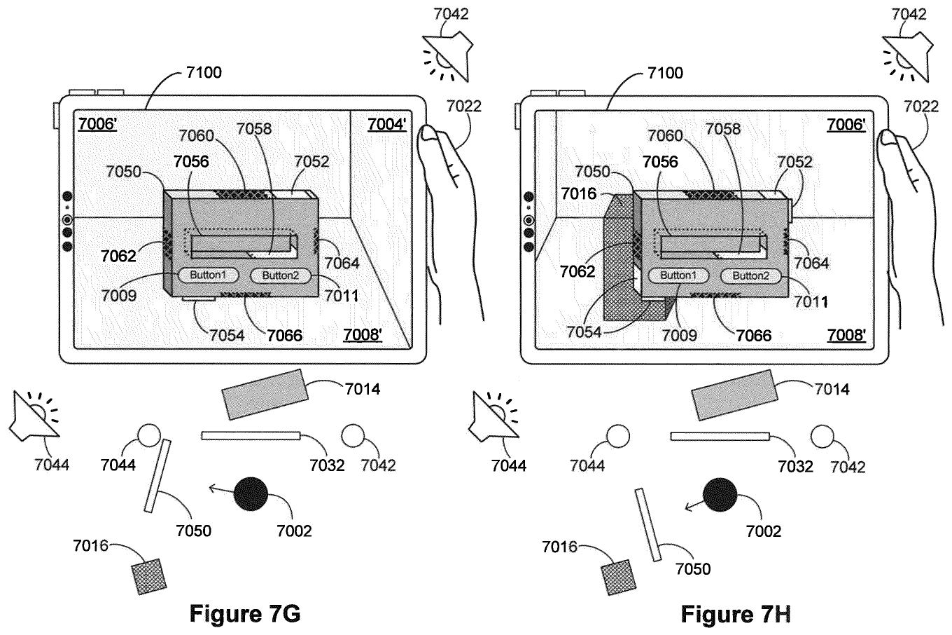

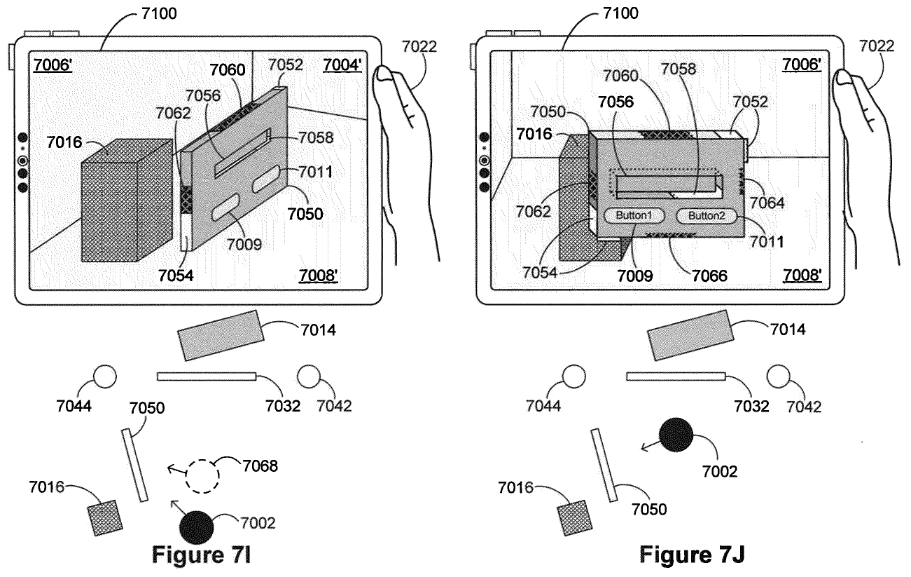

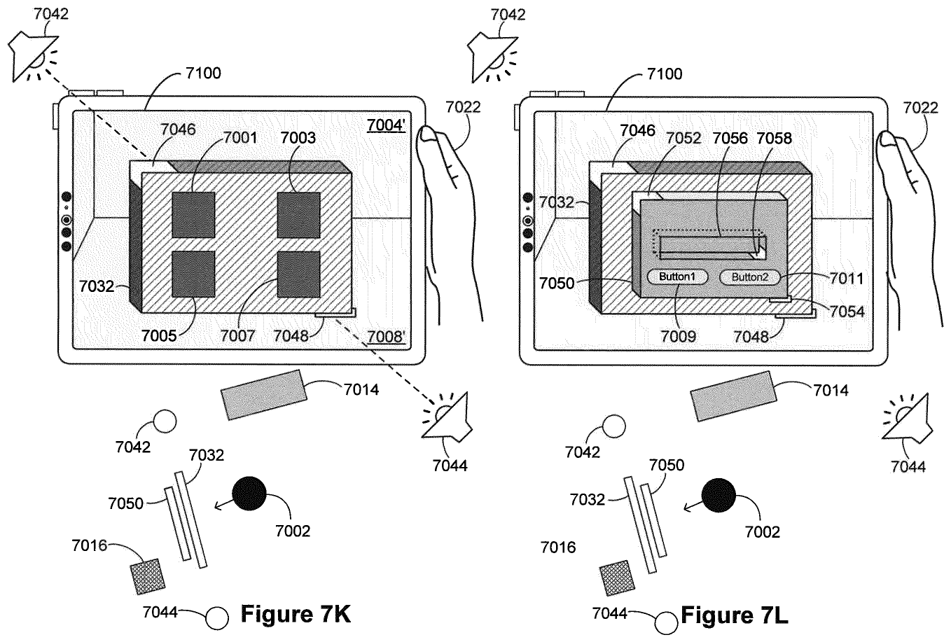

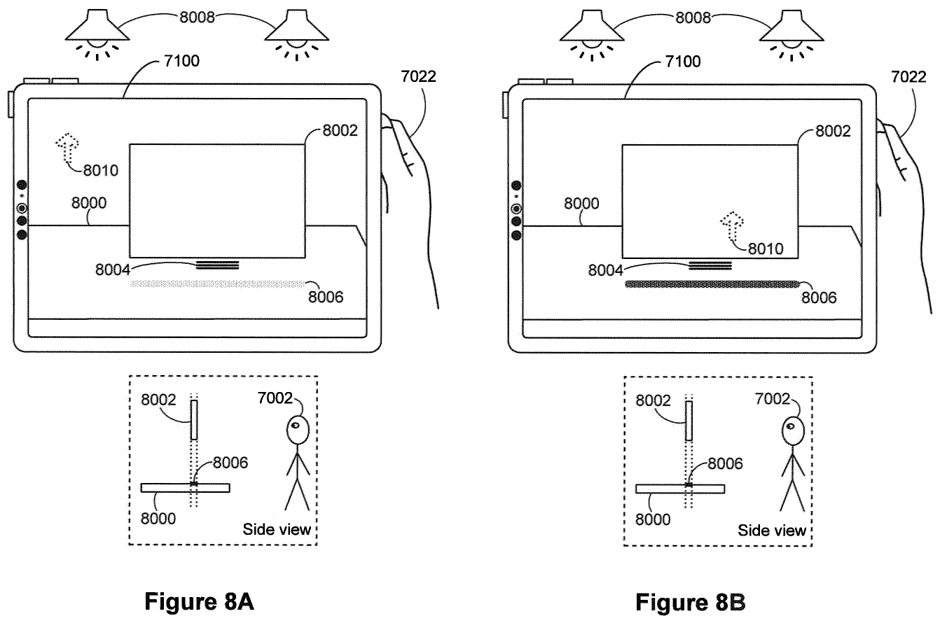

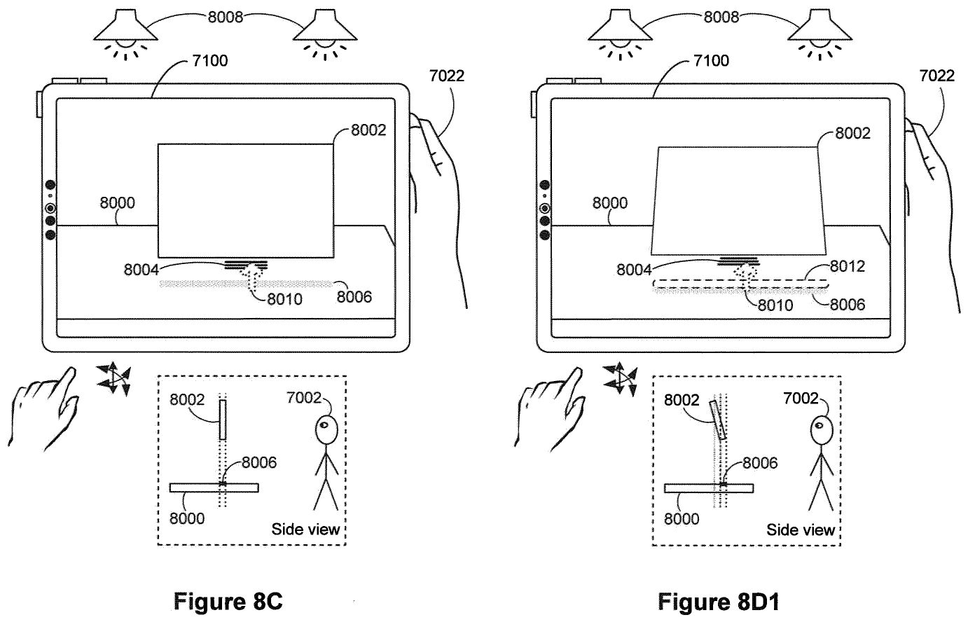

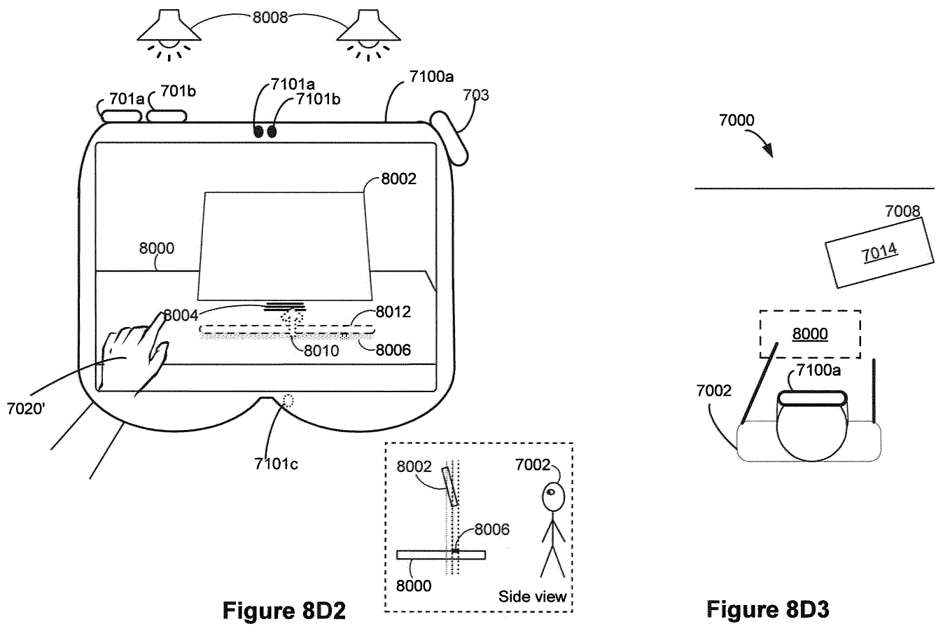

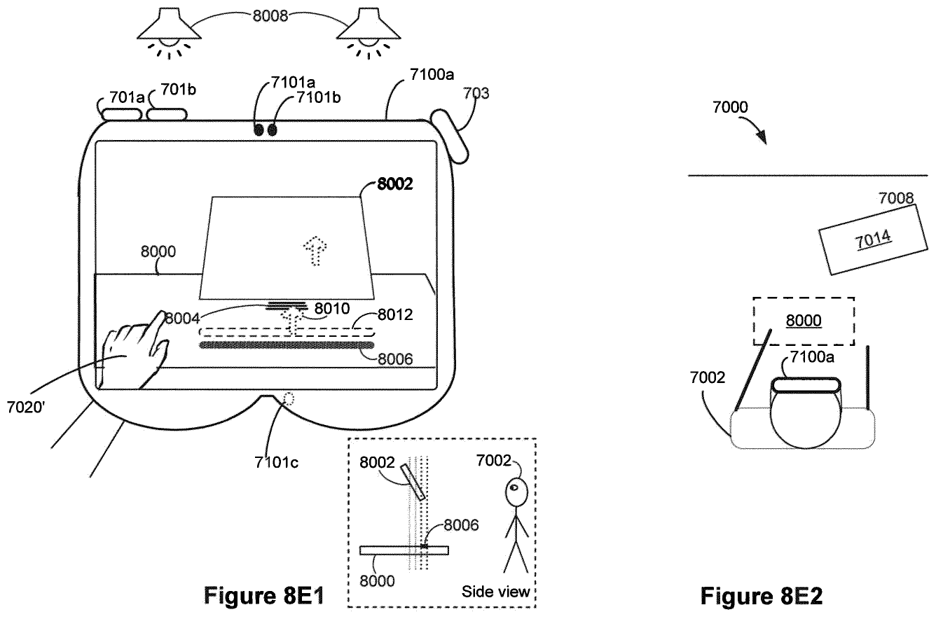

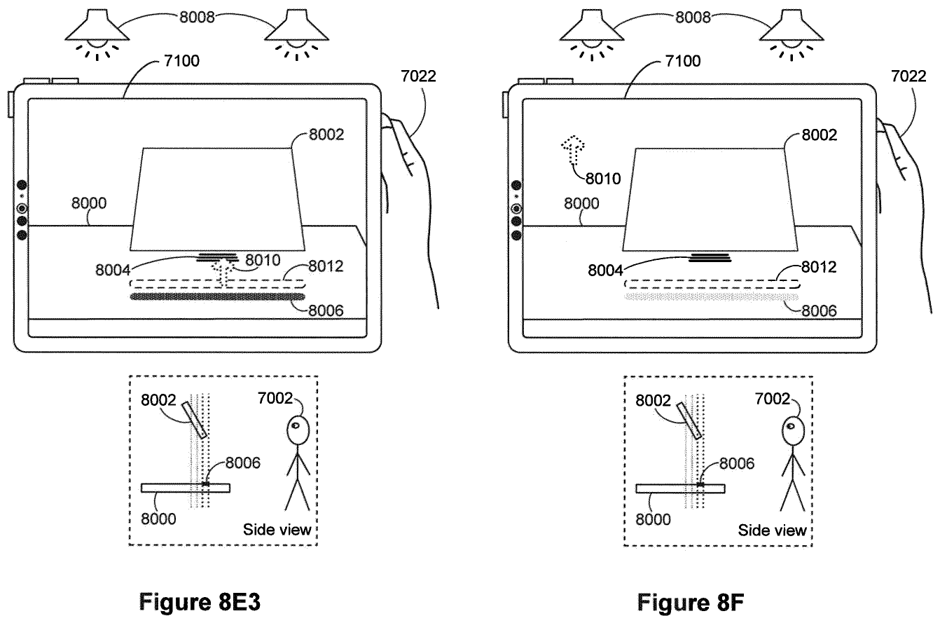

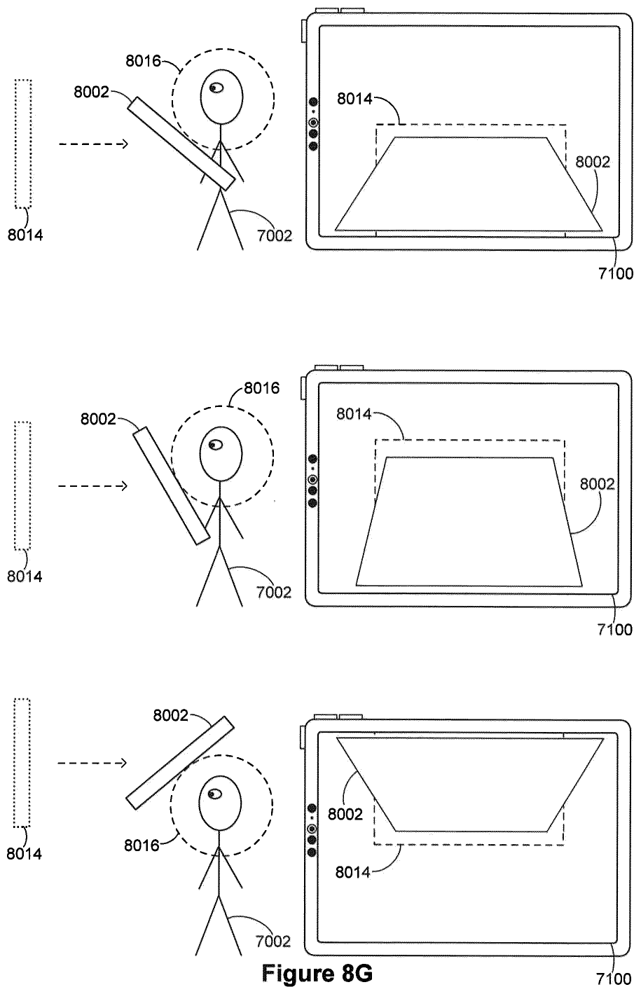

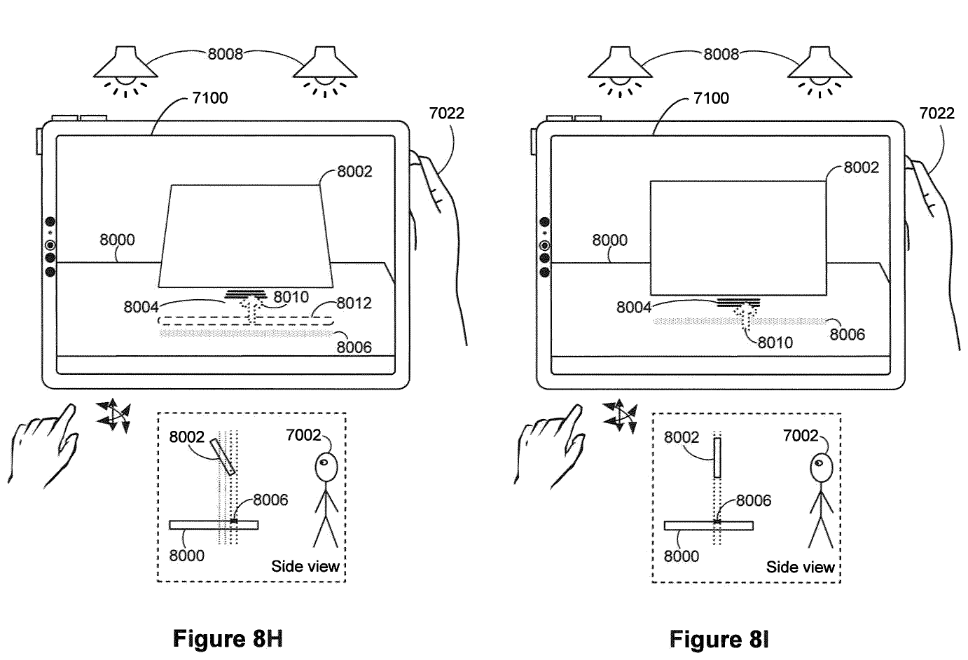

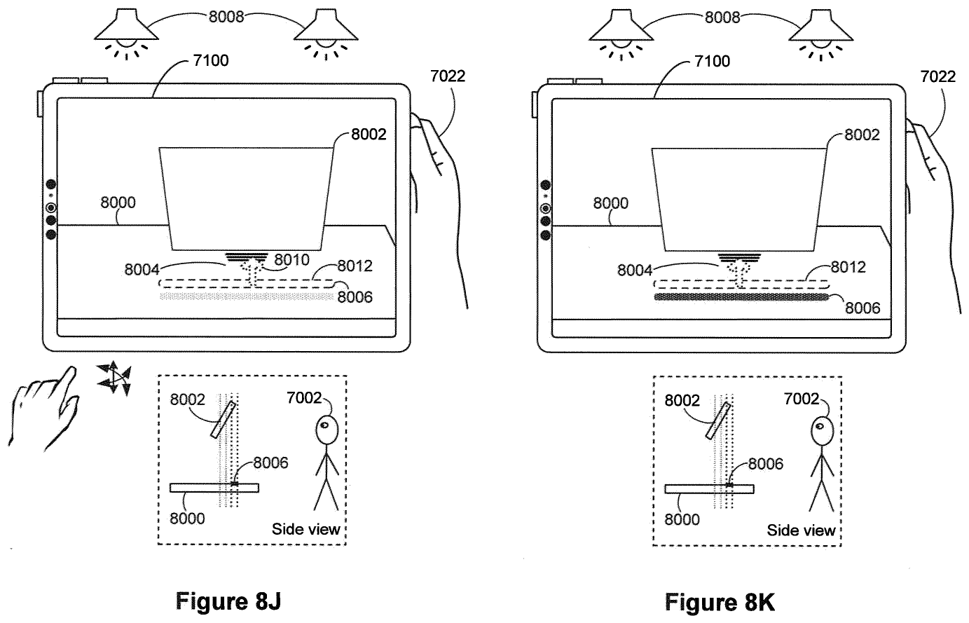

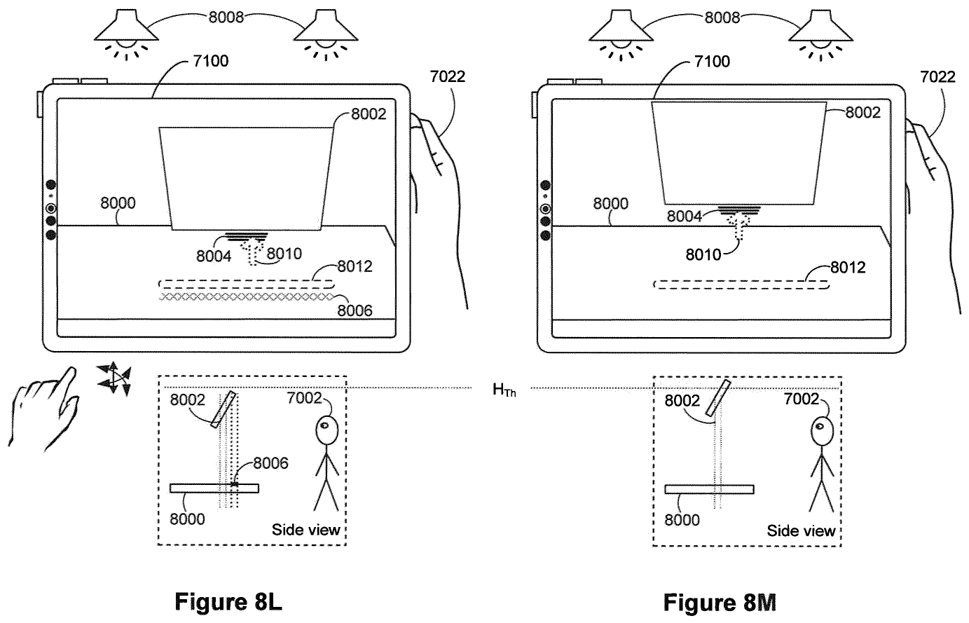

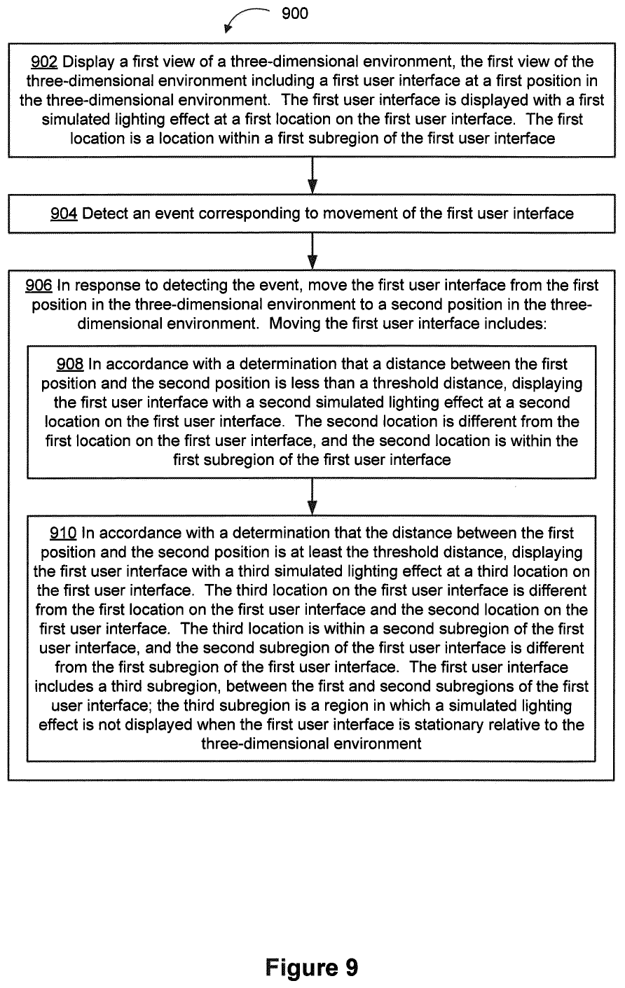

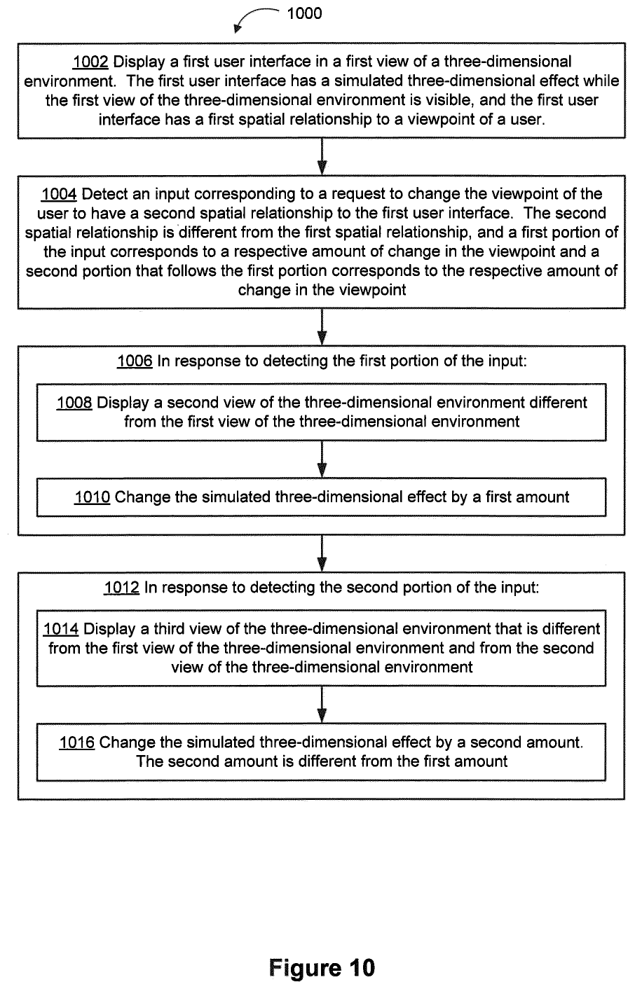

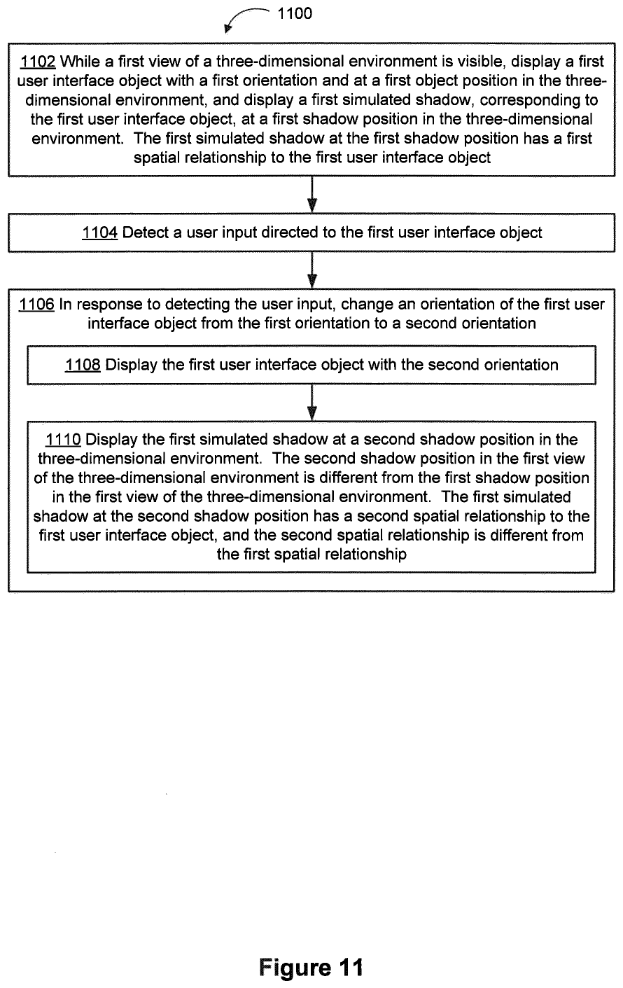

FIGS. 1A-6 provide a description of example computer systems for providing XR experiences to users. FIGS. 7A-7L illustrate example techniques for changing displayed visual effects as user interfaces and/or user interface elements are repositioned and/or as a viewpoint of a user relative to the user interfaces and/or user interface elements is changed, in accordance with some embodiments. FIGS. 8A-8M illustrate example techniques for repositioning a shadow corresponding to a user interface as the user interface is reoriented, in accordance with some embodiments. FIG. 9 is a flow diagram of methods of updating display of visual effects as user interfaces and/or user interface elements are repositioned, in accordance with various embodiments. FIG. 10 is a flow diagram of methods of updating display of visual effects applied to a user interface and/or user interface element, as a viewpoint of a user is changed, in accordance with various embodiments. The user interfaces in FIGS. 7A-7L are used to illustrate the processes in FIGS. 9 and 10. FIG. 11 is a flow diagram of methods of repositioning a shadow corresponding to a user interface as the user interface is reoriented, in accordance with various embodiments. The user interfaces in FIGS. 8A-8M are used to illustrate the processes in FIG. 11.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving privacy and/or security, providing a more varied, detailed, and/or realistic user experience while saving storage space, and/or additional techniques. These techniques also reduce power usage and improve battery life of the device by enabling the user to use the device more quickly and efficiently. Saving on battery power, and thus weight, improves the ergonomics of the device. These techniques also enable real-time communication, allow for the use of fewer and/or less precise sensors resulting in a more compact, lighter, and cheaper device, and enable the device to be used in a variety of lighting conditions. These techniques reduce energy usage, thereby reducing heat emitted by the device, which is particularly important for a wearable device where a device well within operational parameters for device components can become uncomfortable for a user to wear if it is producing too much heat.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

In some embodiments, as shown in FIG. 1A, the XR experience is provided to the user via an operating environment 100 that includes a computer system 101. The computer system 101 includes a controller 110 (e.g., processors of a portable electronic device or a remote server), a display generation component 120 (e.g., a head-mounted device (HMD), a display, a projector, a touch-screen, etc.), one or more input devices 125 (e.g., an eye tracking device 130, a hand tracking device 140, other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, etc.), and optionally one or more peripheral devices 195 (e.g., home appliances, wearable devices, etc.). In some embodiments, one or more of the input devices 125, output devices 155, sensors 190, and peripheral devices 195 are integrated with the display generation component 120 (e.g., in a head-mounted device or a handheld device).

When describing an XR experience, various terms are used to differentially refer to several related but distinct environments that the user may sense and/or with which a user may interact (e.g., with inputs detected by a computer system 101 generating the XR experience that cause the computer system generating the XR experience to generate audio, visual, and/or tactile feedback corresponding to various inputs provided to the computer system 101). The following is a subset of these terms:

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Extended reality: In contrast, an extended reality (XR) environment refers to a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with at least one law of physics. For example, an XR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in an XR environment may be made in response to representations of physical motions (e.g., vocal commands). A person may sense and/or interact with an XR object using any one of their senses, including sight, sound, touch, taste, and smell. For example, a person may sense and/or interact with audio objects that create a 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects.

Examples of XR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationary with respect to the physical ground.

Examples of mixed realities include augmented reality and augmented virtuality.

Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

Augmented virtuality: An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

In an augmented reality, mixed reality, or virtual reality environment, a view of a three-dimensional environment is visible to a user. The view of the three-dimensional environment is typically visible to the user via one or more display generation components (e.g., a display or a pair of display modules that provide stereoscopic content to different eyes of the same user) through a virtual viewport that has a viewport boundary that defines an extent of the three-dimensional environment that is visible to the user via the one or more display generation components. In some embodiments, the region defined by the viewport boundary is smaller than a range of vision of the user in one or more dimensions (e.g., based on the range of vision of the user, size, optical properties or other physical characteristics of the one or more display generation components, and/or the location and/or orientation of the one or more display generation components relative to the eyes of the user). In some embodiments, the region defined by the viewport boundary is larger than a range of vision of the user in one or more dimensions (e.g., based on the range of vision of the user, size, optical properties or other physical characteristics of the one or more display generation components, and/or the location and/or orientation of the one or more display generation components relative to the eyes of the user). The viewport and viewport boundary typically move as the one or more display generation components move (e.g., moving with a head of the user for a head mounted device or moving with a hand of a user for a handheld device such as a tablet or smartphone). A viewpoint of a user determines what content is visible in the viewport, a viewpoint generally specifies a location and a direction relative to the three-dimensional environment, and as the viewpoint shifts, the view of the three-dimensional environment will also shift in the viewport. For a head mounted device, a viewpoint is typically based on a location and direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include display generation components with virtual passthrough, portions of the physical environment that are visible (e.g., displayed, and/or projected) via the one or more display generation components are based on a field of view of one or more cameras in communication with the display generation components which typically move with the display generation components (e.g., moving with a head of the user for a head mounted device or moving with a hand of a user for a handheld device such as a tablet or smartphone) because the viewpoint of the user moves as the field of view of the one or more cameras moves (and the appearance of one or more virtual objects displayed via the one or more display generation components is updated based on the viewpoint of the user (e.g., displayed positions and poses of the virtual objects are updated based on the movement of the viewpoint of the user)). For display generation components with optical passthrough, portions of the physical environment that are visible (e.g., optically visible through one or more partially or fully transparent portions of the display generation component) via the one or more display generation components are based on a field of view of a user through the partially or fully transparent portion(s) of the display generation component (e.g., moving with a head of the user for a head mounted device or moving with a hand of a user for a handheld device such as a tablet or smartphone) because the viewpoint of the user moves as the field of view of the user through the partially or fully transparent portions of the display generation components moves (and the appearance of one or more virtual objects is updated based on the viewpoint of the user).

In some embodiments a representation of a physical environment (e.g., displayed via virtual passthrough or optical passthrough) can be partially or fully obscured by a virtual environment. In some embodiments, the amount of virtual environment that is displayed (e.g., the amount of physical environment that is not displayed) is based on an immersion level for the virtual environment (e.g., with respect to the representation of the physical environment). For example, increasing the immersion level optionally causes more of the virtual environment to be displayed, replacing and/or obscuring more of the physical environment, and reducing the immersion level optionally causes less of the virtual environment to be displayed, revealing portions of the physical environment that were previously not displayed and/or obscured. In some embodiments, at a particular immersion level, one or more first background objects (e.g., in the representation of the physical environment) are visually de-emphasized (e.g., dimmed, blurred, and/or displayed with increased transparency) more than one or more second background objects, and one or more third background objects cease to be displayed. In some embodiments, a level of immersion includes an associated degree to which the virtual content displayed by the computer system (e.g., the virtual environment and/or the virtual content) obscures background content (e.g., content other than the virtual environment and/or the virtual content) around/behind the virtual content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the virtual content (e.g., 33% of the field of view consumed by the virtual content at low immersion, 66% of the field of view consumed by the virtual content at medium immersion, or 100% of the field of view consumed by the virtual content at high immersion). In some embodiments, the background content is included in a background over which the virtual content is displayed (e.g., background content in the representation of the physical environment). In some embodiments, the background content includes user interfaces (e.g., user interfaces generated by the computer system corresponding to applications), virtual objects (e.g., files or representations of other users generated by the computer system) not associated with or included in the virtual environment and/or virtual content, and/or real objects (e.g., pass-through objects representing real objects in the physical environment around the user that are visible such that they are displayed via the display generation component and/or a visible via a transparent or translucent component of the display generation component because the computer system does not obscure/prevent visibility of them through the display generation component). In some embodiments, at a low level of immersion (e.g., a first level of immersion), the background, virtual and/or real objects are displayed in an unobscured manner. For example, a virtual environment with a low level of immersion is optionally displayed concurrently with the background content, which is optionally displayed with full brightness, color, and/or translucency. In some embodiments, at a higher level of immersion (e.g., a second level of immersion higher than the first level of immersion), the background, virtual and/or real objects are displayed in an obscured manner (e.g., dimmed, blurred, or removed from display). For example, a respective virtual environment with a high level of immersion is displayed without concurrently displaying the background content (e.g., in a full screen or fully immersive mode). As another example, a virtual environment displayed with a medium level of immersion is displayed concurrently with darkened, blurred, or otherwise de-emphasized background content. In some embodiments, the visual characteristics of the background objects vary among the background objects. For example, at a particular immersion level, one or more first background objects are visually de-emphasized (e.g., dimmed, blurred, and/or displayed with increased transparency) more than one or more second background objects, and one or more third background objects cease to be displayed. In some embodiments, a null or zero level of immersion corresponds to the virtual environment ceasing to be displayed and instead a representation of a physical environment is displayed (optionally with one or more virtual objects such as application, windows, or virtual three-dimensional objects) without the representation of the physical environment being obscured by the virtual environment. Adjusting the level of immersion using a physical input element provides for quick and efficient method of adjusting immersion, which enhances the operability of the computer system and makes the user-device interface more efficient.

Viewpoint-locked virtual object: A virtual object is viewpoint-locked when a computer system displays the virtual object at the same location and/or position in the viewpoint of the user, even as the viewpoint of the user shifts (e.g., changes). In embodiments where the computer system is a head-mounted device, the viewpoint of the user is locked to the forward facing direction of the user's head (e.g., the viewpoint of the user is at least a portion of the field-of-view of the user when the user is looking straight ahead); thus, the viewpoint of the user remains fixed even as the user's gaze is shifted, without moving the user's head. In embodiments where the computer system has a display generation component (e.g., a display screen) that can be repositioned with respect to the user's head, the viewpoint of the user is the augmented reality view that is being presented to the user on a display generation component of the computer system. For example, a viewpoint-locked virtual object that is displayed in the upper left corner of the viewpoint of the user, when the viewpoint of the user is in a first orientation (e.g., with the user's head facing north) continues to be displayed in the upper left corner of the viewpoint of the user, even as the viewpoint of the user changes to a second orientation (e.g., with the user's head facing west). In other words, the location and/or position at which the viewpoint-locked virtual object is displayed in the viewpoint of the user is independent of the user's position and/or orientation in the physical environment. In embodiments in which the computer system is a head-mounted device, the viewpoint of the user is locked to the orientation of the user's head, such that the virtual object is also referred to as a “head-locked virtual object.”

Environment-locked virtual object: A virtual object is environment-locked (alternatively, “world-locked”) when a computer system displays the virtual object at a location and/or position in the viewpoint of the user that is based on (e.g., selected in reference to and/or anchored to) a location and/or object in the three-dimensional environment (e.g., a physical environment or a virtual environment). As the viewpoint of the user shifts, the location and/or object in the environment relative to the viewpoint of the user changes, which results in the environment-locked virtual object being displayed at a different location and/or position in the viewpoint of the user. For example, an environment-locked virtual object that is locked onto a tree that is immediately in front of a user is displayed at the center of the viewpoint of the user. When the viewpoint of the user shifts to the right (e.g., the user's head is turned to the right) so that the tree is now left-of-center in the viewpoint of the user (e.g., the tree's position in the viewpoint of the user shifts), the environment-locked virtual object that is locked onto the tree is displayed left-of-center in the viewpoint of the user. In other words, the location and/or position at which the environment-locked virtual object is displayed in the viewpoint of the user is dependent on the position and/or orientation of the location and/or object in the environment onto which the virtual object is locked. In some embodiments, the computer system uses a stationary frame of reference (e.g., a coordinate system that is anchored to a fixed location and/or object in the physical environment) in order to determine the position at which to display an environment-locked virtual object in the viewpoint of the user. An environment-locked virtual object can be locked to a stationary part of the environment (e.g., a floor, wall, table, or other stationary object) or can be locked to a moveable part of the environment (e.g., a vehicle, animal, person, or even a representation of portion of the users body that moves independently of a viewpoint of the user, such as a user's hand, wrist, arm, or foot) so that the virtual object is moved as the viewpoint or the portion of the environment moves to maintain a fixed relationship between the virtual object and the portion of the environment.

In some embodiments a virtual object that is environment-locked or viewpoint-locked exhibits lazy follow behavior which reduces or delays motion of the environment-locked or viewpoint-locked virtual object relative to movement of a point of reference which the virtual object is following. In some embodiments, when exhibiting lazy follow behavior the computer system intentionally delays movement of the virtual object when detecting movement of a point of reference (e.g., a portion of the environment, the viewpoint, or a point that is fixed relative to the viewpoint, such as a point that is between 5-300 cm from the viewpoint) which the virtual object is following. For example, when the point of reference (e.g., the portion of the environment or the viewpoint) moves with a first speed, the virtual object is moved by the device to remain locked to the point of reference but moves with a second speed that is slower than the first speed (e.g., until the point of reference stops moving or slows down, at which point the virtual object starts to catch up to the point of reference). In some embodiments, when a virtual object exhibits lazy follow behavior the device ignores small amounts of movement of the point of reference (e.g., ignoring movement of the point of reference that is below a threshold amount of movement such as movement by 0-5 degrees or movement by 0-50 cm). For example, when the point of reference (e.g., the portion of the environment or the viewpoint to which the virtual object is locked) moves by a first amount, a distance between the point of reference and the virtual object increases (e.g., because the virtual object is being displayed so as to maintain a fixed or substantially fixed position relative to a viewpoint or portion of the environment that is different from the point of reference to which the virtual object is locked) and when the point of reference (e.g., the portion of the environment or the viewpoint to which the virtual object is locked) moves by a second amount that is greater than the first amount, a distance between the point of reference and the virtual object initially increases (e.g., because the virtual object is being displayed so as to maintain a fixed or substantially fixed position relative to a viewpoint or portion of the environment that is different from the point of reference to which the virtual object is locked) and then decreases as the amount of movement of the point of reference increases above a threshold (e.g., a “lazy follow” threshold) because the virtual object is moved by the computer system to maintain a fixed or substantially fixed position relative to the point of reference. In some embodiments the virtual object maintaining a substantially fixed position relative to the point of reference includes the virtual object being displayed within a threshold distance (e.g., 1, 2, 3, 5, 15, 20, 50 cm) of the point of reference in one or more dimensions (e.g., up/down, left/right, and/or forward/backward relative to the position of the point of reference).

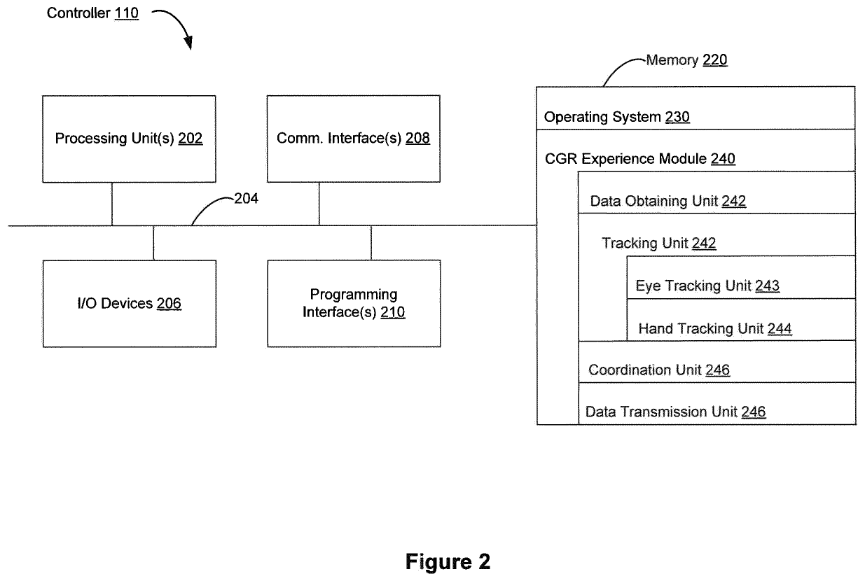

Hardware: There are many different types of electronic systems that enable a person to sense and/or interact with various XR environments. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may have one or more speaker(s) and an integrated opaque display. Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. In some embodiments, the controller 110 is configured to manage and coordinate an XR experience for the user. In some embodiments, the controller 110 includes a suitable combination of software, firmware, and/or hardware. The controller 110 is described in greater detail below with respect to FIG. 2. In some embodiments, the controller 110 is a computing device that is local or remote relative to the scene 105 (e.g., a physical environment). For example, the controller 110 is a local server located within the scene 105. In another example, the controller 110 is a remote server located outside of the scene 105 (e.g., a cloud server, central server, etc.). In some embodiments, the controller 110 is communicatively coupled with the display generation component 120 (e.g., an HMD, a display, a projector, a touch-screen, etc.) via one or more wired or wireless communication channels 144 (e.g., BLUETOOTH, IEEE 802.11x, IEEE 802.16x, IEEE 802.3x, etc.). In another example, the controller 110 is included within the enclosure (e.g., a physical housing) of the display generation component 120 (e.g., an HMD, or a portable electronic device that includes a display and one or more processors, etc.), one or more of the input devices 125, one or more of the output devices 155, one or more of the sensors 190, and/or one or more of the peripheral devices 195, or share the same physical enclosure or support structure with one or more of the above.

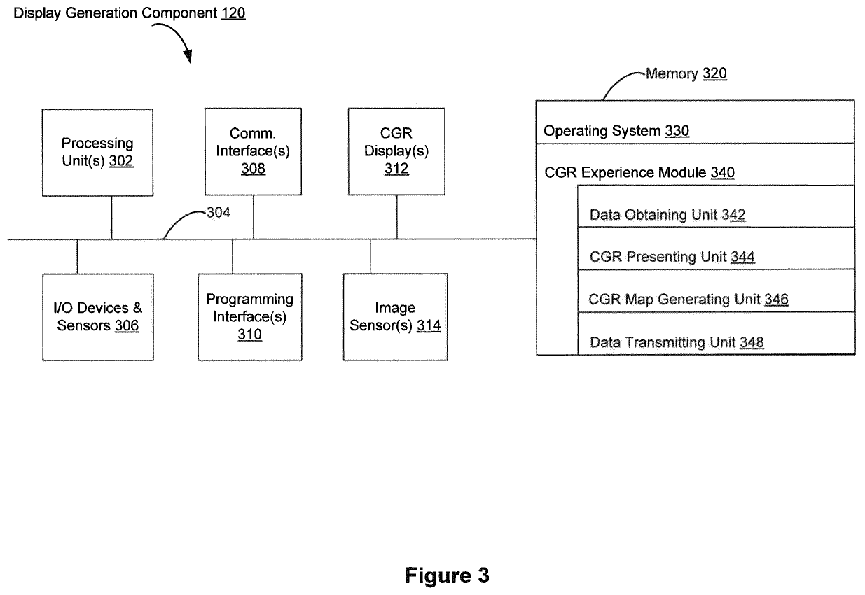

In some embodiments, the display generation component 120 is configured to provide the XR experience (e.g., at least a visual component of the XR experience) to the user. In some embodiments, the display generation component 120 includes a suitable combination of software, firmware, and/or hardware. The display generation component 120 is described in greater detail below with respect to FIG. 3. In some embodiments, the functionalities of the controller 110 are provided by and/or combined with the display generation component 120.

According to some embodiments, the display generation component 120 provides an XR experience to the user while the user is virtually and/or physically present within the scene 105.

In some embodiments, the display generation component is worn on a part of the user's body (e.g., on his/her head, on his/her hand, etc.). As such, the display generation component 120 includes one or more XR displays provided to display the XR content. For example, in various embodiments, the display generation component 120 encloses the field-of-view of the user. In some embodiments, the display generation component 120 is a handheld device (such as a smartphone or tablet) configured to present XR content, and the user holds the device with a display directed towards the field-of-view of the user and a camera directed towards the scene 105. In some embodiments, the handheld device is optionally placed within an enclosure that is worn on the head of the user. In some embodiments, the handheld device is optionally placed on a support (e.g., a tripod) in front of the user. In some embodiments, the display generation component 120 is an XR chamber, enclosure, or room configured to present XR content in which the user does not wear or hold the display generation component 120. Many user interfaces described with reference to one type of hardware for displaying XR content (e.g., a handheld device or a device on a tripod) could be implemented on another type of hardware for displaying XR content (e.g., an HMD or other wearable computing device). For example, a user interface showing interactions with XR content triggered based on interactions that happen in a space in front of a handheld or tripod mounted device could similarly be implemented with an HMD where the interactions happen in a space in front of the HMD and the responses of the XR content are displayed via the HMD. Similarly, a user interface showing interactions with XR content triggered based on movement of a handheld or tripod mounted device relative to the physical environment (e.g., the scene 105 or a part of the user's body (e.g., the user's eye(s), head, or hand)) could similarly be implemented with an HMD where the movement is caused by movement of the HMD relative to the physical environment (e.g., the scene 105 or a part of the user's body (e.g., the user's eye(s), head, or hand)).

While pertinent features of the operating environment 100 are shown in FIG. 1A, those of ordinary skill in the art will appreciate from the present disclosure that various other features have not been illustrated for the sake of brevity and so as not to obscure more pertinent aspects of the example embodiments disclosed herein.

FIGS. 1A-1P illustrate various examples of a computer system that is used to perform the methods and provide audio, visual and/or haptic feedback as part of user interfaces described herein. In some embodiments, the computer system includes one or more display generation components (e.g., first and second display assemblies 1-120a, 1-120b and/or first and second optical modules 11.1.1-104a and 11.1.1-104b) for displaying virtual elements and/or a representation of a physical environment to a user of the computer system, optionally generated based on detected events and/or user inputs detected by the computer system. User interfaces generated by the computer system are optionally corrected by one or more corrective lenses 11.3.2-216 that are optionally removably attached to one or more of the optical modules to enable the user interfaces to be more easily viewed by users who would otherwise use glasses or contacts to correct their vision. While many user interfaces illustrated herein show a single view of a user interface, user interfaces in a HMD are optionally displayed using two optical modules (e.g., first and second display assemblies 1-120a, 1-120b and/or first and second optical modules 11.1.1-104a and 11.1.1-104b), one for a user's right eye and a different one for a user's left eye, and slightly different images are presented to the two different eyes to generate the illusion of stereoscopic depth, the single view of the user interface would typically be either a right-eye or left-eye view and the depth effect is explained in the text or using other schematic charts or views. In some embodiments, the computer system includes one or more external displays (e.g., display assembly 1-108) for displaying status information for the computer system to the user of the computer system (when the computer system is not being worn) and/or to other people who are near the computer system, optionally generated based on detected events and/or user inputs detected by the computer system. In some embodiments, the computer system includes one or more audio output components (e.g., electronic component 1-112) for generating audio feedback, optionally generated based on detected events and/or user inputs detected by the computer system. In some embodiments, the computer system includes one or more input devices for detecting input such as one or more sensors (e.g., one or more sensors in sensor assembly 1-356, and/or FIG. 1I) for detecting information about a physical environment of the device which can be used (optionally in conjunction with one or more illuminators such as the illuminators described in FIG. 1I) to generate a digital passthrough image, capture visual media corresponding to the physical environment (e.g., photos and/or video), or determine a pose (e.g., position and/or orientation) of physical objects and/or surfaces in the physical environment so that virtual objects ban be placed based on a detected pose of physical objects and/or surfaces. In some embodiments, the computer system includes one or more input devices for detecting input such as one or more sensors for detecting hand position and/or movement (e.g., one or more sensors in sensor assembly 1-356, and/or FIG. 1I) that can be used (optionally in conjunction with one or more illuminators such as the illuminators 6-124 described in FIG. 11) to determine when one or more air gestures have been performed. In some embodiments, the computer system includes one or more input devices for detecting input such as one or more sensors for detecting eye movement (e.g., eye tracking and gaze tracking sensors in FIG. 1I) which can be used (optionally in conjunction with one or more lights such as lights 11.3.2-110 in FIG. 10) to determine attention or gaze position and/or gaze movement which can optionally be used to detect gaze-only inputs based on gaze movement and/or dwell. A combination of the various sensors described above can be used to determine user facial expressions and/or hand movements for use in generating an avatar or representation of the user such as an anthropomorphic avatar or representation for use in a real-time communication session where the avatar has facial expressions, hand movements, and/or body movements that are based on or similar to detected facial expressions, hand movements, and/or body movements of a user of the device. Gaze and/or attention information is, optionally, combined with hand tracking information to determine interactions between the user and one or more user interfaces based on direct and/or indirect inputs such as air gestures or inputs that use one or more hardware input devices such as one or more buttons (e.g., first button 1-128, button 11.1.1-114, second button 1-132, and or dial or button 1-328), knobs (e.g., first button 1-128, button 11.1.1-114, and/or dial or button 1-328), digital crowns (e.g., first button 1-128 which is depressible and twistable or rotatable, button 11.1.1-114, and/or dial or button 1-328), trackpads, touch screens, keyboards, mice and/or other input devices. One or more buttons (e.g., first button 1-128, button 11.1.1-114, second button 1-132, and or dial or button 1-328) are optionally used to perform system operations such as recentering content in three-dimensional environment that is visible to a user of the device, displaying a home user interface for launching applications, starting real-time communication sessions, or initiating display of virtual three-dimensional backgrounds. Knobs or digital crowns (e.g., first button 1-128 which is depressible and twistable or rotatable, button 11.1.1-114, and/or dial or button 1-328) are optionally rotatable to adjust parameters of the visual content such as a level of immersion of a virtual three-dimensional environment (e.g., a degree to which virtual-content occupies the viewport of the user into the three-dimensional environment) or other parameters associated with the three-dimensional environment and the virtual content that is displayed via the optical modules (e.g., first and second display assemblies 1-120a, 1-120b and/or first and second optical modules 11.1.1-104a and 11.1.1-104b).

FIG. 1B illustrates a front, top, perspective view of an example of a head-mountable display (HMD) device 1-100 configured to be donned by a user and provide virtual and altered/mixed reality (VR/AR) experiences. The HMD 1-100 can include a display unit 1-102 or assembly, an electronic strap assembly 1-104 connected to and extending from the display unit 1-102, and a band assembly 1-106 secured at either end to the electronic strap assembly 1-104. The electronic strap assembly 1-104 and the band 1-106 can be part of a retention assembly configured to wrap around a user's head to hold the display unit 1-102 against the face of the user.

In at least one example, the band assembly 1-106 can include a first band 1-116 configured to wrap around the rear side of a user's head and a second band 1-117 configured to extend over the top of a user's head. The second strap can extend between first and second electronic straps 1-105a, 1-105b of the electronic strap assembly 1-104 as shown. The strap assembly 1-104 and the band assembly 1-106 can be part of a securement mechanism extending rearward from the display unit 1-102 and configured to hold the display unit 1-102 against a face of a user.

In at least one example, the securement mechanism includes a first electronic strap 1-105a including a first proximal end 1-134 coupled to the display unit 1-102, for example a housing 1-150 of the display unit 1-102, and a first distal end 1-136 opposite the first proximal end 1-134. The securement mechanism can also include a second electronic strap 1-105b including a second proximal end 1-138 coupled to the housing 1-150 of the display unit 1-102 and a second distal end 1-140 opposite the second proximal end 1-138. The securement mechanism can also include the first band 1-116 including a first end 1-142 coupled to the first distal end 1-136 and a second end 1-144 coupled to the second distal end 1-140 and the second band 1-117 extending between the first electronic strap 1-105a and the second electronic strap 1-105b. The straps 1-105a-b and band 1-116 can be coupled via connection mechanisms or assemblies 1-114. In at least one example, the second band 1-117 includes a first end 1-146 coupled to the first electronic strap 1-105a between the first proximal end 1-134 and the first distal end 1-136 and a second end 1-148 coupled to the second electronic strap 1-105b between the second proximal end 1-138 and the second distal end 1-140.

In at least one example, the first and second electronic straps 1-105a-b include plastic, metal, or other structural materials forming the shape the substantially rigid straps 1-105a-b. In at least one example, the first and second bands 1-116, 1-117 are formed of elastic, flexible materials including woven textiles, rubbers, and the like. The first and second bands 1-116, 1-117 can be flexible to conform to the shape of the user' head when donning the HMD 1-100.

In at least one example, one or more of the first and second electronic straps 1-105a-b can define internal strap volumes and include one or more electronic components disposed in the internal strap volumes. In one example, as shown in FIG. 1B, the first electronic strap 1-105a can include an electronic component 1-112. In one example, the electronic component 1-112 can include a speaker. In one example, the electronic component 1-112 can include a computing component such as a processor.

In at least one example, the housing 1-150 defines a first, front-facing opening 1-152. The front-facing opening is labeled in dotted lines at 1-152 in FIG. 1B because the display assembly 1-108 is disposed to occlude the first opening 1-152 from view when the HMD 1-100 is assembled. The housing 1-150 can also define a rear-facing second opening 1-154. The housing 1-150 also defines an internal volume between the first and second openings 1-152, 1-154. In at least one example, the HMD 1-100 includes the display assembly 1-108, which can include a front cover and display screen (shown in other figures) disposed in or across the front opening 1-152 to occlude the front opening 1-152. In at least one example, the display screen of the display assembly 1-108, as well as the display assembly 1-108 in general, has a curvature configured to follow the curvature of a user's face. The display screen of the display assembly 1-108 can be curved as shown to compliment the user's facial features and general curvature from one side of the face to the other, for example from left to right and/or from top to bottom where the display unit 1-102 is pressed.

In at least one example, the housing 1-150 can define a first aperture 1-126 between the first and second openings 1-152, 1-154 and a second aperture 1-130 between the first and second openings 1-152, 1-154. The HMD 1-100 can also include a first button 1-128 disposed in the first aperture 1-126 and a second button 1-132 disposed in the second aperture 1-130. The first and second buttons 1-128, 1-132 can be depressible through the respective apertures 1-126, 1-130. In at least one example, the first button 1-126 and/or second button 1-132 can be twistable dials as well as depressible buttons. In at least one example, the first button 1-128 is a depressible and twistable dial button and the second button 1-132 is a depressible button.

FIG. 1C illustrates a rear, perspective view of the HMD 1-100. The HMD 1-100 can include a light seal 1-110 extending rearward from the housing 1-150 of the display assembly 1-108 around a perimeter of the housing 1-150 as shown. The light seal 1-110 can be configured to extend from the housing 1-150 to the user's face around the user's eyes to block external light from being visible. In one example, the HMD 1-100 can include first and second display assemblies 1-120a, 1-120b disposed at or in the rearward facing second opening 1-154 defined by the housing 1-150 and/or disposed in the internal volume of the housing 1-150 and configured to project light through the second opening 1-154. In at least one example, each display assembly 1-120a-b can include respective display screens 1-122a, 1-122b configured to project light in a rearward direction through the second opening 1-154 toward the user's eyes.

In at least one example, referring to both FIGS. 1B and 1C, the display assembly 1-108 can be a front-facing, forward display assembly including a display screen configured to project light in a first, forward direction and the rear facing display screens 1-122a-b can be configured to project light in a second, rearward direction opposite the first direction. As noted above, the light seal 1-110 can be configured to block light external to the HMD 1-100 from reaching the user's eyes, including light projected by the forward facing display screen of the display assembly 1-108 shown in the front perspective view of FIG. 1B. In at least one example, the HMD 1-100 can also include a curtain 1-124 occluding the second opening 1-154 between the housing 1-150 and the rear-facing display assemblies 1-120a-b. In at least one example, the curtain 1-124 can be elastic or at least partially elastic.

Any of the features, components, and/or parts, including the arrangements and configurations thereof shown in FIGS. 1B and 1C can be included, either alone or in any combination, in any of the other examples of devices, features, components, and parts shown in FIGS. 1D-IF and described herein. Likewise, any of the features, components, and/or parts, including the arrangements and configurations thereof shown and described with reference to FIGS. 1D-IF can be included, either alone or in any combination, in the example of the devices, features, components, and parts shown in FIGS. 1B and 1C.

FIG. 1D illustrates an exploded view of an example of an HMD 1-200 including various portions or parts thereof separated according to the modularity and selective coupling of those parts. For example, the HMD 1-200 can include a band 1-216 which can be selectively coupled to first and second electronic straps 1-205a, 1-205b. The first securement strap 1-205a can include a first electronic component 1-212a and the second securement strap 1-205b can include a second electronic component 1-212b. In at least one example, the first and second straps 1-205a-b can be removably coupled to the display unit 1-202.

In addition, the HMD 1-200 can include a light seal 1-210 configured to be removably coupled to the display unit 1-202. The HMD 1-200 can also include lenses 1-218 which can be removably coupled to the display unit 1-202, for example over first and second display assemblies including display screens. The lenses 1-218 can include customized prescription lenses configured for corrective vision. As noted, each part shown in the exploded view of FIG. 1D and described above can be removably coupled, attached, re-attached, and changed out to update parts or swap out parts for different users. For example, bands such as the band 1-216, light seals such as the light seal 1-210, lenses such as the lenses 1-218, and electronic straps such as the straps 1-205a-b can be swapped out depending on the user such that these parts are customized to fit and correspond to the individual user of the HMD 1-200.

Any of the features, components, and/or parts, including the arrangements and configurations thereof shown in FIG. 1D can be included, either alone or in any combination, in any of the other examples of devices, features, components, and parts shown in FIGS. 1B, 1C, and 1E-1F and described herein. Likewise, any of the features, components, and/or parts, including the arrangements and configurations thereof shown and described with reference to FIGS. 1B, IC, and 1E-1F can be included, cither alone or in any combination, in the example of the devices, features, components, and parts shown in FIG. 1D.

FIG. 1E illustrates an exploded view of an example of a display unit 1-306 of a HMD. The display unit 1-306 can include a front display assembly 1-308, a frame/housing assembly 1-350, and a curtain assembly 1-324. The display unit 1-306 can also include a sensor assembly 1-356, logic board assembly 1-358, and cooling assembly 1-360 disposed between the frame assembly 1-350 and the front display assembly 1-308. In at least one example, the display unit 1-306 can also include a rear-facing display assembly 1-320 including first and second rear-facing display screens 1-322a, 1-322b disposed between the frame 1-350 and the curtain assembly 1-324.

In at least one example, the display unit 1-306 can also include a motor assembly 1-362 configured as an adjustment mechanism for adjusting the positions of the display screens 1-322a-b of the display assembly 1-320 relative to the frame 1-350. In at least one example, the display assembly 1-320 is mechanically coupled to the motor assembly 1-362, with at least one motor for each display screen 1-322a-b, such that the motors can translate the display screens 1-322a-b to match an interpupillary distance of the user's eyes.

In at least one example, the display unit 1-306 can include a dial or button 1-328 depressible relative to the frame 1-350 and accessible to the user outside the frame 1-350. The button 1-328 can be electronically connected to the motor assembly 1-362 via a controller such that the button 1-328 can be manipulated by the user to cause the motors of the motor assembly 1-362 to adjust the positions of the display screens 1-322a-b.

Any of the features, components, and/or parts, including the arrangements and configurations thereof shown in FIG. 1E can be included, cither alone or in any combination, in any of the other examples of devices, features, components, and parts shown in FIGS. 1B-1D and 1F and described herein. Likewise, any of the features, components, and/or parts, including the arrangements and configurations thereof shown and described with reference to FIGS. 1B-1D and 1F can be included, cither alone or in any combination, in the example of the devices, features, components, and parts shown in FIG. 1E.

FIG. 1F illustrates an exploded view of another example of a display unit 1-406 of a HMD device similar to other HMD devices described herein. The display unit 1-406 can include a front display assembly 1-402, a sensor assembly 1-456, a logic board assembly 1-458, a cooling assembly 1-460, a frame assembly 1-450, a rear-facing display assembly 1-421, and a curtain assembly 1-424. The display unit 1-406 can also include a motor assembly 1-462 for adjusting the positions of first and second display sub-assemblies 1-420a, 1-420b of the rear-facing display assembly 1-421, including first and second respective display screens for interpupillary adjustments, as described above.

The various parts, systems, and assemblies shown in the exploded view of FIG. 1F are described in greater detail herein with reference to FIGS. 1B-1E as well as subsequent figures referenced in the present disclosure. The display unit 1-406 shown in FIG. 1F can be assembled and integrated with the securement mechanisms shown in FIGS. 1B-1E, including the electronic straps, bands, and other components including light seals, connection assemblies, and so forth.

Any of the features, components, and/or parts, including the arrangements and configurations thereof shown in FIG. 1F can be included, either alone or in any combination, in any of the other examples of devices, features, components, and parts shown in FIGS. 1B-1E and described herein. Likewise, any of the features, components, and/or parts, including the arrangements and configurations thereof shown and described with reference to FIGS. 1B-1E can be included, cither alone or in any combination, in the example of the devices, features, components, and parts shown in FIG. 1F.

FIG. 1G illustrates a perspective, exploded view of a front cover assembly 3-100 of an HMD device described herein, for example the front cover assembly 3-1 of the HMD 3-100 shown in FIG. 1G or any other HMD device shown and described herein. The front cover assembly 3-100 shown in FIG. 1G can include a transparent or semi-transparent cover 3-102, shroud 3-104 (or “canopy”), adhesive layers 3-106, display assembly 3-108 including a lenticular lens panel or array 3-110, and a structural trim 3-112. The adhesive layer 3-106 can secure the shroud 3-104 and/or transparent cover 3-102 to the display assembly 3-108 and/or the trim 3-112. The trim 3-112 can secure the various components of the front cover assembly 3-100 to a frame or chassis of the HMD device.

In at least one example, as shown in FIG. 1G, the transparent cover 3-102, shroud 3-104, and display assembly 3-108, including the lenticular lens array 3-110, can be curved to accommodate the curvature of a user's face. The transparent cover 3-102 and the shroud 3-104 can be curved in two or three dimensions, e.g., vertically curved in the Z-direction in and out of the Z-X plane and horizontally curved in the X-direction in and out of the Z-X plane. In at least one example, the display assembly 3-108 can include the lenticular lens array 3-110 as well as a display panel having pixels configured to project light through the shroud 3-104 and the transparent cover 3-102. The display assembly 3-108 can be curved in at least one direction, for example the horizontal direction, to accommodate the curvature of a user's face from one side (e.g., left side) of the face to the other (e.g., right side). In at least one example, each layer or component of the display assembly 3-108, which will be shown in subsequent figures and described in more detail, but which can include the lenticular lens array 3-110 and a display layer, can be similarly or concentrically curved in the horizontal direction to accommodate the curvature of the user's face.

In at least one example, the shroud 3-104 can include a transparent or semi-transparent material through which the display assembly 3-108 projects light. In one example, the shroud 3-104 can include one or more opaque portions, for example opaque ink-printed portions or other opaque film portions on the rear surface of the shroud 3-104. The rear surface can be the surface of the shroud 3-104 facing the user's eyes when the HMD device is donned. In at least one example, opaque portions can be on the front surface of the shroud 3-104 opposite the rear surface. In at least one example, the opaque portion or portions of the shroud 3-104 can include perimeter portions visually hiding any components around an outside perimeter of the display screen of the display assembly 3-108. In this way, the opaque portions of the shroud hide any other components, including electronic components, structural components, and so forth, of the HMD device that would otherwise be visible through the transparent or semi-transparent cover 3-102 and/or shroud 3-104.

In at least one example, the shroud 3-104 can define one or more apertures transparent portions 3-120 through which sensors can send and receive signals. In one example, the portions 3-120 are apertures through which the sensors can extend or send and receive signals. In one example, the portions 3-120 are transparent portions, or portions more transparent than surrounding semi-transparent or opaque portions of the shroud, through which sensors can send and receive signals through the shroud and through the transparent cover 3-102. In one example, the sensors can include cameras, IR sensors, LUX sensors, or any other visual or non-visual environmental sensors of the HMD device.

Any of the features, components, and/or parts, including the arrangements and configurations thereof shown in FIG. 1G can be included, either alone or in any combination, in any of the other examples of devices, features, components, and parts described herein. Likewise, any of the features, components, and/or parts, including the arrangements and configurations thereof shown and described herein can be included, either alone or in any combination, in the example of the devices, features, components, and parts shown in FIG. 1G.

FIG. 1H illustrates an exploded view of an example of an HMD device 6-100. The HMD device 6-100 can include a sensor array or system 6-102 including one or more sensors, cameras, projectors, and so forth mounted to one or more components of the HMD 6-100. In at least one example, the sensor system 6-102 can include a bracket 1-338 on which one or more sensors of the sensor system 6-102 can be fixed/secured.

FIG. 1I illustrates a portion of an HMD device 6-100 including a front transparent cover 6-104 and a sensor system 6-102. The sensor system 6-102 can include a number of different sensors, emitters, receivers, including cameras, IR sensors, projectors, and so forth. The transparent cover 6-104 is illustrated in front of the sensor system 6-102 to illustrate relative positions of the various sensors and emitters as well as the orientation of each sensor/emitter of the system 6-102. As referenced herein, “sideways,” “side,” “lateral,” “horizontal,” and other similar terms refer to orientations or directions as indicated by the X-axis shown in FIG. 1J. Terms such as “vertical,” “up,” “down,” and similar terms refer to orientations or directions as indicated by the Z-axis shown in FIG. 1J. Terms such as “frontward,” “rearward,” “forward,” backward,” and similar terms refer to orientations or directions as indicated by the Y-axis shown in FIG. 1J.

In at least one example, the transparent cover 6-104 can define a front, external surface of the HMD device 6-100 and the sensor system 6-102, including the various sensors and components thereof, can be disposed behind the cover 6-104 in the Y-axis/direction. The cover 6-104 can be transparent or semi-transparent to allow light to pass through the cover 6-104, both light detected by the sensor system 6-102 and light emitted thereby.

As noted elsewhere herein, the HMD device 6-100 can include one or more controllers including processors for electrically coupling the various sensors and emitters of the sensor system 6-102 with one or more mother boards, processing units, and other electronic devices such as display screens and the like. In addition, as will be shown in more detail below with reference to other figures, the various sensors, emitters, and other components of the sensor system 6-102 can be coupled to various structural frame members, brackets, and so forth of the HMD device 6-100 not shown in FIG. 1I. FIG. 1I shows the components of the sensor system 6-102 unattached and un-coupled electrically from other components for the sake of illustrative clarity.

In at least one example, the device can include one or more controllers having processors configured to execute instructions stored on memory components electrically coupled to the processors. The instructions can include, or cause the processor to execute, one or more algorithms for self-correcting angles and positions of the various cameras described herein overtime with use as the initial positions, angles, or orientations of the cameras get bumped or deformed due to unintended drop events or other events.

In at least one example, the sensor system 6-102 can include one or more scene cameras 6-106. The system 6-102 can include two scene cameras 6-102 disposed on either side of the nasal bridge or arch of the HMD device 6-100 such that each of the two cameras 6-106 correspond generally in position with left and right eyes of the user behind the cover 6-103. In at least one example, the scene cameras 6-106 are oriented generally forward in the Y-direction to capture images in front of the user during use of the HMD 6-100. In at least one example, the scene cameras are color cameras and provide images and content for MR video pass through to the display screens facing the user's eyes when using the HMD device 6-100. The scene cameras 6-106 can also be used for environment and object reconstruction.

In at least one example, the sensor system 6-102 can include a first depth sensor 6-108 pointed generally forward in the Y-direction. In at least one example, the first depth sensor 6-108 can be used for environment and object reconstruction as well as user hand and body tracking. In at least one example, the sensor system 6-102 can include a second depth sensor 6-110 disposed centrally along the width (e.g., along the X-axis) of the HMD device 6-100. For example, the second depth sensor 6-110 can be disposed above the central nasal bridge or accommodating features over the nose of the user when donning the HMD 6-100. In at least one example, the second depth sensor 6-110 can be used for environment and object reconstruction as well as hand and body tracking. In at least one example, the second depth sensor can include a LIDAR sensor.

In at least one example, the sensor system 6-102 can include a depth projector 6-112 facing generally forward to project electromagnetic waves, for example in the form of a predetermined pattern of light dots, out into and within a field of view of the user and/or the scene cameras 6-106 or a field of view including and beyond the field of view of the user and/or scene cameras 6-106. In at least one example, the depth projector can project electromagnetic waves of light in the form of a dotted light pattern to be reflected off objects and back into the depth sensors noted above, including the depth sensors 6-108, 6-110. In at least one example, the depth projector 6-112 can be used for environment and object reconstruction as well as hand and body tracking.

In at least one example, the sensor system 6-102 can include downward facing cameras 6-114 with a field of view pointed generally downward relative to the HMD device 6-100 in the Z-axis. In at least one example, the downward cameras 6-114 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The downward cameras 6-114, for example, can be used to capture facial expressions and movements for the face of the user below the HMD device 6-100, including the checks, mouth, and chin.

In at least one example, the sensor system 6-102 can include jaw cameras 6-116. In at least one example, the jaw cameras 6-116 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The jaw cameras 6-116, for example, can be used to capture facial expressions and movements for the face of the user below the HMD device 6-100, including the user's jaw, cheeks, mouth, and chin. For hand and body tracking, headset tracking, and facial avatar

In at least one example, the sensor system 6-102 can include side cameras 6-118. The side cameras 6-118 can be oriented to capture side views left and right in the X-axis or direction relative to the HMD device 6-100. In at least one example, the side cameras 6-118 can be used for hand and body tracking, headset tracking, and facial avatar detection and re-creation.

In at least one example, the sensor system 6-102 can include a plurality of eye tracking and gaze tracking sensors for determining an identity, status, and gaze direction of a user's eyes during and/or before use. In at least one example, the eye/gaze tracking sensors can include nasal eye cameras 6-120 disposed on either side of the user's nose and adjacent the user's nose when donning the HMD device 6-100. The eye/gaze sensors can also include bottom eye cameras 6-122 disposed below respective user eyes for capturing images of the eyes for facial avatar detection and creation, gaze tracking, and iris identification functions.

In at least one example, the sensor system 6-102 can include infrared illuminators 6-124 pointed outward from the HMD device 6-100 to illuminate the external environment and any object therein with IR light for IR detection with one or more IR sensors of the sensor system 6-102. In at least one example, the sensor system 6-102 can include a flicker sensor 6-126 and an ambient light sensor 6-128. In at least one example, the flicker sensor 6-126 can detect overhead light refresh rates to avoid display flicker. In one example, the infrared illuminators 6-124 can include light emitting diodes and can be used especially for low light environments for illuminating user hands and other objects in low light for detection by infrared sensors of the sensor system 6-102.

In at least one example, multiple sensors, including the scene cameras 6-106, the downward cameras 6-114, the jaw cameras 6-116, the side cameras 6-118, the depth projector 6-112, and the depth sensors 6-108, 6-110 can be used in combination with an electrically coupled controller to combine depth data with camera data for hand tracking and for size determination for better hand tracking and object recognition and tracking functions of the HMD device 6-100. In at least one example, the downward cameras 6-114, jaw cameras 6-116, and side cameras 6-118 described above and shown in FIG. 1I can be wide angle cameras operable in the visible and infrared spectrums. In at least one example, these cameras 6-114, 6-116, 6-118 can operate only in black and white light detection to simplify image processing and gain sensitivity.

Any of the features, components, and/or parts, including the arrangements and configurations thereof shown in FIG. 1I can be included, either alone or in any combination, in any of the other examples of devices, features, components, and parts shown in FIGS. 1J-1L and described herein. Likewise, any of the features, components, and/or parts, including the arrangements and configurations thereof shown and described with reference to FIGS. 1J-1L can be included, either alone or in any combination, in the example of the devices, features, components, and parts shown in FIG. 1I.

FIG. 1J illustrates a lower perspective view of an example of an HMD 6-200 including a cover or shroud 6-204 secured to a frame 6-230. In at least one example, the sensors 6-203 of the sensor system 6-202 can be disposed around a perimeter of the HMD 6-200 such that the sensors 6-203 are outwardly disposed around a perimeter of a display region or area 6-232 so as not to obstruct a view of the displayed light. In at least one example, the sensors can be disposed behind the shroud 6-204 and aligned with transparent portions of the shroud allowing sensors and projectors to allow light back and forth through the shroud 6-204. In at least one example, opaque ink or other opaque material or films/layers can be disposed on the shroud 6-204 around the display area 6-232 to hide components of the HMD 6-200 outside the display area 6-232 other than the transparent portions defined by the opaque portions, through which the sensors and projectors send and receive light and electromagnetic signals during operation. In at least one example, the shroud 6-204 allows light to pass therethrough from the display (e.g., within the display region 6-232) but not radially outward from the display region around the perimeter of the display and shroud 6-204.

In some examples, the shroud 6-204 includes a transparent portion 6-205 and an opaque portion 6-207, as described above and elsewhere herein. In at least one example, the opaque portion 6-207 of the shroud 6-204 can define one or more transparent regions 6-209 through which the sensors 6-203 of the sensor system 6-202 can send and receive signals. In the illustrated example, the sensors 6-203 of the sensor system 6-202 sending and receiving signals through the shroud 6-204, or more specifically through the transparent regions 6-209 of the (or defined by) the opaque portion 6-207 of the shroud 6-204 can include the same or similar sensors as those shown in the example of FIG. 1I, for example depth sensors 6-108 and 6-110, depth projector 6-112, first and second scene cameras 6-106, first and second downward cameras 6-114, first and second side cameras 6-118, and first and second infrared illuminators 6-124. These sensors are also shown in the examples of FIGS. 1K and 1L. Other sensors, sensor types, number of sensors, and relative positions thereof can be included in one or more other examples of HMDs.

Any of the features, components, and/or parts, including the arrangements and configurations thereof shown in FIG. 1J can be included, either alone or in any combination, in any of the other examples of devices, features, components, and parts shown in FIGS. 11 and 1K-1L and described herein. Likewise, any of the features, components, and/or parts, including the arrangements and configurations thereof shown and described with reference to FIGS. 11 and 1K-1L can be included, either alone or in any combination, in the example of the devices, features, components, and parts shown in FIG. 1J.

FIG. 1K illustrates a front view of a portion of an example of an HMD device 6-300 including a display 6-334, brackets 6-336, 6-338, and frame or housing 6-330. The example shown in FIG. 1K does not include a front cover or shroud in order to illustrate the brackets 6-336, 6-338. For example, the shroud 6-204 shown in FIG. 1J includes the opaque portion 6-207 that would visually cover/block a view of anything outside (e.g., radially/peripherally outside) the display/display region 6-334, including the sensors 6-303 and bracket 6-338.

In at least one example, the various sensors of the sensor system 6-302 are coupled to the brackets 6-336, 6-338. In at least one example, the scene cameras 6-306 include tight tolerances of angles relative to one another. For example, the tolerance of mounting angles between the two scene cameras 6-306 can be 0.5 degrees or less, for example 0.3 degrees or less. In order to achieve and maintain such a tight tolerance, in one example, the scene cameras 6-306 can be mounted to the bracket 6-338 and not the shroud. The bracket can include cantilevered arms on which the scene cameras 6-306 and other sensors of the sensor system 6-302 can be mounted to remain un-deformed in position and orientation in the case of a drop event by a user resulting in any deformation of the other bracket 6-226, housing 6-330, and/or shroud.

Any of the features, components, and/or parts, including the arrangements and configurations thereof shown in FIG. 1K can be included, either alone or in any combination, in any of the other examples of devices, features, components, and parts shown in FIGS. 1I-1J and 1L and described herein. Likewise, any of the features, components, and/or parts, including the arrangements and configurations thereof shown and described with reference to FIGS. 1I-1J and 1L can be included, either alone or in any combination, in the example of the devices, features, components, and parts shown in FIG. 1K.

FIG. 1L illustrates a bottom view of an example of an HMD 6-400 including a front display/cover assembly 6-404 and a sensor system 6-402. The sensor system 6-402 can be similar to other sensor systems described above and elsewhere herein, including in reference to FIGS. 1I-1K. In at least one example, the jaw cameras 6-416 can be facing downward to capture images of the user's lower facial features. In one example, the jaw cameras 6-416 can be coupled directly to the frame or housing 6-430 or one or more internal brackets directly coupled to the frame or housing 6-430 shown. The frame or housing 6-430 can include one or more apertures/openings 6-415 through which the jaw cameras 6-416 can send and receive signals.

Any of the features, components, and/or parts, including the arrangements and configurations thereof shown in FIG. 1L can be included, either alone or in any combination, in any of the other examples of devices, features, components, and parts shown in FIGS. 1I-1K and described herein. Likewise, any of the features, components, and/or parts, including the arrangements and configurations thereof shown and described with reference to FIGS. 1I-1K can be included, either alone or in any combination, in the example of the devices, features, components, and parts shown in FIG. 1L.

FIG. 1M illustrates a rear perspective view of an inter-pupillary distance (IPD) adjustment system 11.1.1-102 including first and second optical modules 11.1.1-104a-b slidably engaging/coupled to respective guide-rods 11.1.1-108a-b and motors 11.1.1-110a-b of left and right adjustment subsystems 11.1.1-106a-b. The IPD adjustment system 11.1.1-102 can be coupled to a bracket 11.1.1-112 and include a button 11.1.1-114 in electrical communication with the motors 11.1.1-110a-b. In at least one example, the button 11.1.1-114 can electrically communicate with the first and second motors 11.1.1-110a-b via a processor or other circuitry components to cause the first and second motors 11.1.1-110a-b to activate and cause the first and second optical modules 11.1.1-104a-b, respectively, to change position relative to one another.

In at least one example, the first and second optical modules 11.1.1-104a-b can include respective display screens configured to project light toward the user's eyes when donning the HMD 11.1.1-100. In at least one example, the user can manipulate (e.g., depress and/or rotate) the button 11.1.1-114 to activate a positional adjustment of the optical modules 11.1.1-104a-b to match the inter-pupillary distance of the user's eyes. The optical modules 11.1.1-104a-b can also include one or more cameras or other sensors/sensor systems for imaging and measuring the IPD of the user such that the optical modules 11.1.1-104a-b can be adjusted to match the IPD.

In one example, the user can manipulate the button 11.1.1-114 to cause an automatic positional adjustment of the first and second optical modules 11.1.1-104a-b. In one example, the user can manipulate the button 11.1.1-114 to cause a manual adjustment such that the optical modules 11.1.1-104a-b move further or closer away, for example when the user rotates the button 11.1.1-114 one way or the other, until the user visually matches her/his own IPD. In one example, the manual adjustment is electronically communicated via one or more circuits and power for the movements of the optical modules 11.1.1-104a-b via the motors 11.1.1-110a-b is provided by an electrical power source. In one example, the adjustment and movement of the optical modules 11.1.1-104a-b via a manipulation of the button 11.1.1-114 is mechanically actuated via the movement of the button 11.1.1-114.

Any of the features, components, and/or parts, including the arrangements and configurations thereof shown in FIG. 1M can be included, either alone or in any combination, in any of the other examples of devices, features, components, and parts shown in any other figures shown and described herein. Likewise, any of the features, components, and/or parts, including the arrangements and configurations thereof shown and described with reference to any other figure shown and described herein, either alone or in any combination, in the example of the devices, features, components, and parts shown in FIG. 1M.

FIG. 1N illustrates a front perspective view of a portion of an HMD 11.1.2-100, including an outer structural frame 11.1.2-102 and an inner or intermediate structural frame 11.1.2-104 defining first and second apertures 11.1.2-106a, 11.1.2-106b. The apertures 11.1.2-106a-b are shown in dotted lines in FIG. 1N because a view of the apertures 11.1.2-106a-b can be blocked by one or more other components of the HMD 11.1.2-100 coupled to the inner frame 11.1.2-104 and/or the outer frame 11.1.2-102, as shown. In at least one example, the HMD 11.1.2-100 can include a first mounting bracket 11.1.2-108 coupled to the inner frame 11.1.2-104. In at least one example, the mounting bracket 11.1.2-108 is coupled to the inner frame 11.1.2-104 between the first and second apertures 11.1.2-106a-b.

The mounting bracket 11.1.2-108 can include a middle or central portion 11.1.2-109 coupled to the inner frame 11.1.2-104. In some examples, the middle or central portion 11.1.2-109 may not be the geometric middle or center of the bracket 11.1.2-108. Rather, the middle/central portion 11.1.2-109 can be disposed between first and second cantilevered extension arms extending away from the middle portion 11.1.2-109. In at least one example, the mounting bracket 108 includes a first cantilever arm 11.1.2-112 and a second cantilever arm 11.1.2-114 extending away from the middle portion 11.1.2-109 of the mount bracket 11.1.2-108 coupled to the inner frame 11.1.2-104.

As shown in FIG. 1N, the outer frame 11.1.2-102 can define a curved geometry on a lower side thereof to accommodate a user's nose when the user dons the HMD 11.1.2-100. The curved geometry can be referred to as a nose bridge 11.1.2-111 and be centrally located on a lower side of the HMD 11.1.2-100 as shown. In at least one example, the mounting bracket 11.1.2-108 can be connected to the inner frame 11.1.2-104 between the apertures 11.1.2-106a-b such that the cantilevered arms 11.1.2-112, 11.1.2-114 extend downward and laterally outward away from the middle portion 11.1.2-109 to compliment the nose bridge 11.1.2-111 geometry of the outer frame 11.1.2-102. In this way, the mounting bracket 11.1.2-108 is configured to accommodate the user's nose as noted above. The nose bridge 11.1.2-111 geometry accommodates the nose in that the nose bridge 11.1.2-111 provides a curvature that curves with, above, over, and around the user's nose for comfort and fit.

The first cantilever arm 11.1.2-112 can extend away from the middle portion 11.1.2-109 of the mounting bracket 11.1.2-108 in a first direction and the second cantilever arm 11.1.2-114 can extend away from the middle portion 11.1.2-109 of the mounting bracket 11.1.2-10 in a second direction opposite the first direction. The first and second cantilever arms 11.1.2-112, 11.1.2-114 are referred to as “cantilevered” or “cantilever” arms because each arm 11.1.2-112, 11.1.2-114, includes a distal free end 11.1.2-116, 11.1.2-118, respectively, which are free of affixation from the inner and outer frames 11.1.2-102, 11.1.2-104. In this way, the arms 11.1.2-112, 11.1.2-114 are cantilevered from the middle portion 11.1.2-109, which can be connected to the inner frame 11.1.2-104, with distal ends 11.1.2-102, 11.1.2-104 unattached.

In at least one example, the HMD 11.1.2-100 can include one or more components coupled to the mounting bracket 11.1.2-108. In one example, the components include a plurality of sensors 11.1.2-110a-f. Each sensor of the plurality of sensors 11.1.2-110a-f can include various types of sensors, including cameras, IR sensors, and so forth. In some examples, one or more of the sensors 11.1.2-110a-f can be used for object recognition in three-dimensional space such that it is important to maintain a precise relative position of two or more of the plurality of sensors 11.1.2-110a-f. The cantilevered nature of the mounting bracket 11.1.2-108 can protect the sensors 11.1.2-110a-f from damage and altered positioning in the case of accidental drops by the user. Because the sensors 11.1.2-110a-f are cantilevered on the arms 11.1.2-112, 11.1.2-114 of the mounting bracket 11.1.2-108, stresses and deformations of the inner and/or outer frames 11.1.2-104, 11.1.2-102 are not transferred to the cantilevered arms 11.1.2-112, 11.1.2-114 and thus do not affect the relative positioning of the sensors 11.1.2-110a-f coupled/mounted to the mounting bracket 11.1.2-108.

Any of the features, components, and/or parts, including the arrangements and configurations thereof shown in FIG. 1N can be included, either alone or in any combination, in any of the other examples of devices, features, components, and described herein. Likewise, any of the features, components, and/or parts, including the arrangements and configurations thereof shown and described herein can be included, either alone or in any combination, in the example of the devices, features, components, and parts shown in FIG. 1N.

FIG. 10 illustrates an example of an optical module 11.3.2-100 for use in an electronic device such as an HMD, including HMD devices described herein. As shown in one or more other examples described herein, the optical module 11.3.2-100 can be one of two optical modules within an HMD, with each optical module aligned to project light toward a user's eye. In this way, a first optical module can project light via a display screen toward a user's first eye and a second optical module of the same device can project light via another display screen toward the user's second eye.

In at least one example, the optical module 11.3.2-100 can include an optical frame or housing 11.3.2-102, which can also be referred to as a barrel or optical module barrel. The optical module 11.3.2-100 can also include a display 11.3.2-104, including a display screen or multiple display screens, coupled to the housing 11.3.2-102. The display 11.3.2-104 can be coupled to the housing 11.3.2-102 such that the display 11.3.2-104 is configured to project light toward the eye of a user when the HMD of which the display module 11.3.2-100 is a part is donned during use. In at least one example, the housing 11.3.2-102 can surround the display 11.3.2-104 and provide connection features for coupling other components of optical modules described herein.

In one example, the optical module 11.3.2-100 can include one or more cameras 11.3.2-106 coupled to the housing 11.3.2-102. The camera 11.3.2-106 can be positioned relative to the display 11.3.2-104 and housing 11.3.2-102 such that the camera 11.3.2-106 is configured to capture one or more images of the user's eye during use. In at least one example, the optical module 11.3.2-100 can also include a light strip 11.3.2-108 surrounding the display 11.3.2-104. In one example, the light strip 11.3.2-108 is disposed between the display 11.3.2-104 and the camera 11.3.2-106. The light strip 11.3.2-108 can include a plurality of lights 11.3.2-110. The plurality of lights can include one or more light emitting diodes (LEDs) or other lights configured to project light toward the user's eye when the HMD is donned. The individual lights 11.3.2-110 of the light strip 11.3.2-108 can be spaced about the strip 11.3.2-108 and thus spaced about the display 11.3.2-104 uniformly or non-uniformly at various locations on the strip 11.3.2-108 and around the display 11.3.2-104.

In at least one example, the housing 11.3.2-102 defines a viewing opening 11.3.2-101 through which the user can view the display 11.3.2-104 when the HMD device is donned. In at least one example, the LEDs are configured and arranged to emit light through the viewing opening 11.3.2-101 and onto the user's eye. In one example, the camera 11.3.2-106 is configured to capture one or more images of the user's eye through the viewing opening 11.3.2-101.

As noted above, each of the components and features of the optical module 11.3.2-100 shown in FIG. 10 can be replicated in another (e.g., second) optical module disposed with the HMD to interact (e.g., project light and capture images) of another eye of the user.

Any of the features, components, and/or parts, including the arrangements and configurations thereof shown in FIG. 10 can be included, either alone or in any combination, in any of the other examples of devices, features, components, and parts shown in FIG. 1P or otherwise described herein. Likewise, any of the features, components, and/or parts, including the arrangements and configurations thereof shown and described with reference to FIG. 1P or otherwise described herein can be included, either alone or in any combination, in the example of the devices, features, components, and parts shown in FIG. 10.

FIG. 1P illustrates a cross-sectional view of an example of an optical module 11.3.2-200 including a housing 11.3.2-202, display assembly 11.3.2-204 coupled to the housing 11.3.2-202, and a lens 11.3.2-216 coupled to the housing 11.3.2-202. In at least one example, the housing 11.3.2-202 defines a first aperture or channel 11.3.2-212 and a second aperture or channel 11.3.2-214. The channels 11.3.2-212, 11.3.2-214 can be configured to slidably engage respective rails or guide rods of an HMD device to allow the optical module 11.3.2-200 to adjust in position relative to the user's eyes for match the user's interpapillary distance (IPD). The housing 11.3.2-202 can slidably engage the guide rods to secure the optical module 11.3.2-200 in place within the HMD.

In at least one example, the optical module 11.3.2-200 can also include a lens 11.3.2-216 coupled to the housing 11.3.2-202 and disposed between the display assembly 11.3.2-204 and the user's eyes when the HMD is donned. The lens 11.3.2-216 can be configured to direct light from the display assembly 11.3.2-204 to the user's eye. In at least one example, the lens 11.3.2-216 can be a part of a lens assembly including a corrective lens removably attached to the optical module 11.3.2-200. In at least one example, the lens 11.3.2-216 is disposed over the light strip 11.3.2-208 and the one or more eye-tracking cameras 11.3.2-206 such that the camera 11.3.2-206 is configured to capture images of the user's eye through the lens 11.3.2-216 and the light strip 11.3.2-208 includes lights configured to project light through the lens 11.3.2-216 to the users' eye during use.

Any of the features, components, and/or parts, including the arrangements and configurations thereof shown in FIG. 1P can be included, either alone or in any combination, in any of the other examples of devices, features, components, and parts and described herein. Likewise, any of the features, components, and/or parts, including the arrangements and configurations thereof shown and described herein can be included, either alone or in any combination, in the example of the devices, features, components, and parts shown in FIG. 1P.

FIG. 2 is a block diagram of an example of the controller 110 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some embodiments, the one or more communication buses 204 include circuitry that interconnects and controls communications between system components. In some embodiments, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some embodiments, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some embodiments, the memory 220 or the non-transitory computer readable storage medium of the memory 220 stores the following programs, modules and data structures, or a subset thereof including an optional operating system 230 and an XR experience module 240.

The operating system 230 includes instructions for handling various basic system services and for performing hardware dependent tasks. In some embodiments, the XR experience module 240 is configured to manage and coordinate one or more XR experiences for one or more users (e.g., a single XR experience for one or more users, or multiple XR experiences for respective groups of one or more users). To that end, in various embodiments, the XR experience module 240 includes a data obtaining unit 242, a tracking unit 244, a coordination unit 246, and a data transmitting unit 248.

In some embodiments, the data obtaining unit 242 is configured to obtain data (e.g., presentation data, interaction data, sensor data, location data, etc.) from at least the display generation component 120 of FIG. 1A, and optionally one or more of the input devices 125, output devices 155, sensors 190, and/or peripheral devices 195. To that end, in various embodiments, the data obtaining unit 242 includes instructions and/or logic therefor, and heuristics and metadata therefor.

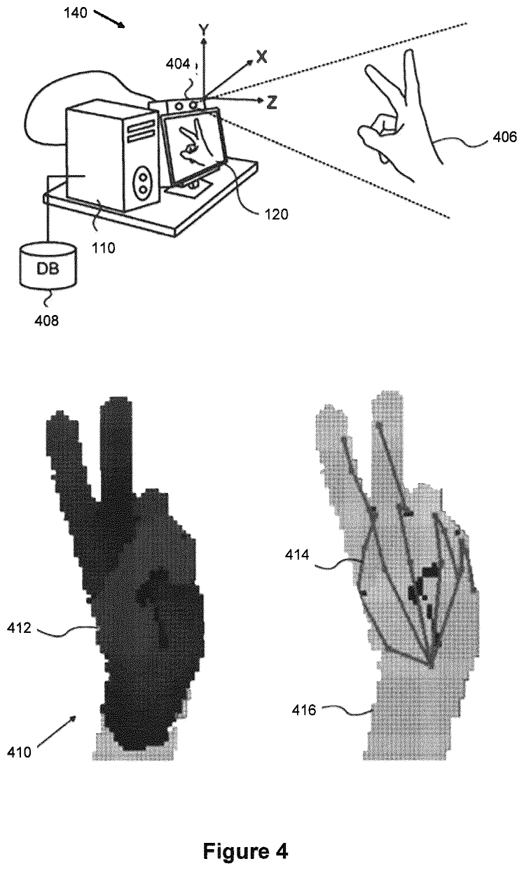

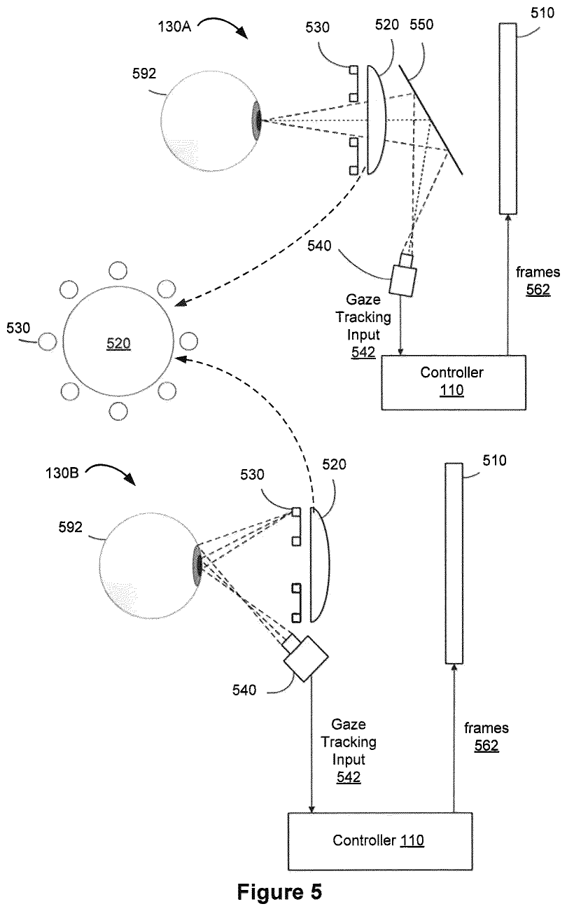

In some embodiments, the tracking unit 244 is configured to map the scene 105 and to track the position/location of at least the display generation component 120 with respect to the scene 105 of FIG. 1A, and optionally, to one or more of the input devices 125, output devices 155, sensors 190, and/or peripheral devices 195. To that end, in various embodiments, the tracking unit 244 includes instructions and/or logic therefor, and heuristics and metadata therefor. In some embodiments, the tracking unit 244 includes hand tracking unit 245 and/or eye tracking unit 243. In some embodiments, the hand tracking unit 245 is configured to track the position/location of one or more portions of the user's hands, and/or motions of one or more portions of the user's hands with respect to the scene 105 of FIG. 1A, relative to the display generation component 120, and/or relative to a coordinate system defined relative to the user's hand. The hand tracking unit 245 is described in greater detail below with respect to FIG. 4. In some embodiments, the eye tracking unit 243 is configured to track the position and movement of the user's gaze (or more broadly, the user's eyes, face, or head) with respect to the scene 105 (e.g., with respect to the physical environment and/or to the user (e.g., the user's hand)) or with respect to the XR content displayed via the display generation component 120. The eye tracking unit 243 is described in greater detail below with respect to FIG. 5.

In some embodiments, the coordination unit 246 is configured to manage and coordinate the XR experience presented to the user by the display generation component 120, and optionally, by one or more of the output devices 155 and/or peripheral devices 195. To that end, in various embodiments, the coordination unit 246 includes instructions and/or logic therefor, and heuristics and metadata therefor.

In some embodiments, the data transmitting unit 248 is configured to transmit data (e.g., presentation data, location data, etc.) to at least the display generation component 120, and optionally, to one or more of the input devices 125, output devices 155, sensors 190, and/or peripheral devices 195. To that end, in various embodiments, the data transmitting unit 248 includes instructions and/or logic therefor, and heuristics and metadata therefor.

Although the data obtaining unit 242, the tracking unit 244 (e.g., including the eye tracking unit 243 and the hand tracking unit 245), the coordination unit 246, and the data transmitting unit 248 are shown as residing on a single device (e.g., the controller 110), it should be understood that in other embodiments, any combination of the data obtaining unit 242, the tracking unit 244 (e.g., including the eye tracking unit 243 and the hand tracking unit 245), the coordination unit 246, and the data transmitting unit 248 may be located in separate computing devices.

Moreover, FIG. 2 is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 3 is a block diagram of an example of the display generation component 120 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the display generation component 120 (e.g., HMD) includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some embodiments, the one or more communication buses 304 include circuitry that interconnects and controls communications between system components. In some embodiments, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some embodiments, the one or more XR displays 312 are configured to provide the XR experience to the user. In some embodiments, the one or more XR displays 312 correspond to holographic, digital light processing (DLP), liquid-crystal display (LCD), liquid-crystal on silicon (LCoS), organic light-emitting field-effect transistor (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more XR displays 312 correspond to diffractive, reflective, polarized, holographic, etc. waveguide displays. For example, the display generation component 120 (e.g., HMD) includes a single XR display. In another example, the display generation component 120 includes an XR display for each eye of the user. In some embodiments, the one or more XR displays 312 are capable of presenting MR and VR content. In some embodiments, the one or more XR displays 312 are capable of presenting MR or VR content.

In some embodiments, the one or more image sensors 314 are configured to obtain image data that corresponds to at least a portion of the face of the user that includes the eyes of the user (and may be referred to as an eye-tracking camera). In some embodiments, the one or more image sensors 314 are configured to obtain image data that corresponds to at least a portion of the user's hand(s) and optionally arm(s) of the user (and may be referred to as a hand-tracking camera). In some embodiments, the one or more image sensors 314 are configured to be forward-facing so as to obtain image data that corresponds to the scene as would be viewed by the user if the display generation component 120 (e.g., HMD) was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some embodiments, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some embodiments, the memory 320 or the non-transitory computer readable storage medium of the memory 320 stores the following programs, modules and data structures, or a subset thereof including an optional operating system 330 and an XR presentation module 340.

The operating system 330 includes instructions for handling various basic system services and for performing hardware dependent tasks. In some embodiments, the XR presentation module 340 is configured to present XR content to the user via the one or more XR displays 312. To that end, in various embodiments, the XR presentation module 340 includes a data obtaining unit 342, an XR presenting unit 344, an XR map generating unit 346, and a data transmitting unit 348.

In some embodiments, the data obtaining unit 342 is configured to obtain data (e.g., presentation data, interaction data, sensor data, location data, etc.) from at least the controller 110 of FIG. 1A. To that end, in various embodiments, the data obtaining unit 342 includes instructions and/or logic therefor, and heuristics and metadata therefor.

In some embodiments, the XR presenting unit 344 is configured to present XR content via the one or more XR displays 312. To that end, in various embodiments, the XR presenting unit 344 includes instructions and/or logic therefor, and heuristics and metadata therefor.

In some embodiments, the XR map generating unit 346 is configured to generate an XR map (e.g., a 3D map of the mixed reality scene or a map of the physical environment into which computer-generated objects can be placed to generate the extended reality) based on media content data. To that end, in various embodiments, the XR map generating unit 346 includes instructions and/or logic therefor, and heuristics and metadata therefor.

In some embodiments, the data transmitting unit 348 is configured to transmit data (e.g., presentation data, location data, etc.) to at least the controller 110, and optionally one or more of the input devices 125, output devices 155, sensors 190, and/or peripheral devices 195. To that end, in various embodiments, the data transmitting unit 348 includes instructions and/or logic therefor, and heuristics and metadata therefor.

Although the data obtaining unit 342, the XR presenting unit 344, the XR map generating unit 346, and the data transmitting unit 348 are shown as residing on a single device (e.g., the display generation component 120 of FIG. 1A), it should be understood that in other embodiments, any combination of the data obtaining unit 342, the XR presenting unit 344, the XR map generating unit 346, and the data transmitting unit 348 may be located in separate computing devices.

Moreover, FIG. 3 is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 3 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 4 is a schematic, pictorial illustration of an example embodiment of the hand tracking device 140. In some embodiments, hand tracking device 140 (FIG. 1A) is controlled by hand tracking unit 245 (FIG. 2) to track the position/location of one or more portions of the user's hands, and/or motions of one or more portions of the user's hands with respect to the scene 105 of FIG. 1A (e.g., with respect to a portion of the physical environment surrounding the user, with respect to the display generation component 120, or with respect to a portion of the user (e.g., the user's face, eyes, or head), and/or relative to a coordinate system defined relative to the user's hand. In some embodiments, the hand tracking device 140 is part of the display generation component 120 (e.g., embedded in or attached to a head-mounted device). In some embodiments, the hand tracking device 140 is separate from the display generation component 120 (e.g., located in separate housings or attached to separate physical support structures).

In some embodiments, the hand tracking device 140 includes image sensors 404 (e.g., one or more IR cameras, 3D cameras, depth cameras, and/or color cameras, etc.) that capture three-dimensional scene information that includes at least a hand 406 of a human user. The image sensors 404 capture the hand images with sufficient resolution to enable the fingers and their respective positions to be distinguished. The image sensors 404 typically capture images of other parts of the user's body, as well, or possibly all of the body, and may have either zoom capabilities or a dedicated sensor with enhanced magnification to capture images of the hand with the desired resolution. In some embodiments, the image sensors 404 also capture 2D color video images of the hand 406 and other elements of the scene. In some embodiments, the image sensors 404 are used in conjunction with other image sensors to capture the physical environment of the scene 105, or serve as the image sensors that capture the physical environment of the scene 105. In some embodiments, the image sensors 404 are positioned relative to the user or the user's environment in a way that a field of view of the image sensors or a portion thereof is used to define an interaction space in which hand movement captured by the image sensors are treated as inputs to the controller 110.

In some embodiments, the image sensors 404 output a sequence of frames containing 3D map data (and possibly color image data, as well) to the controller 110, which extracts high-level information from the map data. This high-level information is typically provided via an Application Program Interface (API) to an application running on the controller, which drives the display generation component 120 accordingly. For example, the user may interact with software running on the controller 110 by moving their hand 406 and/or changing their hand posture.

In some embodiments, the image sensors 404 project a pattern of spots onto a scene containing the hand 406 and capture an image of the projected pattern. In some embodiments, the controller 110 computes the 3D coordinates of points in the scene (including points on the surface of the user's hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 404. In the present disclosure, the image sensors 404 are assumed to define an orthogonal set of x, y, z axes, so that depth coordinates of points in the scene correspond to z components measured by the image sensors. Alternatively, the image sensors 404 (e.g., a hand tracking device) may use other methods of 3D mapping, such as stereoscopic imaging or time-of-flight measurements, based on single or multiple cameras or other types of sensors.

In some embodiments, the hand tracking device 140 captures and processes a temporal sequence of depth maps containing the user's hand, while the user moves their hand (e.g., whole hand or one or more fingers). Software running on a processor in the image sensors 404 and/or the controller 110 processes the 3D map data to extract patch descriptors of the hand in these depth maps. The software matches these descriptors to patch descriptors stored in a database 408, based on a prior learning process, in order to estimate the pose of the hand in each frame. The pose typically includes 3D locations of the user's hand joints and fingertips.

The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion, and gesture information are provided via the above-mentioned API to an application program running on the controller 110. This program may, for example, move and modify images presented on the display generation component 120, or perform other functions, in response to the pose and/or gesture information.

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) or part(s) of the user's hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand. In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture is performed using a first hand of the user (e.g., a pinch input, a long pinch input, or a pinch and drag input), and, in conjunction with performing the pinch input using the first hand, a second pinch input is performed using the other hand (e.g., the second hand of the user's two hands). In some embodiments, movement between the user's two hands is performed (e.g., to increase and/or decrease a distance or relative orientation between the user's two hands).

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user's head and above the user's waist and extended out from the body by at least 15, 20, 25, 30, or 50 cm), and/or based on whether the hand has moved in a particular manner (e.g., moved toward a region in front of the user above the user's waist and below the user's head or moved away from the user's body or leg). In some embodiments, the ready state is used to determine whether interactive elements of the user interface respond to attention (e.g., gaze) inputs.

In scenarios where inputs are described with reference to air gestures, it should be understood that similar gestures could be detected using a hardware input device that is attached to or held by one or more hands of a user, where the position of the hardware input device in space can be tracked using optical tracking, one or more accelerometers, one or more gyroscopes, one or more magnetometers, and/or one or more inertial measurement units and the position and/or movement of the hardware input device is used in place of the position and/or movement of the one or more hands in the corresponding air gesture(s). In scenarios where inputs are described with reference to air gestures, it should be understood that similar gestures could be detected using a hardware input device that is attached to or held by one or more hands of a user, user inputs can be detected with controls contained in the hardware input device such as one or more touch-sensitive input elements, one or more pressure-sensitive input elements, one or more buttons, one or more knobs, one or more dials, one or more joysticks, one or more hand or finger coverings that can detect a position or change in position of portions of a hand and/or fingers relative to each other, relative to the user's body, and/or relative to a physical environment of the user, and/or other hardware input device controls, wherein the user inputs with the controls contained in the hardware input device are used in place of hand and/or finger gestures such as air taps or air pinches in the corresponding air gesture(s). For example, a selection input that is described as being performed with an air tap or air pinch input could be alternatively detected with a button press, a tap on a touch-sensitive surface, a press on a pressure-sensitive surface, or other hardware input. As another example, a movement input that is described as being performed with an air pinch and drag could be alternatively detected based on an interaction with the hardware input control such as a button press and hold, a touch on a touch-sensitive surface, a press on a pressure-sensitive surface, or other hardware input that is followed by movement of the hardware input device (e.g., along with the hand with which the hardware input device is associated) through space. Similarly, a two-handed input that includes movement of the hands relative to each other could be performed with one air gesture and one hardware input device in the hand that is not performing the air gesture, two hardware input devices held in different hands, or two air gestures performed by different hands using various combinations of air gestures and/or the inputs detected by one or more hardware input devices that are described above.

In some embodiments, the software may be downloaded to the controller 110 in electronic form, over a network, for example, or it may alternatively be provided on tangible, non-transitory media, such as optical, magnetic, or electronic memory media. In some embodiments, the database 408 is likewise stored in a memory associated with the controller 110. Alternatively or additionally, some or all of the described functions of the computer may be implemented in dedicated hardware, such as a custom or semi-custom integrated circuit or a programmable digital signal processor (DSP). Although the controller 110 is shown in FIG. 4, by way of example, as a separate unit from the image sensors 404, some or all of the processing functions of the controller may be performed by a suitable microprocessor and software or by dedicated circuitry within the housing of the image sensors 404 (e.g., a hand tracking device) or otherwise associated with the image sensors 404. In some embodiments, at least some of these processing functions may be carried out by a suitable processor that is integrated with the display generation component 120 (e.g., in a television set, a handheld device, or head-mounted device, for example) or with any other suitable computerized device, such as a game console or media player. The sensing functions of image sensors 404 may likewise be integrated into the computer or other computerized apparatus that is to be controlled by the sensor output.

FIG. 4 further includes a schematic representation of a depth map 410 captured by the image sensors 404, in accordance with some embodiments. The depth map, as explained above, comprises a matrix of pixels having respective depth values. The pixels 412 corresponding to the hand 406 have been segmented out from the background and the wrist in this map. The brightness of each pixel within the depth map 410 corresponds inversely to its depth value, i.e., the measured z distance from the image sensors 404, with the shade of gray growing darker with increasing depth. The controller 110 processes these depth values in order to identify and segment a component of the image (i.e., a group of neighboring pixels) having characteristics of a human hand. These characteristics, may include, for example, overall size, shape and motion from frame to frame of the sequence of depth maps.

FIG. 4 also schematically illustrates a hand skeleton 414 that controller 110 ultimately extracts from the depth map 410 of the hand 406, in accordance with some embodiments. In FIG. 4, the hand skeleton 414 is superimposed on a hand background 416 that has been segmented from the original depth map. In some embodiments, key feature points of the hand (e.g., points corresponding to knuckles, fingertips, center of the palm, end of the hand connecting to wrist, etc.) and optionally on the wrist or arm connected to the hand are identified and located on the hand skeleton 414. In some embodiments, location and movements of these key feature points over multiple image frames are used by the controller 110 to determine the hand gestures performed by the hand or the current state of the hand, in accordance with some embodiments.

FIG. 5 illustrates an example embodiment of the eye tracking device 130 (FIG. 1A). In some embodiments, the eye tracking device 130 is controlled by the eye tracking unit 243 (FIG. 2) to track the position and movement of the user's gaze with respect to the scene 105 or with respect to the XR content displayed via the display generation component 120. In some embodiments, the eye tracking device 130 is integrated with the display generation component 120. For example, in some embodiments, when the display generation component 120 is a head-mounted device such as headset, helmet, goggles, or glasses, or a handheld device placed in a wearable frame, the head-mounted device includes both a component that generates the XR content for viewing by the user and a component for tracking the gaze of the user relative to the XR content. In some embodiments, the eye tracking device 130 is separate from the display generation component 120. For example, when display generation component is a handheld device or an XR chamber, the eye tracking device 130 is optionally a separate device from the handheld device or XR chamber. In some embodiments, the eye tracking device 130 is a head-mounted device or part of a head-mounted device. In some embodiments, the head-mounted eye-tracking device 130 is optionally used in conjunction with a display generation component that is also head-mounted, or a display generation component that is not head-mounted. In some embodiments, the eye tracking device 130 is not a head-mounted device, and is optionally used in conjunction with a head-mounted display generation component. In some embodiments, the eye tracking device 130 is not a head-mounted device, and is optionally part of a non-head-mounted display generation component.

In some embodiments, the display generation component 120 uses a display mechanism (e.g., left and right near-eye display panels) for displaying frames including left and right images in front of a user's eyes to thus provide 3D virtual views to the user. For example, a head-mounted display generation component may include left and right optical lenses (referred to herein as eye lenses) located between the display and the user's eyes. In some embodiments, the display generation component may include or be coupled to one or more external video cameras that capture video of the user's environment for display. In some embodiments, a head-mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5, in some embodiments, eye tracking device 130 (e.g., a gaze tracking device) includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards “hot” mirrors located between the user's eyes and the display panels that reflect IR or NIR light from the eyes to the eye tracking cameras while allowing visible light to pass. The eye tracking device 130 optionally captures images of the user's eyes (e.g., as a video stream captured at 60-120 frames per second (fps)), analyze the images to generate gaze tracking information, and communicate the gaze tracking information to the controller 110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 130 is calibrated using a device-specific calibration process to determine parameters of the eye tracking device for the specific operating environment 100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device-specific calibration process may be an automated calibration process or a manual calibration process. A user-specific calibration process may include an estimation of a specific user's eye parameters, for example the pupil location, fovea location, optical axis, visual axis, eye spacing, etc. Once the device-specific and user-specific parameters are determined for the eye tracking device 130, images captured by the eye tracking cameras can be processed using a glint-assisted method to determine the current visual axis and point of gaze of the user with respect to the display, in accordance with some embodiments.

As shown in FIG. 5, the eye tracking device 130 (e.g., 130A or 130B) includes eye lens(es) 520, and a gaze tracking system that includes at least one eye tracking camera 540 (e.g., infrared (IR) or near-IR (NIR) cameras) positioned on a side of the user's face for which eye tracking is performed, and an illumination source 530 (e.g., IR or NIR light sources such as an array or ring of NIR light-emitting diodes (LEDs)) that emit light (e.g., IR or NIR light) towards the user's eye(s) 592. The eye tracking cameras 540 may be pointed towards mirrors 550 located between the user's eye(s) 592 and a display 510 (e.g., a left or right display panel of a head-mounted display, or a display of a handheld device, a projector, etc.) that reflect IR or NIR light from the eye(s) 592 while allowing visible light to pass (e.g., as shown in the top portion of FIG. 5), or alternatively may be pointed towards the user's eye(s) 592 to receive reflected IR or NIR light from the eye(s) 592 (e.g., as shown in the bottom portion of FIG. 5).

In some embodiments, the controller 110 renders AR or VR frames 562 (e.g., left and right frames for left and right display panels) and provides the frames 562 to the display 510. The controller 110 uses gaze tracking input 542 from the eye tracking cameras 540 for various purposes, for example in processing the frames 562 for display. The controller 110 optionally estimates the user's point of gaze on the display 510 based on the gaze tracking input 542 obtained from the eye tracking cameras 540 using the glint-assisted methods or other suitable methods. The point of gaze estimated from the gaze tracking input 542 is optionally used to determine the direction in which the user is currently looking.

The following describes several possible use cases for the user's current gaze direction, and is not intended to be limiting. As an example use case, the controller 110 may render virtual content differently based on the determined direction of the user's gaze. For example, the controller 110 may generate virtual content at a higher resolution in a foveal region determined from the user's current gaze direction than in peripheral regions. As another example, the controller may position or move virtual content in the view based at least in part on the user's current gaze direction. As another example, the controller may display particular virtual content in the view based at least in part on the user's current gaze direction. As another example use case in AR applications, the controller 110 may direct external cameras for capturing the physical environments of the XR experience to focus in the determined direction. The autofocus mechanism of the external cameras may then focus on an object or surface in the environment that the user is currently looking at on the display 510. As another example use case, the eye lenses 520 may be focusable lenses, and the gaze tracking information is used by the controller to adjust the focus of the eye lenses 520 so that the virtual object that the user is currently looking at has the proper vergence to match the convergence of the user's eyes 592. The controller 110 may leverage the gaze tracking information to direct the eye lenses 520 to adjust focus so that close objects that the user is looking at appear at the right distance.

In some embodiments, the eye tracking device is part of a head-mounted device that includes a display (e.g., display 510), two eye lenses (e.g., eye lens(es) 520), eye tracking cameras (e.g., eye tracking camera(s) 540), and light sources (e.g., light sources 530 (e.g., IR or NIR LEDs), mounted in a wearable housing. The light sources emit light (e.g., IR or NIR light) towards the user's eye(s) 592. In some embodiments, the light sources may be arranged in rings or circles around each of the lenses as shown in FIG. 5. In some embodiments, eight light sources 530 (e.g., LEDs) are arranged around each lens 520 as an example. However, more or fewer light sources 530 may be used, and other arrangements and locations of light sources 530 may be used.

In some embodiments, the display 510 emits light in the visible light range and does not emit light in the IR or NIR range, and thus does not introduce noise in the gaze tracking system. Note that the location and angle of eye tracking camera(s) 540 is given by way of example, and is not intended to be limiting. In some embodiments, a single eye tracking camera 540 is located on each side of the user's face. In some embodiments, two or more NIR cameras 540 may be used on each side of the user's face. In some embodiments, a camera 540 with a wider field of view (FOV) and a camera 540 with a narrower FOV may be used on each side of the user's face. In some embodiments, a camera 540 that operates at one wavelength (e.g., 850 nm) and a camera 540 that operates at a different wavelength (e.g., 940 nm) may be used on each side of the user's face.

Embodiments of the gaze tracking system as illustrated in FIG. 5 may, for example, be used in computer-generated reality, virtual reality, and/or mixed reality applications to provide computer-generated reality, virtual reality, augmented reality, and/or augmented virtuality experiences to the user.

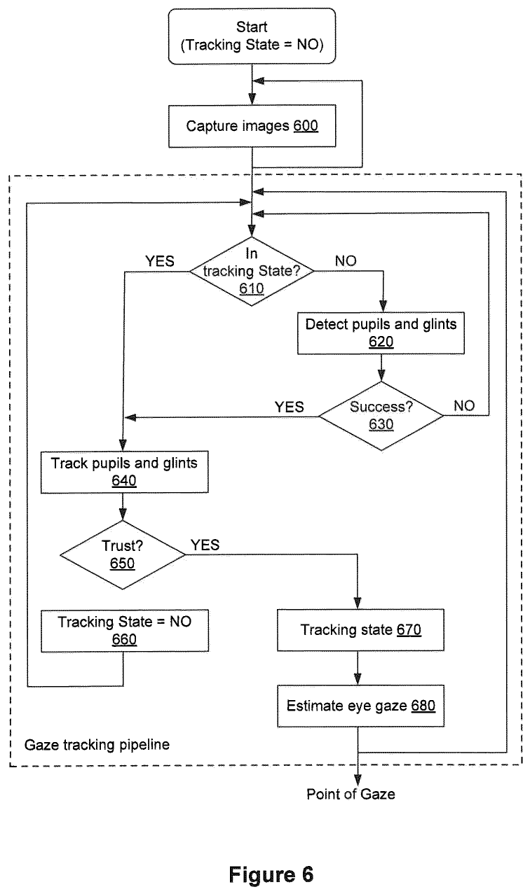

FIG. 6 illustrates a glint-assisted gaze tracking pipeline, in accordance with some embodiments. In some embodiments, the gaze tracking pipeline is implemented by a glint-assisted gaze tracking system (e.g., eye tracking device 130 as illustrated in FIGS. 1A and 5). The glint-assisted gaze tracking system may maintain a tracking state. Initially, the tracking state is off or “NO”. When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES” and continues with the next frame in the tracking state.

As shown in FIG. 6, the gaze tracking cameras may capture left and right images of the user's left and right eyes. The captured images are then input to a gaze tracking pipeline for processing beginning at 610. As indicated by the arrow returning to element 600, the gaze tracking system may continue to capture images of the user's eyes, for example at a rate of 60 to 120 frames per second. In some embodiments, each set of captured images may be input to the pipeline for processing. However, in some embodiments or under some conditions, not all captured frames are processed by the pipeline.

At 610, for the current captured images, if the tracking state is YES, then the method proceeds to element 640. At 610, if the tracking state is NO, then as indicated at 620 the images are analyzed to detect the user's pupils and glints in the images. At 630, if the pupils and glints are successfully detected, then the method proceeds to element 640. Otherwise, the method returns to element 610 to process next images of the user's eyes.

At 640, if proceeding from element 610, the current frames are analyzed to track the pupils and glints based in part on prior information from the previous frames. At 640, if proceeding from element 630, the tracking state is initialized based on the detected pupils and glints in the current frames. Results of processing at element 640 are checked to verify that the results of tracking or detection can be trusted. For example, results may be checked to determine if the pupil and a sufficient number of glints to perform gaze estimation are successfully tracked or detected in the current frames. At 650, if the results cannot be trusted, then the tracking state is set to NO at element 660, and the method returns to element 610 to process next images of the user's eyes. At 650, if the results are trusted, then the method proceeds to element 670. At 670, the tracking state is set to YES (if not already YES), and the pupil and glint information is passed to element 680 to estimate the user's point of gaze.

FIG. 6 is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 101 for providing XR experiences to users, in accordance with various embodiments.

In some embodiments, the captured portions of real-world environment 602 are used to provide a XR experience to the user, for example, a mixed reality environment in which one or more virtual objects are superimposed over representations of real-world environment 602.

Thus, the description herein describes some embodiments of three-dimensional environments (e.g., XR environments) that include representations of real-world objects and representations of virtual objects. For example, a three-dimensional environment optionally includes a representation of a table that exists in the physical environment, which is captured and displayed in the three-dimensional environment (e.g., actively via cameras and displays of a computer system, or passively via a transparent or translucent display of the computer system). As described previously, the three-dimensional environment is optionally a mixed reality system in which the three-dimensional environment is based on the physical environment that is captured by one or more sensors of the computer system and displayed via a display generation component. As a mixed reality system, the computer system is optionally able to selectively display portions and/or objects of the physical environment such that the respective portions and/or objects of the physical environment appear as if they exist in the three-dimensional environment displayed by the computer system. Similarly, the computer system is optionally able to display virtual objects in the three-dimensional environment to appear as if the virtual objects exist in the real world (e.g., physical environment) by placing the virtual objects at respective locations in the three-dimensional environment that have corresponding locations in the real world. For example, the computer system optionally displays a vase such that it appears as if a real vase is placed on top of a table in the physical environment. In some embodiments, a respective location in the three-dimensional environment has a corresponding location in the physical environment. Thus, when the computer system is described as displaying a virtual object at a respective location with respect to a physical object (e.g., such as a location at or near the hand of the user, or at or near a physical table), the computer system displays the virtual object at a particular location in the three-dimensional environment such that it appears as if the virtual object is at or near the physical object in the physical world (e.g., the virtual object is displayed at a location in the three-dimensional environment that corresponds to a location in the physical environment at which the virtual object would be displayed if it were a real object at that particular location).

In some embodiments, real world objects that exist in the physical environment that are displayed in the three-dimensional environment (e.g., and/or visible via the display generation component) can interact with virtual objects that exist only in the three-dimensional environment. For example, a three-dimensional environment can include a table and a vase placed on top of the table, with the table being a view of (or a representation of) a physical table in the physical environment, and the vase being a virtual object.

In a three-dimensional environment (e.g., a real environment, a virtual environment, or an environment that includes a mix of real and virtual objects), objects are sometimes referred to as having a depth or simulated depth, or objects are referred to as being visible, displayed, or placed at different depths. In this context, depth refers to a dimension other than height or width. In some embodiments, depth is defined relative to a fixed set of coordinates (e.g., where a room or an object has a height, depth, and width defined relative to the fixed set of coordinates). In some embodiments, depth is defined relative to a location or viewpoint of a user, in which case, the depth dimension varies based on the location of the user and/or the location and angle of the viewpoint of the user. In some embodiments where depth is defined relative to a location of a user that is positioned relative to a surface of an environment (e.g., a floor of an environment, or a surface of the ground), objects that are further away from the user along a line that extends parallel to the surface are considered to have a greater depth in the environment, and/or the depth of an object is measured along an axis that extends outward from a location of the user and is parallel to the surface of the environment (e.g., depth is defined in a cylindrical or substantially cylindrical coordinate system with the position of the user at the center of the cylinder that extends from a head of the user toward feet of the user). In some embodiments where depth is defined relative to viewpoint of a user (e.g., a direction relative to a point in space that determines which portion of an environment that is visible via a head mounted device or other display), objects that are further away from the viewpoint of the user along a line that extends parallel to the direction of the viewpoint of the user are considered to have a greater depth in the environment, and/or the depth of an object is measured along an axis that extends outward from a line that extends from the viewpoint of the user and is parallel to the direction of the viewpoint of the user (e.g., depth is defined in a spherical or substantially spherical coordinate system with the origin of the viewpoint at the center of the sphere that extends outwardly from a head of the user). In some embodiments, depth is defined relative to a user interface container (e.g., a window or application in which application and/or system content is displayed) where the user interface container has a height and/or width, and depth is a dimension that is orthogonal to the height and/or width of the user interface container. In some embodiments, in circumstances where depth is defined relative to a user interface container, the height and or width of the container are typically orthogonal or substantially orthogonal to a line that extends from a location based on the user (e.g., a viewpoint of the user or a location of the user) to the user interface container (e.g., the center of the user interface container, or another characteristic point of the user interface container) when the container is placed in the three-dimensional environment or is initially displayed (e.g., so that the depth dimension for the container extends outward away from the user or the viewpoint of the user). In some embodiments, in situations where depth is defined relative to a user interface container, depth of an object relative to the user interface container refers to a position of the object along the depth dimension for the user interface container. In some embodiments, multiple different containers can have different depth dimensions (e.g., different depth dimensions that extend away from the user or the viewpoint of the user in different directions and/or from different starting points). In some embodiments, when depth is defined relative to a user interface container, the direction of the depth dimension remains constant for the user interface container as the location of the user interface container, the user and/or the viewpoint of the user changes (e.g., or when multiple different viewers are viewing the same container in the three-dimensional environment such as during an in-person collaboration session and/or when multiple participants are in a real-time communication session with shared virtual content including the container). In some embodiments, for curved containers (e.g., including a container with a curved surface or curved content region), the depth dimension optionally extends into a surface of the curved container. In some situations, z-separation (e.g., separation of two objects in a depth dimension), z-height (e.g., distance of one object from another in a depth dimension), z-position (e.g., position of one object in a depth dimension), z-depth (e.g., position of one object in a depth dimension), or simulated z dimension (e.g., depth used as a dimension of an object, dimension of an environment, a direction in space, and/or a direction in simulated space) are used to refer to the concept of depth as described above.

In some embodiments, a user is optionally able to interact with virtual objects in the three-dimensional environment using one or more hands as if the virtual objects were real objects in the physical environment. For example, as described above, one or more sensors of the computer system optionally capture one or more of the hands of the user and display representations of the hands of the user in the three-dimensional environment (e.g., in a manner similar to displaying a real world object in three-dimensional environment described above), or in some embodiments, the hands of the user are visible via the display generation component via the ability to see the physical environment through the user interface due to the transparency/translucency of a portion of the display generation component that is displaying the user interface or due to projection of the user interface onto a transparent/translucent surface or projection of the user interface onto the user's eye or into a field of view of the user's eye. Thus, in some embodiments, the hands of the user are displayed at a respective location in the three-dimensional environment and are treated as if they were objects in the three-dimensional environment that are able to interact with the virtual objects in the three-dimensional environment as if they were physical objects in the physical environment. In some embodiments, the computer system is able to update display of the representations of the user's hands in the three-dimensional environment in conjunction with the movement of the user's hands in the physical environment.

In some of the embodiments described below, the computer system is optionally able to determine the “effective” distance between physical objects in the physical world and virtual objects in the three-dimensional environment, for example, for the purpose of determining whether a physical object is directly interacting with a virtual object (e.g., whether a hand is touching, grabbing, holding, etc. a virtual object or within a threshold distance of a virtual object). For example, a hand directly interacting with a virtual object optionally includes one or more of a finger of a hand pressing a virtual button, a hand of a user grabbing a virtual vase, two fingers of a hand of the user coming together and pinching/holding a user interface of an application, and any of the other types of interactions described here. For example, the computer system optionally determines the distance between the hands of the user and virtual objects when determining whether the user is interacting with virtual objects and/or how the user is interacting with virtual objects. In some embodiments, the computer system determines the distance between the hands of the user and a virtual object by determining the distance between the location of the hands in the three-dimensional environment and the location of the virtual object of interest in the three-dimensional environment. For example, the one or more hands of the user are located at a particular position in the physical world, which the computer system optionally captures and displays at a particular corresponding position in the three-dimensional environment (e.g., the position in the three-dimensional environment at which the hands would be displayed if the hands were virtual, rather than physical, hands). The position of the hands in the three-dimensional environment is optionally compared with the position of the virtual object of interest in the three-dimensional environment to determine the distance between the one or more hands of the user and the virtual object. In some embodiments, the computer system optionally determines a distance between a physical object and a virtual object by comparing positions in the physical world (e.g., as opposed to comparing positions in the three-dimensional environment). For example, when determining the distance between one or more hands of the user and a virtual object, the computer system optionally determines the corresponding location in the physical world of the virtual object (e.g., the position at which the virtual object would be located in the physical world if it were a physical object rather than a virtual object), and then determines the distance between the corresponding physical position and the one of more hands of the user. In some embodiments, the same techniques are optionally used to determine the distance between any physical object and any virtual object. Thus, as described herein, when determining whether a physical object is in contact with a virtual object or whether a physical object is within a threshold distance of a virtual object, the computer system optionally performs any of the techniques described above to map the location of the physical object to the three-dimensional environment and/or map the location of the virtual object to the physical environment.

In some embodiments, the same or similar technique is used to determine where and what the gaze of the user is directed to and/or where and at what a physical stylus held by a user is pointed. For example, if the gaze of the user is directed to a particular position in the physical environment, the computer system optionally determines the corresponding position in the three-dimensional environment (e.g., the virtual position of the gaze), and if a virtual object is located at that corresponding virtual position, the computer system optionally determines that the gaze of the user is directed to that virtual object. Similarly, the computer system is optionally able to determine, based on the orientation of a physical stylus, to where in the physical environment the stylus is pointing. In some embodiments, based on this determination, the computer system determines the corresponding virtual position in the three-dimensional environment that corresponds to the location in the physical environment to which the stylus is pointing, and optionally determines that the stylus is pointing at the corresponding virtual position in the three-dimensional environment.

Similarly, the embodiments described herein may refer to the location of the user (e.g., the user of the computer system) and/or the location of the computer system in the three-dimensional environment. In some embodiments, the user of the computer system is holding, wearing, or otherwise located at or near the computer system. Thus, in some embodiments, the location of the computer system is used as a proxy for the location of the user. In some embodiments, the location of the computer system and/or user in the physical environment corresponds to a respective location in the three-dimensional environment. For example, the location of the computer system would be the location in the physical environment (and its corresponding location in the three-dimensional environment) from which, if a user were to stand at that location facing a respective portion of the physical environment that is visible via the display generation component, the user would see the objects in the physical environment in the same positions, orientations, and/or sizes as they are displayed by or visible via the display generation component of the computer system in the three-dimensional environment (e.g., in absolute terms and/or relative to each other). Similarly, if the virtual objects displayed in the three-dimensional environment were physical objects in the physical environment (e.g., placed at the same locations in the physical environment as they are in the three-dimensional environment, and having the same sizes and orientations in the physical environment as in the three-dimensional environment), the location of the computer system and/or user is the position from which the user would see the virtual objects in the physical environment in the same positions, orientations, and/or sizes as they are displayed by the display generation component of the computer system in the three-dimensional environment (e.g., in absolute terms and/or relative to each other and the real world objects).

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

### User Interfaces and Associated Processes

Attention is now directed towards embodiments of user interfaces (“UI”) and associated processes that may be implemented on a computer system, such as a portable multifunction device or a head-mounted device, in communication with a display generation component and one or more sensors, and optionally one or more input devices.

FIGS. 7A-7L and 8A-8M include illustrations of three-dimensional environments that are visible via a display generation component (e.g., a display generation component 7100 or a display generation component 120) of a computer system (e.g., computer system 101) and interactions that occur in the three-dimensional environments caused by user inputs directed to the three-dimensional environments and/or inputs received from other computer systems and/or sensors. In some embodiments, an input is directed to a virtual object within a three-dimensional environment by a user's gaze detected in the region occupied by the virtual object, or by a hand gesture performed at a location in the physical environment that corresponds to the region of the virtual object. In some embodiments, an input is directed to a virtual object within a three-dimensional environment by a hand gesture that is performed (e.g., optionally, at a location in the physical environment that is independent of the region of the virtual object in the three-dimensional environment) while the virtual object has input focus (e.g., while the virtual object has been selected by a concurrently and/or previously detected gaze input, selected by a concurrently or previously detected pointer input, and/or selected by a concurrently and/or previously detected gesture input). In some embodiments, an input is directed to a virtual object within a three-dimensional environment by an input device that has positioned a focus selector object (e.g., a pointer object or selector object) at the position of the virtual object. In some embodiments, an input is directed to a virtual object within a three-dimensional environment via other means (e.g., voice and/or control button). In some embodiments, an input is directed to a representation of a physical object or a virtual object that corresponds to a physical object by the user's hand movement (e.g., whole hand movement, whole hand movement in a respective posture, movement of one portion of the user's hand relative to another portion of the hand, and/or relative movement between two hands) and/or manipulation with respect to the physical object (e.g., touching, swiping, tapping, opening, moving toward, and/or moving relative to). In some embodiments, the computer system displays some changes in the three-dimensional environment (e.g., displaying additional virtual content, ceasing to display existing virtual content, and/or transitioning between different levels of immersion with which visual content is being displayed) in accordance with inputs from sensors (e.g., image sensors, temperature sensors, biometric sensors, motion sensors, and/or proximity sensors) and contextual conditions (e.g., location, time, and/or presence of others in the environment). In some embodiments, the computer system displays some changes in the three-dimensional environment (e.g., displaying additional virtual content, ceasing to display existing virtual content, and/or transitioning between different levels of immersion with which visual content is being displayed) in accordance with inputs from other computers used by other users that are sharing the computer-generated environment with the user of the computer system (e.g., in a shared computer-generated experience, in a shared virtual environment, and/or in a shared virtual or augmented reality environment of a communication session). In some embodiments, the computer system displays some changes in the three-dimensional environment (e.g., displaying movement, deformation, and/or changes in visual characteristics of a user interface, a virtual surface, a user interface object, and/or virtual scenery) in accordance with inputs from sensors that detect movement of other persons and objects and movement of the user that may not qualify as a recognized gesture input for triggering an associated operation of the computer system.

In some embodiments, a three-dimensional environment that is visible via a display generation component described herein is a virtual three-dimensional environment that includes virtual objects and content at different virtual positions in the three-dimensional environment without a representation of the physical environment. In some embodiments, the three-dimensional environment is a mixed reality environment that displays virtual objects at different virtual positions in the three-dimensional environment that are constrained by one or more physical aspects of the physical environment (e.g., positions and orientations of walls, floors, surfaces, direction of gravity, time of day, and/or spatial relationships between physical objects). In some embodiments, the three-dimensional environment is an augmented reality environment that includes a representation of the physical environment. In some embodiments, the representation of the physical environment includes respective representations of physical objects and surfaces at different positions in the three-dimensional environment, such that the spatial relationships between the different physical objects and surfaces in the physical environment are reflected by the spatial relationships between the representations of the physical objects and surfaces in the three-dimensional environment. In some embodiments, when virtual objects are placed relative to the positions of the representations of physical objects and surfaces in the three-dimensional environment, they appear to have corresponding spatial relationships with the physical objects and surfaces in the physical environment. In some embodiments, the computer system transitions between displaying the different types of environments (e.g., transitions between presenting a computer-generated environment or experience with different levels of immersion, adjusting the relative prominence of audio/visual sensory inputs from the virtual content and from the representation of the physical environment) based on user inputs and/or contextual conditions.

In some embodiments, the display generation component includes a pass-through portion in which the representation of the physical environment is displayed or visible. In some embodiments, the pass-through portion of the display generation component is a transparent or semi-transparent (e.g., see-through) portion of the display generation component revealing at least a portion of a physical environment surrounding and within the field of view of a user (sometimes called “optical passthrough”). For example, the pass-through portion is a portion of a head-mounted display or heads-up display that is made semi-transparent (e.g., less than 50%, 40%, 30%, 20%, 15%, 10%, or 5% of opacity) or transparent, such that the user can see through it to view the real world surrounding the user without removing the head-mounted display or moving away from the heads-up display. In some embodiments, the pass-through portion gradually transitions from semi-transparent or transparent to fully opaque when displaying a virtual or mixed reality environment. In some embodiments, the pass-through portion of the display generation component displays a live feed of images or video of at least a portion of physical environment captured by one or more cameras (e.g., rear facing camera(s) of a mobile device or associated with a head-mounted display, or other cameras that feed image data to the computer system) (sometimes called “digital passthrough”). In some embodiments, the one or more cameras point at a portion of the physical environment that is directly in front of the user's eyes (e.g., behind the display generation component relative to the user of the display generation component). In some embodiments, the one or more cameras point at a portion of the physical environment that is not directly in front of the user's eyes (e.g., in a different physical environment, or to the side of or behind the user).

In some embodiments, when displaying virtual objects at positions that correspond to locations of one or more physical objects in the physical environment (e.g., at positions in a virtual reality environment, a mixed reality environment, or an augmented reality environment), at least some of the virtual objects are displayed in place of (e.g., replacing display of) a portion of the live view (e.g., a portion of the physical environment captured in the live view) of the cameras. In some embodiments, at least some of the virtual objects and content are projected onto physical surfaces or empty space in the physical environment and are visible through the pass-through portion of the display generation component (e.g., viewable as part of the camera view of the physical environment, or through the transparent or semi-transparent portion of the display generation component). In some embodiments, at least some of the virtual objects and virtual content are displayed to overlay a portion of the display and block the view of at least a portion of the physical environment visible through the transparent or semi-transparent portion of the display generation component.

In some embodiments, the display generation component displays different views of the three-dimensional environment in accordance with user inputs or movements that change the virtual position of the viewpoint of the currently displayed view of the three-dimensional environment relative to the three-dimensional environment. In some embodiments, when the three-dimensional environment is a virtual environment, the viewpoint moves in accordance with navigation or locomotion requests (e.g., in-air hand gestures, and/or gestures performed by movement of one portion of the hand relative to another portion of the hand) without requiring movement of the user's head, torso, and/or the display generation component in the physical environment. In some embodiments, movement of the user's head and/or torso, and/or the movement of the display generation component or other location sensing elements of the computer system (e.g., due to the user holding the display generation component or wearing the HMD), relative to the physical environment, cause corresponding movement of the viewpoint (e.g., with corresponding movement direction, movement distance, movement speed, and/or change in orientation) relative to the three-dimensional environment, resulting in corresponding change in the currently displayed view of the three-dimensional environment. In some embodiments, when a virtual object has a preset spatial relationship relative to the viewpoint (e.g., is anchored or fixed to the viewpoint), movement of the viewpoint relative to the three-dimensional environment would cause movement of the virtual object relative to the three-dimensional environment while the position of the virtual object in the field of view is maintained (e.g., the virtual object is said to be head locked). In some embodiments, a virtual object is body-locked to the user, and moves relative to the three-dimensional environment when the user moves as a whole in the physical environment (e.g., carrying or wearing the display generation component and/or other location sensing component of the computer system), but will not move in the three-dimensional environment in response to the user's head movement alone (e.g., the display generation component and/or other location sensing component of the computer system rotating around a fixed location of the user in the physical environment). In some embodiments, a virtual object is, optionally, locked to another portion of the user, such as a user's hand or a user's wrist, and moves in the three-dimensional environment in accordance with movement of the portion of the user in the physical environment, to maintain a preset spatial relationship between the position of the virtual object and the virtual position of the portion of the user in the three-dimensional environment. In some embodiments, a virtual object is locked to a preset portion of a field of view provided by the display generation component, and moves in the three-dimensional environment in accordance with the movement of the field of view, irrespective of movement of the user that does not cause a change of the field of view.

In some embodiments, as shown in FIGS. 7A-7L and 8A-8M, the views of a three-dimensional environment sometimes do not include representation(s) of a user's hand(s), arm(s), and/or wrist(s). In some embodiments, the representation(s) of a user's hand(s), arm(s), and/or wrist(s) are included in the views of a three-dimensional environment. In some embodiments, the representation(s) of a user's hand(s), arm(s), and/or wrist(s) are included in the views of a three-dimensional environment as part of the representation of the physical environment provided via the display generation component. In some embodiments, the representations are not part of the representation of the physical environment and are separately captured (e.g., by one or more cameras pointing toward the user's hand(s), arm(s), and wrist(s)) and displayed in the three-dimensional environment independent of the currently displayed view of the three-dimensional environment. In some embodiments, the representation(s) include camera images as captured by one or more cameras of the computer system(s), or stylized versions of the arm(s), wrist(s) and/or hand(s) based on information captured by various sensors). In some embodiments, the representation(s) replace display of, are overlaid on, or block the view of, a portion of the representation of the physical environment. In some embodiments, when the display generation component does not provide a view of a physical environment, and provides a completely virtual environment (e.g., no camera view and no transparent pass-through portion), real-time visual representations (e.g., stylized representations or segmented camera images) of one or both arms, wrists, and/or hands of the user are, optionally, still displayed in the virtual environment. In some embodiments, if a representation of the user's hand is not provided in the view of the three-dimensional environment, the position that corresponds to the user's hand is optionally indicated in the three-dimensional environment, e.g., by the changing appearance of the virtual content (e.g., through a change in translucency and/or simulated reflective index) at positions in the three-dimensional environment that correspond to the location of the user's hand in the physical environment. In some embodiments, the representation of the user's hand or wrist is outside of the currently displayed view of the three-dimensional environment while the virtual position in the three-dimensional environment that corresponds to the location of the user's hand or wrist is outside of the current field of view provided via the display generation component; and the representation of the user's hand or wrist is made visible in the view of the three-dimensional environment in response to the virtual position that corresponds to the location of the user's hand or wrist being moved within the current field of view due to movement of the display generation component, the user's hand or wrist, the user's head, and/or the user as a whole.

FIGS. 7A-7L illustrate examples of changing displayed visual effects as user interfaces and/or user interface elements are repositioned and as a viewpoint of a user relative to the user interfaces and/or user interface elements is changed. FIG. 9 is a flow diagram of an exemplary method 900 for updating display of visual effects as user interfaces and/or user interface elements are repositioned. FIG. 10 is a flow diagram of an exemplary method 1000 for updating display of visual effects applied to a user interface and/or user interface element, as a viewpoint of a user is changed. The user interfaces in FIGS. 7A-7L are used to illustrate the processes described below, including the processes in FIGS. 9 and 10.

As shown in the examples in FIGS. 7A-7L, display generation component 7100 of computer system 101 is a touchscreen held by user 7002. In some embodiments, the display generation component of computer system 101 is a head mounted display (e.g., head mounted display 7100a, as shown in FIGS. 7E1-7E2, 8D2-8D3 and 8E1-8E2) worn on user 7002's head (e.g., what is shown in FIGS. 7A-7L as being visible via display generation component 7100 of computer system 101 corresponds to user 7002's field of view when wearing a head-mounted display). In some embodiments, the display generation component is a standalone display, a projector, or another type of display. In some embodiments, the computer system is in communication with one or more input devices, including cameras or other sensors and input devices that detect movement of the user's hand(s), movement of the user's body as whole, and/or movement of the user's head in the physical environment. In some embodiments, the one or more input devices detect the movement and the current postures, orientations, and positions of the user's hand(s), face, and/or body as a whole. For example, in some embodiments, while the user's hand 7020 is within the field of view of the one or more sensors of HMD 7100a (e.g., within the field of view of the user), a representation of the user's hand 7020′ is displayed in the user interface displayed (e.g., as a passthrough representation and/or as a virtual representation of the user's hand 7020) on the display of HMD 7100a. in some embodiments, while the user's hand 7022 is within the field of view of the one or more sensors of HMD 7100a (e.g., within the field of view of the user), a representation of the user's hand 7022′ is displayed in the user interface displayed (e.g., as a passthrough representation and/or as a virtual representation of the user's hand 7022) on the display of HMD 7100a. In some embodiments, the user's hand 7020 and/or the user's hand 7022 are used to perform one or more gestures (e.g., one or more air gestures), optionally in combination with a gaze input. In some embodiments, the one or more gestures performed with the user's hand(s) 7020 and/or 7022 include a direct air gesture input that is based on a position of the representation of the user's hand(s) 7020′ and/or 7022′ displayed within the user interface on the display of HMD 7100a. For example, a direct air gesture input is determined as being directed to a user interface object displayed at a position that intersects with the displayed position of the representation of the user's hand(s) 7020′ and/or 7022′ in the user interface. In some embodiments, the one or more gestures performed with the user's hand(s) 7020 and/or 7022 include an indirect air gesture input that is based on a virtual object displayed at a position that corresponds a position at which the user's attention is currently detected (e.g., and/or is optionally not based on a position of the representation of the user's hand(s) 7020′ and/or 7022′ displayed within the user interface). For example, an indirect air gesture is performed with respect to a user interface object while detecting the user's attention (e.g., based on gaze or other indication of user attention) on the user interface object, such as a gaze and pinch (e.g., or other gesture performed with the user's hand).

In some embodiments, user inputs are detected via a touch-sensitive surface or touchscreen. In some embodiments, the one or more input devices include an eye tracking component that detects location and movement of the user's gaze. In some embodiments, the display generation component, and optionally, the one or more input devices and the computer system, are parts of a head-mounted device that moves and rotates with the user's head in the physical environment, and changes the viewpoint of the user in the three-dimensional environment provided via the display generation component. In some embodiments, the display generation component is a heads-up display that does not move or rotate with the user's head or the user's body as a whole, but, optionally, changes the viewpoint of the user in the three-dimensional environment in accordance with the movement of the user's head or body relative to the display generation component. In some embodiments, the display generation component (e.g., a touchscreen) is optionally moved and rotated by the user's hand relative to the physical environment or relative to the user's head, and changes the viewpoint of the user in the three-dimensional environment in accordance with the movement of the display generation component relative to the user's head or face or relative to the physical environment.

In some embodiments, the display generation component 7100 comprises a head mounted display (HMD) 7100a. For example, as illustrated in FIG. 7E1 (e.g., and FIGS. 8D2 and 8E1), the head mounted display 7100a includes one or more displays that displays a representation of a portion of the three-dimensional environment 7000′ that corresponds to the perspective of the user, while an HMD typically includes multiple displays including a display for a right eye and a separate display for a left eye that display slightly different images to generate user interfaces with stereoscopic depth, in the figures a single image is shown that corresponds to the image for a single eye and depth information is indicated with other annotations or description of the figures. In some embodiments, HMD 7100a includes one or more sensors (e.g., one or more interior- and/or exterior-facing image sensors 314), such as sensor 7101a, sensor 7101b and/or sensor 7101c for detecting a state of the user, including facial and/or eye tracking of the user (e.g., using one or more inward-facing sensors 7101a and/or 7101b) and/or tracking hand, torso, or other movements of the user (e.g., using one or more outward-facing sensors 7101c). In some embodiments, HMD 7100a includes one or more input devices that are optionally located on a housing of HMD 7100a, such as one or more buttons, trackpads, touchscreens, scroll wheels, digital crowns that are rotatable and depressible or other input devices. In some embodiments input elements are mechanical input elements, in some embodiments input elements are solid state input elements that respond to press inputs based on detected pressure or intensity. For example, in FIG. 7E1 (e.g., and FIGS. 8D2 and 8E1), HMD 7100a includes one or more of button 701a, button 701b and digital crown 703 for providing inputs to HMD 7100a. It will be understood that additional and/or alternative input devices may be included in HMD 7100a.

FIG. 7E2 (e.g., and FIGS. 8D3 and 8E2) illustrates a top-down view of the user 7002 in the physical environment 7000. For example, the user 7002 is wearing HMD 7100a, such that the user's hand(s) 7020 and/or 7022 (e.g., that are optionally used to provide air gestures or other user inputs) are physically present within the physical environment 7000 behind the display of HMD 7100a.

FIG. 7E1 (e.g., and FIGS. 8D2 and 8E1) illustrates an alternative display generation component of the computer system than the display illustrated in FIGS. 7A-7D, 7E3-8D1 and 8E3-8M. It will be understood that the processes, features and functions described herein with reference to the display generation component 7100 described in 7A-7D, 7E3-8D1 and 8E3-8M are also applicable to HMD 7100a, illustrated in FIGS. 7E1-7E2, 8D2-8D3 and 8E1-8E2.

FIG. 7A illustrates a physical environment 7000, which includes a first wall 7004, a second wall 7006, a floor 7008, and a physical object 7014. A user 7002 has a left hand 7020 and a right hand 7022, and the user 7002 is holding a display generation component 7100 of a computer system 101 (shown in FIG. 1A). FIG. 7A also includes a top-down view of the user 7002, along with an arrow that indicates a direction that the user 7002 is facing (e.g., in FIG. 7A, the user 7002 is facing in a direction that is towards the physical object 7014). The top-down view of the user 7002 also includes a virtual object 7016, which does not exist in the physical environment 7000.

FIG. 7B illustrates a view of a three-dimensional environment that is visible via the display of the display generation component 7100. In some embodiments, the three-dimensional environment includes elements of the physical environment 7000, such as a representation 7014′ of the physical object 7014, a representation 7004′ of the first wall 7004, and a representation 7008′ of the floor 7008. In some embodiments, the three-dimensional environment includes one or more virtual elements, such as virtual elements 7024, 7026, 7028, 7030, 7032, 7034, 7036, and 7038. In some embodiments, the virtual elements 7024, 7026, 7028, 7030, 7032, 7034, 7036, and 7038 are application launch affordances (e.g., and optionally, the group of application launch affordances comprise a home user interface for launching and/or accessing applications of the computer system 101), and the user 7002 can launch different applications by interacting with a respective application launch affordance. In some embodiments, the interactive elements 7024, 7026, 7028, 7030, 7032, 7034, 7036, and 7038 are collectively referred to as a “home user interface.”

FIG. 7B also includes a top-down view of the user 7002, which is analogous to the top-down view of FIG. 7A, but additionally shows the locations of the virtual elements (e.g., the virtual elements 7024, 7026, 7032 (partially obscured by virtual element 7026 from the top-down perspective), and 7028 (with the other virtual elements of the home user interface obscured from the top-down perspective)) relative to the user 7002. The top-down view in FIG. 7B also includes a virtual object 7016, which is not currently visible via the display generation component 7100 of the computer system 101 (e.g., because the virtual object 7016 is behind the user 7002, and out of the user 7002's field of vision).

FIG. 7C illustrates a user interface 7032 in the three-dimensional environment. In some embodiments, the user interface 7032 is an application user interface (e.g., the user interacts with one of the virtual elements 7024, 7026, 7028, 7030, 7032, 7034, 7036, or 7038, in order to display the user interface 7032). In some embodiments, the user interface 7032 includes interactive elements 7001, 7003, 7005, and 7007. In some embodiments, the interactive elements are buttons or affordances, sliders, toggles, text-entry fields, or other suitable interactive elements that enable the user 7002 to interact with the user interface 7032. The user interface 7032 is shown with four interactive elements in FIG. 7C, but in some embodiments, the user interface 7032 includes additional, or fewer, interactive elements. The descriptions below describe various behaviors and appearances of the user interface 7032, but in some embodiments, the described behaviors and appearances are also applicable to the home user interface (e.g., of FIG. 7B, that includes the interactive elements 7024, 7026, 7028, 7030, 7032, 7034, 7036, and 7038) (e.g., the user interface 7032 and the home user interface are interchangeable in figures described below).

In some embodiments, when the computer system 101 displays the user interface 7032 (e.g., in response to detecting user interaction with a respective virtual element in FIG. 7B), the computer system 101 also positions a light source 7042 and a light source 7044, relative to the user interface 7032. In some embodiments, the user interface 7032 is a reference point of the light source 7042 and the light source 7044 (e.g., the light source 7042 and the light source 7044 are positioned relative to the reference point, and the reference point is a point (e.g., a center point) in or along the user interface 7032). In some embodiments, the light source 7042 and the light source 7044 affect (e.g., cast light on) other user interface elements (e.g., a user interface 7050, as described in further detail below), such that the light sources 7042 and 7044 are initially positioned relative to the user interface 7032, but can interact with other (e.g., or all) user interface elements. In some embodiments, the home user interface (e.g., the home user interface that includes the interactive elements 7024, 7026, 7028, 7030, 7032, 7034, 7036, and 7038, in FIG. 7B) is a reference point of the light source 7042 and the light source 7044 (e.g., and the descriptions herein of the behavior of the light source 7042 and the light source 7044, with references to the user interface 7032, are analogously applicable to the home user interface). In some embodiments, the “reference point” described above corresponds to the initial positions of the light source 7042 and the light source 7044, and the light source 7042 and/or the light source 7044 can be (e.g., automatically) repositioned in accordance with movement of different user interfaces and/or user interface elements (e.g., the home user interface, the user interface 7032, or a user interface 7050, as described in further detail below). In some embodiments, the “reference point” described above applies to the initial positions of the light source 7042 and the light source 7044, and is not referenced after the initial positioning of the light source 7042 and the light source 7044, unless the user interface 7032 (e.g., or the home user interface) is redisplayed at a new location (e.g., in which case, the light source 7042 and the light source 7044 are repositioned, in predefined locations relative to the new location of the user interface 7032) (e.g., optionally, regardless of whether and/or how the light source 7042 and the light source 7044 have been repositioned in accordance with movement of other user interfaces or other user interface elements, as described below).

In some embodiments, the light source 7042 and the light source 7044 are placed opposite one another, with the user interface 7032 positioned between the two light sources. For example, as in FIG. 7C, the light source 7042 is positioned in an upper left corner, and the light source 7044 is positioned in a lower right corner. In some embodiments, the light source 7042 and the light source 7044 are positioned at default positions relative to the user interface 7032. For example, the light source 7042 and the light source 7044 are positioned at 45 degree angles (e.g., relative to a horizontal direction or axis of the user interface 7032), and a preset distance from the user interface 7032 (e.g., a center point of the user interface 7032).

In some embodiments, the user interface 7032 is substantially planar, and the light source 7042 and the light source 7044 are positioned in the same plane as the user interface 7032. In some embodiments, the light source 7042 and the light source 7044 are positioned in the same plane that is defined by the display generation component 7100 of computer system 101 (e.g., in cases where the user interface 7032 has a non-planar or otherwise irregular shape).

The user interface 7032 is displayed with a visual effect 7046 and a visual effect 7048. In some embodiments, the visual effect 7046 corresponds to (e.g., is based off of, and/or has an appearance that depends on a (e.g., spatial) relationship of the visual effect 7046 to) the light source 7042, and the visual effect 7048 corresponds to (e.g., is based off of, and/or has an appearance that depends on a (e.g., spatial) relationship of the visual effect 7046 to) the light source 7044. In some embodiments, the visual effect 7046 corresponds to both the light source 7042 and the light source 7044 (e.g., the appearance of the visual effect 7046 depends on a (e.g., spatial) relationship of the visual effect 7046 to the light source 7042, and also depends on a (e.g., spatial) relationship of the visual effect 7046 to the light source 7044), and the visual effect 7048 corresponds to both the light source 7042 and the light source 7044 (e.g., the appearance of the visual effect 7048 depends on a (e.g., spatial) relationship of the visual effect 7048 to the light source 7042, and also depends on a (e.g., spatial) relationship of the visual effect 7048 to the light source 7044).

In some embodiments, the visual effect 7046 and the visual effect 7048 are reflection effects, glow effects, or shadow effects. The descriptions of the visual effect 7046 and the visual effect 7048 below are applicable to any suitable visual effect.

The top-down view of FIG. 7C shows the user 7002 facing the user interface 7032, which is positioned between the user 7002 and the (representation of) the physical object 7014. The light source 7042 and the light source 7044 are positioned in the same plane as the user interface 7032 (e.g., an imaginary plane that includes the user interface 7032 and extends beyond the boundaries of the user interface 7032).

FIG. 7D illustrates a user interface 7050, which is displayed concurrently with the user interface 7032 (e.g., and as shown in FIG. 7D, is displayed as overlaying or occluding portions of the user interface 7032, from the current viewpoint of the user 7002, that is shown via the display generation component 7100 of the computer system 101). In some embodiments, the user interface 7050 is displayed in response to detecting a user input (e.g., a user input directed to an interactive element of the user interface 7032 in FIG. 7C, or a user input directed to a virtual element in FIG. 7B).

The user interface 7050 includes interactive elements, such as a text-entry field 7056, a button 7009, and a button 7011. In some embodiments, the user interface 7050 includes additional interactive elements, optionally in addition to one or more of the ones shown in FIG. 7D, and in some embodiments, the user interface 7050 includes fewer interactive elements than shown in FIG. 7D. In some embodiments, one or more visual effects (e.g., reflection effects, a glow effect, and/or a shadow effect) are applied to one or more user interface elements of the user interface 7050. For example, FIG. 7D shows the text-entry field 7056 with a visual effect 7058, and additional visual effects are optionally applied to the button 7009 and the button 7011 (e.g., in addition to the visual effect 7058 being applied to the text-entry field 7056). In some embodiments, the visual effects applied to other user interface elements (e.g., the button 7009 and/or the button 7011) have analogous behavior to the visual effects described below.

The user interface 7050 is displayed with a visual effect 7052, which appears in the upper left corner of the user interface 7050, and corresponds to (e.g., has an appearance that depends on a (e.g., spatial) relationship of the visual effect 7052 to) the light source 7042 (e.g., and/or the light source 7044). The user interface 7050 is displayed with a visual effect 7054, which appears in the lower left corner of the user interface 7050, and corresponds to (e.g., has an appearance that depends on a (e.g., spatial) relationship of the visual effect 7054 to) the light source 7044 (e.g., and/or the light source 7042). In some embodiments, the visual effect 7052 and the visual effect 7054 are reflection effects, glow effects, or shadow effects. The descriptions of the visual effect 7052 and the visual effect 7054 below are applicable to any suitable visual effect.

In some embodiments, the visual effect 7052 and the visual effect 7054 correspond to light sources other than the light source 7042 and/or the light source 7044. For example, the visual effect 7052 corresponds to a first light source (e.g., other than the light source 7042 and the light source 7044) and/or a second light source (e.g., other than the first light source, the light source 7042, and the light source 7044), and the visual effect 7054 corresponds to the second light source and/or the first light source. The first light source and the second light source are analogous to the light source 7042 and the light source 7044, respectively, but are positioned at predefined locations relative to the user interface 7050 (e.g., rather than the user interface 7032, as in the case of the light source 7042 and the light source 7044).

In some embodiments, the user interface 7050 includes an interactive element that has a simulated three-dimensional effect. For example, the text-entry field 7056 is displayed with an appearance that includes a simulated depth effect (e.g., to give the appearance that the text-entry field 7056 is recessed into the surface of the user interface 7050). In some embodiments, the user interface 7050 includes a mix of interactive elements with, and without, simulated three-dimensional effects (e.g., the text-entry field 7056 includes a simulated three-dimensional effect, but the button 7009 and the button 7011 do not include simulated three-dimensional effects). In some embodiments, interactive elements that are displayed with a simulated three-dimensional effect are also displayed with a visual effect that corresponds to one or more available light sources.

For example, the text-entry field 7056 is displayed with a visual effect 7058, which corresponds to the light source 7042 (e.g., and/or the light source 7044). In some embodiments, the visual effect 7058 is a reflection effect, a glow effect, and/or a shadow effect.

The top-down view of FIG. 7D is analogous to the top-down view in FIG. 7C, but also includes the user interface 7050, which is displayed closer to the viewpoint of the user 7002 (e.g., between the user interface 7032 and the user 7002).

In FIG. 7E (e.g., FIGS. 7E1, 7E2 and 7E3) (e.g., where a user interface analogous to the user interface described in FIG. 7E3 is shown on HMD 7100a in FIG. 7E1), the user interface 7050 is repositioned relative to the user interface 7032 (e.g., and the light source 7042 and the light source 7044, the user 7002, the home user interface of FIG. 7B (e.g., which is optionally displayed in place of the user interface 7032), and/or the three-dimensional environment).

FIG. 7E (e.g., FIGS. 7E1, 7E2 and 7E3) illustrates that the visual effect 7052, the visual effect 7054, and the visual effect 7058 are displayed with updated appearances to reflect the new relative position of the user interface 7050 relative to the light source 7042 and the light source 7044. For example, as the user interface 7050 is repositioned (e.g., moved in a horizontal direction with respect to the viewpoint of the user 7002, as illustrated in FIGS. 7E), the visual effect 7052 is displayed at a different location (e.g., the visual effect 7052 is repositioned along the edges of the user interface 7050, in accordance with the change in location of the user interface 7050) and/or with a different size (e.g., to simulate the amount and/or direction of light that reaches the user interface 7050, which would produce the visual effect 7052 in a real-world scenario). In some embodiments, if the user interface 7050 is repositioned in an opposite direction than shown in FIGS. 7E, the visual effect 7052, the visual effect 7052, and the visual effect 7054 are updated in an opposite or reverse manner (e.g., moving or expanding in a leftward direction instead of moving or expanding in a rightward direction).

In some embodiments, the visual effect 7058 for the text-entry field 7056 is changed in appearance by a different amount, as compared to the changes in the visual effect 7052 and the visual effect 7054 for the user interface 7050 more generally. For example, the visual effect 7052 is moved by a first amount (e.g., to the right) and the visual effect 7054 is moved by the first amount (e.g., to the left), and the visual effect 7058 is moved by a second amount that is different from the first amount (e.g., a larger amount, as in FIG. 7E). In some embodiments, the visual effect 7058 is changed in appearance in a first direction (e.g., a horizontal direction, or x-direction), but not in a second direction (e.g., a vertical direction, or a y-direction). For example, as compared to the visual effect 7058 in FIG. 7D, the visual effect 7058 in FIG. 7E has expanded along the bottom surface of the text-entry field 7056, but the amount of the visual effect 7058 that is displayed along a right surface of the text-entry field 7056 is the same in both FIG. 7D and FIG. 7E (e.g., the visual effect 7058 is not changed in appearance along the right surface of the text-entry field 7056, and is only changed in appearance along the bottom surface of the text-entry field 7058). In some embodiments, the visual effect 7058 is changed in appearance in both the first direction and the second direction, but the visual effect 7058 is changed in appearance in the first direction by a different magnitude than the change in appearance in the second direction (e.g., the visual effect 7058 is expanded (or shrunk) along the bottom surface of the text-entry field by a greater amount than the visual effect 7058 is expanded or shrunk, along the right surface of the text-entry field 7056, or vice versa).

In some embodiments, while the user interface 7050 is being repositioned, the visual effect 7052 and the visual effect 7054 are displayed with a different appearance (e.g., a different appearance such as a dimmer appearance, a lighter appearance, and/or a blurrier appearance, which visually deemphasizes the visual effect 7052 and the visual effect 7054). In some embodiments, the user interface 7050 is displayed with a different appearance (e.g., a different appearance such as a dimmer appearance, a lighter appearance, and/or a blurrier appearance, which visually deemphasizes the user interface 7050), and the visual effect 7052 and the visual effect 7054 are displayed with a different appearance that visually deemphasizes the visual effect 7052 and the visual effect 7054 by a greater amount than the user interface 7050 (e.g., the user interface 7050 is dimmed, lightened, and/or blurred while the user interface 7050 is being repositioned, and the visual effect 7052 and the visual effect 7054 are dimmed, lightened, and/or blurred by a greater amount than the user interface 7050, while the user interface 7050 is being repositioned) (e.g., such that the visual effect 7052 and the visual effect 7054 are visually deemphasized relative to the different appearance of the (e.g., visually-deemphasized) user interface 7050). In some embodiments, the user interface 7050 is displayed with the different appearance (e.g., that visually deemphasizes the user interface 7050) in response to detecting a user input directed to a move affordance (e.g., a grabber or other move and/or resize affordance) for the user interface 7050 (e.g., even if the user interface 7050 has not yet been repositioned). In some embodiments, once the user interface 7050 is no longer being repositioned (e.g., is substantially stationary), the user interface 7050, the visual effect 7052, and/or the visual effect 7054 are displayed with an original or default appearance (e.g., the same appearance as in FIG. 7D).

In some embodiments, where the visual effect 7052 and the visual effect 7054 are displayed with a reduced visual prominence while the user interface 7050 is being repositioned, the computer system 101 displays, via display generation component 7100, an animated transition of the visual effect 7052 and/or the visual effect 7054 sliding into place (e.g., an animated transition of the visual effect 7052 and/or the visual effect 7054 sliding and/or expanding from the location in FIG. 7D, to the location in FIG. 7E). In some embodiments, where the visual effect 7052 and the visual effect 7054 are shadow effects, the computer system 101 displays, via display generation component 7100, the visual effect 7052 and/or the visual effect 7054 transitioning through a plurality of intermediate appearances corresponding to occlusion (e.g., by one or more visible or invisible user interface objects) of the light source 7042 and/or the light source 7044, as the user interface 7050 is repositioned.

In some embodiments, where the visual effect 7052 and the visual effect 7054 are shadow effects, the shadow effects of the visual effect 7052 and the visual effect 7054 remain displayed while the user interface 7050 is being repositioned (e.g., even if the user interface 7050 is displayed with a reduced visual prominence while the user interface 7050 is being repositioned). In some embodiments, where the visual effect 7052 and the visual effect 7054 are shadow effects, the visual effect 7052 and the visual effect 7054 are displayed with reduced visual prominence as the user interface 7050 is being repositioned (e.g., as described above in the previous paragraph).

In FIG. 7F, the user interface 7050 continues to be repositioned (e.g., further along, in the same direction, as in FIG. 7E). The top-down view shows the new relative position of the user interface 7050 in the three-dimensional environment. The visual effect 7052, the visual effect 7054, and the visual effect 7058 are again updated with new appearances (e.g., to updated locations), in accordance with the repositioning of the user interface 7050.

In some embodiments, the user interface 7050 is repositioned by the same amount between FIG. 7D to FIGS. 7E, and from FIG. 7E to FIG. 7F. The visual effect 7052 and the visual effect 7054 are moved (e.g., and/or change size) by the same amount between FIG. 7D and FIGS. 7E, and between 7E and FIG. 7F. In contrast, the visual effect 7058 moves (e.g., and/or changes size) by a greater amount between FIG. 7D and FIGS. 7E, and by a smaller amount between FIG. 7E and FIG. 7F. In other words, in some embodiments, visual effects applied to user interface elements (e.g., the text-entry field 7056) within a user interface (e.g., the user interface 7050) reflect a greater degree of change in response to a first portion of movement, and that degree of change is reduced (e.g., tapers off) in response to a second portion of movement (e.g., that optionally includes the same amount of movement as the first portion of movement).

FIG. 7F illustrates four regions, including a region 7060 along the top surface of the user interface 7050, a region 7062 along the left surface of the user interface 7050, a region 7064 along the right surface of the user interface 7050, and a region 7066 along the bottom surface of the user interface 7050. The regions 7060, 7062, 7064, and 7066, are optionally not visually displayed (e.g., are illustrated for reference, but are not rendered via the display generation component 7100 of the computer system 101), and represent regions in which visual effects are not displayed. For example, the visual effect 7052 continues to move or expand rightward along the top edge of the user interface 7050, but the visual effect 7052 cannot move or expand into the region 7060 (e.g., the visual effect 7052 moves or expands until it is adjacent to the region 7060, as shown in FIG. 7F, but the visual effect 7052 cannot move or expand beyond the boundary of the region 7060). Similarly, the visual effect 7054 expands along the bottom surface of the user interface 7050, until it is adjacent to the region 7066, but does not expand beyond the boundary of the region 7066.

The regions 7060, 7062, 7064, and 7066 prevent the visual effect 7052 and the visual effect 7054 from accurately simulating visual effects due to the light source 7042 and the light source 7044 (e.g., if the visual effect 7042 is a reflection of light coming from the light source 7042, then an accurate simulation of the reflected light would be able to extend into, and through, the region 7060). The regions 7060, 7062, 7064, and 7066, however, allow the computer system 101 to maintain consistent visual clarity. For example, in some cases, a truly accurate simulation of real-world lighting would result in a visual effect 7052 (e.g., a reflection) that spans the entirety of the top surface of the user interface 7050. In practice, this can cause visual artifacts (e.g., undesirable aliasing effects) in the displayed view, and displaying visual effects that span large areas (e.g., even if accurately rendered) can negatively impact visibility (e.g., and thus, accessibility) of user interfaces and/or user interface elements.

In some embodiments, the regions 7060, 7062, 7064, and 7066 are associated with distance thresholds (e.g., threshold amounts of movement). If the user interface 7050 is repositioned to a new position that is less than the threshold distance from the original position, then the visual representation 7052, the visual representation 7054, and the visual representation 7058 are updated as shown in FIGS. 7D-7F. In some embodiments, the state shown in FIG. 7F is the state at which the user interface 7050 has been moved to a new position that is just below the threshold distance from the original position (e.g., the maximum distance before reaching or exceeding the threshold distance). In some embodiments, the light source 7042 and the light source 7044 do not change positions or orientations as the user interface 7050 is repositioned, as long as the user interface 7050 is repositioned to a new position that is less than the threshold distance from the original position.

In FIG. 7G, the user interface 7050 continues to be repositioned, and has been moved to a new position that is the threshold distance (e.g., or more than the threshold distance) from the original position (e.g., the position of the user interface 7050 in FIG. 7D). As shown by the top-down view, the user interface 7050 is now rotated (e.g., along with the viewpoint of the user 7002, as the user 7002 rotates to face a different direction). The view of the three-dimensional environment visible via the display generation component 7100 of the computer system 101 is updated to display the representation 7004′ of the wall 7004, the representation 7006′ of the wall 7006, and the representation 7008′ of the floor 7008 consistent with the current viewpoint of the user 7002; the representation 7014′ of the physical object 7014 is no longer visible.

In response to detecting that the user interface 7050 is moved to the new position that is the threshold distance (e.g., or more than the threshold distance) from the original position (e.g., and because visual effects are not displayed in the regions 7060, 7062, 7064, and 7066), the light source 7042 and the light source 7044 are repositioned. In some embodiments, the light source 7042 and the light source 7044 are “flipped” about a vertical or y-axis (e.g., of the user interface 7050), relative to the default positions of the light source 7042 and the light source 7044. In other words, if the default positions of the light source 7042 and the light source 7044 are in the upper left corner, and the lower right corner, respectively, then once “flipped” about the vertical or y-axis (e.g., in accordance with movement along the lateral or x-axis), the new positions of the light source 7042 and the light source 7044 are in the upper right corner and the lower left corner, respectively (e.g., and as shown in FIG. 7G).

The visual effect 7052, the visual effect 7054, and the visual effect 7068 are updated in accordance with movement of the user interface 7050. In some embodiments, since the visual effect 7052 and the visual effect 7054 correspond to the light source 7042 and the light source 7044, respectively, when the light sources are “flipped,” the visual effect 7052 and the visual effect 7054 are also “flipped” (e.g., displayed on an opposite side of the region 7060 and the region 7066, respectively). In some embodiments, the visual effect 7052 and the visual effect 7054 are moved by a first amount when the user interface 7050 is moved by a first amount, before the user interface 7050 is moved to a position that is the threshold distance from the original position, and the visual effect 7052 and the visual effect 7054 are moved by a second amount (e.g., that is greater than the first amount) when the user interface 7050 is moved by a second amount (e.g., that is more than the first amount), when the user interface 7050 is moved to a position that is (e.g., or is more than) the threshold distance from the original position (e.g., because the visual effect 7052 and the visual effect 7054 cannot be displayed in the region 7060 and the region 7066). In some embodiments, for a respective amount of movement of the user interface 7050 to a position that is within the threshold distance from the original position, the visual effect 7052 and the visual effect 7054 by smaller amounts than for the same respective amount of movement of the user interface to a position that is at least the threshold distance from the original position.

In some embodiments, the visual effect 7058 does not “flip” even if the light source 7042 and the light source 7044 are repositioned relative to the user interface 7050 (e.g., visual effects for user interface elements within a user interface 7050 behave differently than visual effects applied to the user interface 7050 itself). Instead, as shown in FIG. 7G, the visual effect 7058 continues to update in an analogous fashion as shown in and described with reference to FIGS. 7D-7F, but with a smaller degree of change (e.g., less movement and/or change in size).

In FIG. 7H, the user interface 7050 continues to be repositioned. As shown by the top-down view, the user interface 7050 continues to be rotated (e.g., along with the viewpoint of the user 7002, as the user 7002 rotates to face a different direction). The view of the three-dimensional environment visible via the display generation component 7100 of the computer system 101 is updated to display the virtual object 7016 (e.g., which is now in the viewport of the three-dimensional environment visible to the user 7002), the representation of the wall 7006′, and the representation of the floor 7008′ consistent with the current viewpoint of the user 7002; the representation 7004′ of the wall 7004 is no longer visible.

Since the user interface 7050 is moved to a new position that is less than the threshold distance from a previous position (e.g., the position of the user interface 7050 in FIG. 7G), the visual effect 7052 and the visual effect 7054 are updated in an analogous fashion as described above with reference to FIGS. 7D-7F. The visual effect 7058 continues to update in an analogous fashion as shown in and described with reference to FIGS. 7D-7F, but with a smaller degree of change (e.g., less movement and/or change in size, which is optionally less than the amount of movement and/or change in size from FIG. 7F to FIG. 7G). In some embodiments, if the user interface 7050 is moved to a new position that is the threshold distance (e.g., or is more than the threshold distance) from the previous position (e.g., the position of the user interface 7050 in FIG. 7G), the visual effect 7052 and the visual effect 7054 again “flip” to the opposite side about the y-axis (e.g., switching to the opposite side of the region 7060 and 7066, respectively). In this way, as the user interface 7050 continues to be repositioned, the visual effect 7052 and the visual effect 7054 continue to “flip” about the y-axis of the user interface 7050 (e.g., to alternate sides relative to the region 7060 and the region 7066, respectively), each time the user interface 7050 is moved by the threshold distance (e.g., to a new position that is the threshold distance from a previous position, where the visual effect 7052 and the visual effect 7054 last “flipped”). In some embodiments, the threshold distance is defined such that if the user interface 7050 is repositioned by rotating the user interface 7050 in an analogous fashion to that shown in FIG. 7F-7G, the visual effect 7052 and the visual effect 7054 continue to “flip” about the y-axis of the user interface 7050 each time the user interface 7050 is rotated (e.g., and said rotation causes the user interface 7050 to move to a new position that is the threshold distance from a previous position where the visual effect 7052 and the visual effect 7054 were last “flipped), and if the user interface 7050 is rotated far enough that the user interface 7050 returns to the position of the user interface 7050 in FIG. 7D, or FIG. 7F, the visual effect 7052 and the visual effect 7054 are displayed at the same location (e.g., or locations on the same side of the region 7060 and the region 7066, respectively) as in FIG. 7D and FIG. 7F (e.g., the visual effect 7052 starts to the left of the region 7060 and the visual effect 7054 starts to the right of the region 7066, as in FIG. 7D, and the visual effect 7052 and the visual effect 7054 are “flipped” every 45 degrees of rotation (or other angular interval, such as an angular interval between 15-120 degrees), such that when the user interface 7050 has been rotated through a full 360 degrees (e.g., returning to the original position), the visual effect 7052 and the visual effect 7054 are again to the left of the region 7060 and to the right of the region 7066, respectively).

In FIG. 7I, the viewpoint of the user 7002 changes (e.g., the user 7002 repositions the display generation component 7100 to display a different view of the three-dimensional environment), but the user 7002 does not reposition the user interface 7050 (e.g., the user interface 7050 is at the same position in the three-dimensional environment in both FIG. 7H and in FIG. 7I). As shown in the top-down view, the user 7002 has moved to an intermediate position 7068, and then to a new position at a new viewing angle.

The visual effect 7052 and the visual effect 7054 are updated to reflect the change in viewpoint of the user 7002. For example, the visual effect 7052 continues to move along the top surface of the user interface 7050 (e.g., and has almost moved completely off the top surface of the user interface 7050), and the visual effect 7054 has moved and/or expanded to the boundary of the region 7062 (e.g., but cannot move and/or expand into or beyond the boundaries of the region 7062).

In some embodiments, for certain types of visual effects (e.g., shadow effects), the visual effect 7052 and the visual effect 7054 are not updated to reflect changes in viewpoint of the user 7002. For such types of visual effects, instead of the positions of the visual effect 7052 and the visual effect 7054 shown in FIG. 7I, the visual effect 7052 and the visual effect 7054 are instead positioned at the same positions (e.g., relative to the user interface 7050) as in FIG. 7H.

In some embodiments, visual effects applied to user interface elements (e.g., the visual effect 7058 corresponding to the text-entry field 7056) have different behavior than visual effects applied to the (e.g., border and/or window of the) user interface 7050 (e.g., the visual effect 7052 and the visual effect 7054). For example, the visual effect 7058 does not change in appearance when the viewpoint of the user 7002 changes (e.g., as shown in FIG. 7H-7I), whereas the visual effect 7052 and the visual effect 7054 do change in appearance when the viewpoint of the user 7002 changes (e.g., and/or the user interface 7050 is repositioned). In some embodiments, the visual effect 7058 changes in appearance when the viewpoint of the user 7002 changes and does not change when the user interface 7050 is repositioned, whereas the visual effect 7052 and the visual effect 7054 change in appearance when the viewpoint of the user 7002 changes as well as when the user interface 7050 is repositioned.

In some embodiments, the visual effect 7058 changes in appearance in accordance with a change in viewpoint of the user in a first direction (e.g., a horizontal direction) but does not change in accordance with a change in viewpoint of the user in a second direction different from the first direction (e.g., a vertical direction). In some embodiments, the visual effect 7052 and the visual effect 7054 change in appearance in accordance with a change in viewpoint of the user in the first direction, and in accordance with a change in viewpoint of the user in the second direction.

In some embodiments, the movement thresholds for determining whether or not to “flip” the light source 7042 and the light source 7044 are applied only to movement of the user interface 7050 within (e.g., relative to) the three-dimensional environment, and is not applied to the movement of the user 7002 (e.g., even though this may change the relative position of the user interface 7050 relative to the user 7002). As such, the user 7002 cannot cause the light source 7042 and the light source 7044 to “flip” back to the original orientation (e.g., with the light source 7042 in the upper left corner and the light source 7044 in the lower right corner), even if the user 7002 moves by a large amount and/or moves to an extreme viewing angle. In some embodiments, the computer system 101 continues to update the visual effect 7052 and the visual effect 7054, but without any “flipping.” For example, the visual effect 7054 is displayed at the boundary of the region 7062, and may be resized in accordance with the movement of the user 7002, but without entering or overlapping the region 7062.

In some embodiments, if the user 7002 moves such that the user interface 7050 is displayed at an extreme viewing angle (e.g., the user is looking almost directly at the left edge of the user interface 7050, which includes the visual effect 7054 and the region 7062, and can see very little of the “front” surface of the user interface 7050 that includes the text-entry field 7056, the button 7009 and the button 7011), the computer system 101 ceases to display the visual effect 7052 and the visual effect 7054 (e.g., and optionally, also the visual effect 7058) (e.g., to prevent any visual artifacts from displaying visual effects at an extreme viewing angle). For example, the computer system 101 continues to display the visual effect 7052 and the visual effect 7054 while the user 7002 is at the intermediate position 7068, but the computer system 7100 ceases to display the visual effect 7052 and the visual effect 7054 when the user 7002 is at the location shown in FIG. 7I.

In FIG. 7J, the user 7002 returns to the original location (e.g., the same location of the user 7002 in FIG. 7H). The visual effect 7052, the visual effect, 7054, and the visual effect 7058 are updated to reflect the change in position of the user 7002 (e.g., each visual effect has the same appearance in FIG. 7J as in FIG. 7H, as the user 7002 is at the same position, and the user interface 7050 is at the same position, in both figures).

In FIG. 7K, the user 7002 redisplays the user interface 7032. As shown in the top-down view, the user interface 7032 is displayed between the user interface 7050 and the user 7002 (e.g., so that the user interface 7050 is not currently visible to the user 7002, via the display generation component 7100 of the computer system 101). In some embodiments, the user 7002 redisplays the home user interface (e.g., of FIG. 7B) instead of (e.g., or in addition to) the user interface 7032.

As described above with reference to FIG. 7C, in some embodiments, the light source 7042 and the light source 7044 are positioned relative to a reference point in the user interface 7032 (or relative to user interface 7032, which itself serves as the reference point). As shown in FIG. 7K, when the user interface 7032 is redisplayed, the light source 7042 and the light source 7044 are automatically repositioned at the default positions relative to the reference point in the user interface 7032. In some embodiments, the light source 7042 and the light source 7044 are repositioned regardless of the position and/or previous movement of the user interface 7050 (e.g., although movement of the user interface 7050, in FIGS. 7G and 7H, caused the visual effect 7052 and the visual effect 7054 to change position (e.g., to “flip”), the light source 7042 and the light source 7044 revert to their default positions (e.g., to “unflip” and to return to their original positions relative to the user interface 7032 as in FIG. 7C)). The visual effect 7046 and the visual effect 7048, which are applied to the user interface 7032, have the same appearance in FIG. 7K as in FIG. 7C (e.g., because the light source 7042 and the light source 7044 have the same relative positions to the user interface 7032 in both figures).

In FIG. 7L, the user 7002 repositions (e.g., moves, relaunches, or otherwise reinvokes) the user interface 7050, such that the user interface 7050 is displayed between the user interface 7032 and the user 7002 (e.g., as shown in the top-down view). Since the light source 7042 and the light source 7044 were repositioned as described with reference to FIG. 7K, the visual effect 7052, the visual effect 7054, and the visual effect 7058 have the same appearance in FIG. 7L as in FIG. 7D.

While the descriptions above are generally agnostic with respect to the type of visual effect and/or combination of visual effect types (e.g., and can be applied to any suitable type of visual effect and/or combination of visual effect types), in some embodiments, a respective one (or more) of the visual effect 7046, the visual effect 7048, the visual effect 7052, the visual effect 7054, and/or the visual effect 7058 includes a plurality of visual effect types (e.g., a reflection effect in combination with a shadow effect, or a glow effect in combination with a shadow effect). Optionally, different visual effect types that together constitute a respective visual effect (e.g., the visual effect 7046, the visual effect 7048, the visual effect 7052, the visual effect 7054, or the visual effect 7058) have different positions relative to a user interface to which the respective visual effect corresponds (e.g., the user interface 7032 or the user interface 7050). For example, if a visual effect that represents a simulated lighting effect is displayed at a top left corner of a user interface, a corresponding simulated shadow is displayed at a lower right corner of the user interface (e.g., consistent with the user interface occluding the simulated light that produced the simulated lighting effect). In some embodiments, each respective visual effect of each respective visual effect type is changed and/or updated (e.g., as described above without specific mention of the type and/or combination of visual effect types) by the same amount and/or degree (e.g., as the user interface 7050 is repositioned). In some embodiments, when a respective visual effect includes a combination of visual effect types, multiple visual effects of different visual effect types (e.g., including each respective visual effect of each respective visual effect type) are changed and/or updated based on an amount of progress along an animation curve. For example, each respective visual effect is changed and/or updated by the same first amount along the animation curve, in response to a first amount of movement of the user interface 7050 (e.g., a first portion of movement of the user interface 7050), and each respective visual effect is changed and/or updated by the same second amount (e.g., that is optionally different from the first amount) along the animation curve, in response to a second amount of movement of the user interface 7050 (e.g., a second portion of movement of the user interface 7050, that follows the first portion of movement).

Additional descriptions regarding FIGS. 7A-7L are provided below in reference to method 900 described with respect to FIG. 9 and method 1000 described with respect to FIG. 10.

FIGS. 8A-8M illustrate examples of repositioning a shadow corresponding to a user interface as the user interface is reoriented. FIG. 11 is a flow diagram of an exemplary method 1100 for repositioning a shadow corresponding to a user interface as the user interface is reoriented. The user interfaces in FIGS. 8A-8M are used to illustrate the processes described below, including the processes in FIG. 11.

As shown in the examples in FIGS. 8A-8M, content that is visible via a display generation component 7100 of computer system 101 is displayed on a touch screen held by user 7002. In some embodiments, display generation component 7100 of computer system 101 is a head-mounted display worn on user 7002's head (e.g., what is shown in FIGS. 8A-8M as being visible via display generation component 7100 of computer system 101 corresponds to user 7002's field of view when wearing a head-mounted display).

FIG. 8A illustrates a first view of a three-dimensional environment, displayed via a display generation component 7100 of the computer system 101, that includes a surface 8000 (e.g., a virtual surface or a passthrough view of a physical surface in a corresponding physical environment) and a user interface 8002. FIG. 8A also includes a side view of the three-dimensional environment that shows the relative positions and orientations of the surface 8000 and the user interface 8002, to further illustrate the relative depth of the user interface 8002 in the first view of the three-dimensional environment). The user interface 8002 can be repositioned, reoriented, and/or resized via a grabber 8004. While the grabber 8004 is illustrated as three bars that are centered below the user interface 8002, the grabber 8004 can be any suitable size (e.g., longer, shorter, wider, and/or thinner than the grabber 8004 illustrated in FIG. 8A) and/or shape (e.g., a single bar, two bars, a circle, a triangle, a rectangle, or other shape or graphic), and can be located in any suitable region in proximity to the user interface 8002 (e.g., centered above the user interface 8002, or to the right of the user interface 8002, to the left of the user interface 8002, or other arrangement).

Light sources 8008 are oriented and positioned such that the user interface 8002 casts a shadow 8006 on the surface 8000. As shown in the side view, the shadow 8006 is directly below the user interface 8002. The shadow 8006 has a first appearance (e.g., a default appearance), while the user's attention 8010 is not directed to the user interface 8002 or the grabber 8004.

In FIG. 8B, the user's attention 8010 moves to the user interface 8002. In response to detecting that the user's attention 8010 is directed to the user interface 8002, the appearance of the shadow 8006 is changed to a different appearance. For example, in FIG. 8B, the shadow 8006 appears darker and/or more opaque than the shadow 8006 in FIG. 8A, to indicate (e.g., and/or provide visual feedback) that the user's attention is directed to the user interface 8002.

In FIG. 8C, the user's attention 8010 moves to the grabber 8004 and the user 7002 performs a predefined gesture (e.g., an air tap, an air pinch, or another air gesture) to select the grabber 8004. In response to detecting that the user's attention 8010 is directed to the grabber 8004 (e.g., in conjunction with the predefined gesture), the computer system 101, via display generation component 7100, updates the appearance of the shadow 8006 to a different appearance. In some embodiments, the different appearance (e.g., the appearance of the shadow 8006 in FIG. 8C) is the same as the default appearance (e.g., the appearance of the shadow 8006 in FIG. 8A). In some embodiments, the different appearance is a third appearance that is different from the appearance of the shadow 8006 in both FIG. 8A and FIG. 8B. In some embodiments, the computer system 101 updates the display of the shadow 8006 as soon as the computer system 101 detects the user's attention 8010 directed to the grabber 8004 in conjunction with the predefined gesture (e.g., even if the user 7002 does not begin to reposition, reorient, and/or resize the user interface 8002). In some embodiments, the shadow 8006 does not change in appearance (e.g., maintains the same appearance as in FIG. 8B), and maintains the same appearance (e.g., as in FIG. 8B) while the user interface 8002 is being reoriented.

In FIG. 8D (e.g., FIGS. 8D1, 8D2 and 8D3) (e.g., where a user interface analogous to the user interface described in FIG. 8D1 is shown on HMD 7100a in FIG. 8D2), the user 7002 reorients (e.g., using an indirect air gesture (e.g., and/or a direct air gesture) performed by the user's hand 7020 while the user's attention 8010 is directed to the grabber 8004, the indirect air gesture not based on the position of the representation of the user's hand 7020′) the user interface 8002 such that a bottom edge of the user interface 8002 moves closer the viewpoint of the user 7002 while a top edge of the user interface 8002 moves further from the viewpoint of the user 7002. A position of the shadow 8002 also changes. An outline 8012 illustrates the original position of the shadow 8006 (e.g., the position of the shadow 8006 in FIGS. 8A-8C), and the shadow 8006 has a current position that is closer to the (viewpoint of the) user 7002. The side view also shows the new position of the shadow 8006 (e.g., instead of being directly below a center of the user interface 8002 as in FIG. 8C, the shadow 8006 in FIG. 8D (e.g., FIGS. 8D1, 8D2 and 8D3) has moved closer to the viewpoint of the user 7002 than the center of the user interface 8002 is to the viewpoint of the user). While FIG. 8D shows the shadow 8006 moving closer to the viewpoint of the user 7002, in some embodiments, the shadow 8006 moves in another suitable direction (e.g., moves further away from the viewpoint of the user 7002).

In some embodiments, the shadow 8006 changes position (e.g., closer or further to the viewpoint of the user 7002) without changing in size (e.g., a width and/or thickness) (e.g., even though a real shadow of a real object being tilted or reoriented in the same manner as the user interface 8002 would change in size). In some embodiments, the shadow 8006 has the same appearance as in FIG. 8C (e.g., the default appearance), and maintains the same appearance while the user interface 8002 is being repositioned, reoriented, and/or resized. In some embodiments, the shadow 8006 has a fourth appearance (e.g., that is different from the appearance in FIGS. 8A, 8B, and 8C), and maintains the fourth appearance while the user interface 8002 is being repositioned, reoriented, and/or resized.

In some embodiments, the position of the shadow 8006 is updated in real time (e.g., or at predefined time intervals) as the user interface 8002 is repositioned. In some embodiments, the amount of change in the position of the shadow 8006 reflects the amount of change in the orientation of the user interface 8002 (e.g., a small change in orientation of the user interface 8002 results in a small change in position of the shadow 8006, and a large change in orientation of the user interface 8002 results in a large change in position of the shadow 8006).

In FIG. 8E (e.g., FIGS. 8E1, 8E2 and 8E3) (e.g., where a user interface analogous to the user interface described in FIG. 8E3 is shown on HMD 7100a in FIG. 8E1), the user 7002 ceases to reorient the user interface 8002 (e.g., as shown by the absence of the hand performing the predefined gesture in FIG. 8E). In response to detecting that the grabber 8004 is no longer selected, the computer system 101 updates the appearance of the shadow 8006 (e.g., back to a same appearance as in FIG. 8B, where the user's attention 8010 was directed to the user interface 8002 and the user 7002 was not repositioning, reorienting, or resizing the user interface 8002). In some embodiments, the shadow 8006 in FIG. 8E has the same appearance as the shadow 8006 in FIG. 8B (e.g., the shadow 8006 is not displayed with the default appearance because the user's attention 8010 is still directed to the grabber 8004 that correspond to the user interface 8002).

Since the user interface 8002 was further reoriented prior to the user 7002 ceasing to perform the predefined gesture (e.g., as shown in the side view, the orientation of the user interface 8002 in FIG. 8E is different from the orientation of the user interface 8002 in FIGS. 8D), the position of the shadow 8006 is also updated (e.g., the shadow 8006 appears even closer to the viewpoint of the user 7002 in FIGS. 8E, as compared to FIGS. 8D). In some embodiments, the shadow 8006 is moved by an amount that is proportional to the amount by which the user interface 8002 is reoriented (e.g., the shadow 8006 is moved further when the user interface 8002 is reoriented by a large amount (e.g., rotated or tilted by a large amount), and the shadow 8006 is moved by a smaller distance when the user interface 8002 is reoriented by a small amount).

In FIG. 8F, the user's attention 8010 is no longer directed to the user interface 8002, nor the grabber 8004, and the computer system 101 updates the appearance of the shadow 8006 to the default appearance (e.g., the same appearance as in FIG. 8A).

FIG. 8G illustrates that, in some embodiments, the user 7002 does not manually adjust the orientation of the user interface 8002. In some embodiments, the user 7002 repositions the user interface 8002 (e.g., changes a position of the user interface 8002 without intentionally adjusting an orientation of the user interface 8002), and the computer system 101 automatically reorients the user interface 8002 (e.g., to ensure content in the user interface 7002 remains visible to the user 7002, as the user interface 8002 is moved). In some embodiments, a shadow corresponding to the user interface 8002 (e.g., an analogous shadow to the shadow 8006 in FIGS. 8A-8F) is displayed and has analogous behavior as described above with reference to FIGS. 8A-8F (e.g., the shadow behaves in an analogous fashion as described with reference to the shadow 8006, as the user interface 8002 is automatically reoriented). In some embodiments, when the user interface 8002 is repositioned (e.g., and before the user interface 8002 is automatically reoriented), the shadow moves by a proportional amount (e.g., such that the shadow is always directly beneath the user interface 8002); when the user interface 8002 begins to be (e.g., automatically) reoriented, the shadow moves by an additional amount beyond the proportional amount (e.g., consistent with the description of the shadow 8006's behavior in FIGS. 8A-8G).

For example, FIG. 8G shows a region 8016 around the viewpoint of the user 7002 (e.g., represented in FIG. 8G by the head of the user 7002), with an outline 8014 representing an original position of the user interface 8002 before the user interface 8002 is repositioned.

In the top example, the user interface 8002 begins at a position that is relatively low in the viewpoint of the user 7002. If the user 7002 repositions the user interface 8002 to move the user interface 8002 closer to the viewpoint of the user 7002, portions of the user interface 8002 may no longer be visible due to the physical constraints of the display generation component 7100 of the computer system 101. To preserve visibility of these portions of the user interface 8002, the computer system 101 automatically reorients the user interface 8002 to maintain visibility (e.g., by tilting the user interface 8002 “upwards,” alternately described as reorienting the user interface 8002 such that the bottom edge of the user interface 8002 is closer to the viewpoint of the user 7002 and the top edge of the user interface 8002 is further from the viewpoint of the user 7002). In geometric terms, when the user interface 8002 is repositioned such that it would enter the region 8016, the computer system 101 automatically reorients the user interface 8002 such that a surface of the user interface 8002 is substantially tangential to the circle defined by the region 8016.

In the middle example, the user interface 8002 begins at a position that is low in the viewpoint of the user 7002, but not as low as in the top example. The computer system 101 automatically reorients the user interface 8002 when the user interface 8002 is close to the viewpoint of the user 7002 (e.g., about as close as in the top example), but to a lesser degree than in the top example (e.g., the user interface 8002 is not tilted as much as in the top example).

In the bottom example, the user interface 8002 begins at a position that is high in the viewpoint of the user 7002. The computer system 101 automatically reorients the user interface 8002 (e.g., by tilting the user interface 8002 “downwards,” alternately described as reorienting the user interface 8002 such that the bottom edge of the user interface 8002 is further from the viewpoint of the user 7002 and the tope edge of the user interface 8002 is closer to the viewpoint of the user 7002) when the user interface 8002 is close to the viewpoint of the user (e.g., about as close as in the top and middle examples).

FIG. 8H is analogous to FIG. 8F, except that in FIG. 8H the user's attention 8010 is directed to the grabber 8004 and the user 7002 performs the predefined gesture. Since the computer system 101 detects that the user's attention 8010 is directed to the grabber 8004 and that the user 7002 is performing the predefined gesture, the shadow 8006 is displayed with the same appearance as in FIGS. 8C and 8D.

In FIG. 8I, the user 7002 reorients the user interface 8002 in an opposite direction as compared to FIGS. 8C-8F. In FIG. 8I, the user interface 8002 has been reoriented such that is has the same orientation as the user interface 8002 in FIG. 8A (e.g., the user 7002 “untilts” or straightens the user interface 8002, and reverses the change in orientation performed in FIGS. 8C-8F). The shadow 8006 moves back to the same position as in FIG. 8A (e.g., as also shown in the side view).

In FIG. 8J, the user 7002 continues to reorient the user interface 8002 in the opposite direction (e.g., the top edge of the user interface 8002 moves closer to the viewpoint of the user 7002, and the bottom edge of the user interface 8002 moves further from the viewpoint of the user 7002).

In some embodiments, as shown in FIG. 8J, the shadow 8006 moves closer to the viewpoint of the user 7002 (e.g., the shadow 8006 always moves closer to the viewpoint of the user 7002, regardless of whether the user interface 8002 is being tilted towards or away from the viewpoint of the user 7002). In some embodiments, the shadow 8006 moves further from the viewpoint of the user 7002 (e.g., tilting the user interface 8002 in a first direction causes the shadow 8006 to move in a first direction, and tilting the user interface 8002 in an opposite direction causes the shadow 8006 to move in a different (e.g., opposite) direction).

In FIG. 8K, the user 7002 ceases to reorient the user interface 8002 (e.g., as illustrated by the absence, in FIG. 8K, of the user's hand performing the predefined gesture (shown in FIG. 8J)). Since the user's attention 8010 remains directed to the grabber 8004, the shadow 8006 is displayed with the same appearance as in FIGS. 8B and 8E.

In FIG. 8L, the user 7002 repositions the user interface 8002 (e.g., without an orientation of the user interface 8002 changing), such that the user interface 8002 moves further from the surface 8000. In response to detecting the change in position of the user interface 8002, the computer system 101 updates the appearance of the shadow 8006. In some embodiments, the shadow 8006 is displayed with an appearance that is different from the appearance of the shadow 8006 in any previously described figure (e.g., the appearance of the shadow 8006 in FIG. 8L is different from both the appearance of the shadow 8006 in FIG. 8A, and the appearance of the shadow 8006 in FIG. 8B). In some embodiments, the size (e.g., width and/or thickness) of the shadow 8006 does not change (e.g., even though the shadow cast by a real-world object would change in size if repositioned in a manner analogous to the change in position of the user interface 8002). In some embodiments, the shadow 8006 is updated with an appearance that is visually deemphasized (e.g., dimmer, blurrier, more transparent, and/or other visual deemphasis) relative to the default appearance of the shadow 8006.

FIG. 8M illustrates that if the user interface 8002 is moved beyond a threshold height H_{Th} (e.g., wherein the threshold height is a predefined distance from the surface 8000), the computer system 101 ceases to display the shadow 8006. In some embodiments, as the user interface 8002 is gradually repositioned (e.g., moved further and further upwards, relative to the surface 8000), the computer system 101 displays a gradual change in the appearance of the shadow 8006 (e.g., the shadow 8006 is displayed with an appearance that becomes gradually blurrier and/or lighter, as the user interface 8002 is moved), until the user interface 8002 is moved beyond the threshold distance H_{Th}, at which point the computer system 101 ceases to display the shadow 8006.

Additional descriptions regarding FIGS. 8A-8M are provided below in reference to method 1100 described with respect to FIG. 11.

FIG. 9 is a flow diagram of an exemplary method 900 for repositioning a shadow corresponding to a user interface as the user interface is reoriented, in accordance with some embodiments. In some embodiments, method 900 is performed at a computer system (e.g., computer system 101 in FIG. 1A) that is in communication with a display generation component (e.g., display generation component 120 in FIGS. 1A, 3, and 4 or display generation component 7100 in FIG. 7A) (e.g., a heads-up display, a display, a touchscreen, a projector, or other display device) and one or more sensors (e.g., one or more cameras (e.g., color sensors, infrared sensors, and/or other depth-sensing cameras), touch-sensitive surfaces, motion sensors, and/or orientation sensors). In some embodiments, the method 900 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 900 are, optionally, combined and/or the order of some operations is, optionally, changed.

The computer system displays (902), via the display generation component, a first view of a three-dimensional environment, the first view of the three-dimensional environment including a first user interface (e.g., the user interface 7050 in FIG. 7D) at a first position in the three-dimensional environment (e.g., a first position in the three-dimensional environment that has a first spatial relationship with a first viewpoint associated with the first view of the three-dimensional environment). The first user interface is displayed with a first simulated lighting effect at a first location on the first user interface (e.g., the visual effect 7052 is displayed at a first location in FIG. 7D). The first location is a location within a first subregion (e.g., a first corner or a first edge) of the first user interface (e.g., the visual effect 7052 is within an upper left corner of the user interface 7050, and the visual effect 7054 is displayed within a lower right corner of the user interface 7050).

The computer system detects (904) an event corresponding to movement of the first user interface (e.g., an input directed to the first user interface corresponding to a request to move the first user interface, or an input corresponding to a request to move multiple user interfaces including the first user interface, or a request by another participant in a real-time communication session that the user of the computer system is participating in to move the first user interface, or a status change event for the computer system or first user interface that causes the first user interface to be moved) (e.g., the user interface 7050 is repositioned in FIGS. 7E-7G).

In response to detecting the event, the computer system moves (906) the first user interface from the first position in the three-dimensional environment to a second position in the three-dimensional environment (e.g., with movement of the first user interface from the first position to a second position in the view of the three-dimensional environment without a change in viewpoint, or with a change in viewpoint from the first viewpoint associated with the first view of the three-dimensional environment to a second viewpoint associated with a second view of the three-dimensional environment that is different from the first view of the three-dimensional environment).

Moving the first user interface includes: in accordance with a determination that a distance between the first position and the second position is less than a threshold distance (e.g., in FIG. 7F, the user interface 7050 is moved to a second position that is less than a threshold distance from the first position (e.g., the position in FIG. 7D)), displaying (908) the first user interface with a second simulated lighting effect at a second location on the first user interface. The second location is different from the first location on the first user interface, and the second location is within the first subregion of the first user interface (e.g., the simulated lighting effect is adjusted slightly along the first corner or first edge of the first user interface) (e.g., in FIG. 7F, the visual effect 7052 is displayed at a second location, but still within the upper left corner of the user interface 7050, and the visual effect 7054 is displayed at a second location, but still within the lower right corner of the user interface 7050).

In addition, moving the first user interface includes: in accordance with a determination that the distance between the first position and the second position is at least the threshold distance (e.g., in FIG. 7G, the user interface 7050 is moved to a second position that is more than the threshold distance from the first position (e.g., the position in FIG. 7D)), displaying (910) the first user interface with a third simulated lighting effect at a third location on the first user interface. The third location on the first user interface is different from the first location on the first user interface and the second location on the first user interface. The third location is within a second subregion (e.g., a second corner or second edge, different from the first corner or first edge) of the first user interface (e.g., the visual effect 7052 in FIG. 7G is within a top edge that is proximate to the upper right corner of the user interface 7050), and the second subregion of the first user interface is different from the first subregion of the first user interface (e.g., the top edge proximate to the upper right corner, or the upper right corner more generally, of the user interface where the visual effect 7052 is displayed in FIG. 7G is a different subregion than the upper left corner of the user interface wherein the visual effect 7052 is displayed in FIG. 7D). The first user interface includes a third subregion (e.g., the region 7060, the region 7062, the region 7064, and/or the region 7066 in FIG. 7G), between the first and second subregions of the first user interface (e.g., the region 7060 is between the upper left corner and the upper right corner of the user interface 7050), and the third subregion is a region in which a simulated lighting effect is not displayed (or in which the simulated lighting effect is prevented from being displayed) when the first user interface is stationary relative to the three-dimensional environment (e.g., the visual effect 7052 is never displayed within the boundaries of the region 7060 as the user interface 7050 is repositioned from the position in FIG. 7D to the position in FIG. 7G).

In some embodiments, the third subregion is a region in which no simulated lighting effect may be displayed while the first user interface is stationary relative to the three-dimensional environment. In some embodiments, the third subregion includes a plurality of regions of the first user interface in which no simulated lighting effect is displayed while the first user interface is stationary relative to the three-dimensional environment. In some embodiments, the third subregion is a region in which the simulated lighting effect is at most transiently displayed, such as while transitioning the simulated lighting effect between the first and second subregions (e.g., while animating movement of the simulated lighting effect from the first subregion to the second subregion or vice versa).

Displaying a user interface in a three-dimensional environment with a simulated lighting effect (e.g., specular reflection), and moving the simulated lighting effect in accordance with movement of the user interface relative to the three-dimensional environment, by moving the simulated lighting effect within a same region of the user interface (e.g., a same edge or corner) if the user interface is moved by less than a threshold amount, rather than to a different region of the user interface (e.g., an opposite edge or corner) past an intervening restricted region of the user interface if the user interface is moved by more than the threshold amount, and restricting display of simulated lighting effects in the restricted region while the user interface is stationary causes the computer system to automatically provide visual feedback about the spatial relationship between the user interface and the three-dimensional environment, which improves the user's context awareness of the three-dimensional environment, providing visual cues (even subtle visual cues) about a three-dimensional environment can help to and improve user physiological comfort by avoiding physiological discomfort associated with physical motion of the user that is not matched with environmental response in an a three-dimensional environment that is visible to the user. Physical motion of the user that is not matched with environmental response in a three-dimensional environment that is visible to the user (e.g., in a car, plane, boat, carnival ride, or other experience) is sometimes experienced with a physiological response sometimes referred to as motion sickness. Improving user comfort is a significant consideration when creating an MR experience because reduced comfort can cause a user to leave the MR experience and then re-enter the MR experience or enable and disable features which increases power usage and decreases battery life (for a battery powered device), in contrast when a user is physiologically comfortable they are able to quickly and efficiently interact with the device to perform the necessary operations thereby reducing power usage and increasing battery life (for a battery powered device).

In some embodiments, moving the first user interface from the first position in the three-dimensional environment to the second position in the three-dimensional environment moves the first user interface relative to a reference point in the three-dimensional environment. In some embodiments, the determination that the distance between the first position and the second position is less than the threshold distance corresponds to a determination that the first user interface is moved relative to the reference point by less than a threshold amount. In some embodiments, the determination that the distance between the first position and the second position is at least the threshold distance corresponds to a determination that the first user interface is moved relative to the reference point by at least the threshold amount. For example, in FIGS. 7E and 7F, the user interface 7050 is moved relative to the representation 7014′ of the physical object 7014 that is also displayed in the three-dimensional environment. For example, in FIGS. 7E, the virtual object 7016 is not visible, and in FIG. 7H, the user interface 7050 is moved to a position proximate to the virtual object 7016 (e.g., the user interface 7050 is moved relative to the virtual object 7016). In addition, in FIGS. 7E-7J, the user interface 7050 is moved relative to the position of a home menu user interface (e.g., of FIG. 7B) or the position of the user interface 7032 (e.g., a current position thereof or, if not currently displayed, a last-displayed position thereof), on which the positions of light sources 7042 and 7044 are based. Moving the simulated lighting effect of a user interface in accordance with movement of the user interface relative to the three-dimensional environment, and specifically relative to a reference point in the three-dimensional environment, causes the computer system to automatically provide visual feedback about the spatial relationship between the user interface and the three-dimensional environment, which improves the user's context awareness of the three-dimensional environment and improves user physiological comfort by avoiding physiological discomfort associated with physical motion of the user that is not matched with environmental response in an a three-dimensional environment that is visible to the user.

In some embodiments, the reference point corresponds to a first home menu position of a home menu user interface in the three-dimensional environment (e.g., a home menu user interface currently or recently displayed in the three-dimensional environment). In some embodiments, a home menu user interface provides a default or primary user interface for the computer system, optionally including icons for launching applications, icons for starting communication sessions (e.g., the icons corresponding to different users other than the user), icons for starting computer-generated experiences, icons for opening files or other content, container objects such as folders or groups of icons for different categories of user interface objects, a home button, a dock, a root menu, or other user interface elements for performing operations in and interacting with the three-dimensional environment. For example, as described with reference to FIGS. 7E, in some embodiments, the user interface 7050 is repositioned relative to a home user interface (e.g., of FIG. 7B), which is displayed in place of the user interface 7032 in FIG. 7E. Moving the simulated lighting effect of a user interface in accordance with movement of the user interface relative to the position of a home menu user interface of the three-dimensional environment (e.g., a current position, if displayed, or a most recent position, if not displayed) causes the computer system to automatically use a consistent point of reference in providing visual feedback about the spatial relationship between the user interface and the three-dimensional environment, which further improves the user's context awareness of the three-dimensional environment and improves user physiological comfort by avoiding physiological discomfort associated with physical motion of the user that is not matched with environmental response in an a three-dimensional environment that is visible to the user.

In some embodiments, the computer system detects one or more inputs corresponding to a request to reposition the home menu user interface at a second home menu position in the three-dimensional environment. In some embodiments, the one or more inputs include movement of a viewport of a user relative to the first home menu position (optionally that exceeds a threshold amount of movement required for repositioning the home menu user interface), followed by an input corresponding to a request to display the home menu user interface. In some embodiments, the one or more inputs include an input directed to the home menu user interface for moving the home menu user interface. In some embodiments, in response to detecting the one or more inputs, the computer system repositions the home menu user interface at the second home menu position. In some embodiments, after repositioning the home menu user interface at the second home menu position (e.g., while the home menu user interface remains associated with the second home menu position, whether or not the home menu user interface is still displayed (e.g., after the home menu user interface at the second home menu position is dismissed, and before the home menu user interface is repositioned to a different home menu position)), the computer system displays the first user interface at the second position, including displaying the first user interface with a fourth simulated lighting effect at a respective location on the first user interface that is outside of the third subregion of the first user interface. In some embodiments, after the home menu user interface is repositioned to, and displayed at, the second home menu location, the home menu user interface is dismissed, and the first user interface is redisplayed or given focus again (e.g., if the first user interface remained displayed, without focus, while the home menu user interface was being displayed at the second home menu location). For example, as described with reference to FIG. 7K, in some embodiments, the user 7002 redisplays the home user interface (e.g., at a new position of the user interface 7032 shown in FIG. 7K), and the light source 7042 and the light source 7044 are repositioned (e.g., using the home user interface as a reference, and/or at predefined positions relative to the position of the home user interface). Moving the simulated lighting effect of a user interface in accordance with changes in position of a home menu user interface of the three-dimensional environment (e.g., even without taking into account movement of the user interface itself) causes the computer system to automatically use a consistent point of reference in providing visual feedback about the spatial relationship between the user interface and the three-dimensional environment, which further improves the user's context awareness of the three-dimensional environment and improves user physiological comfort by avoiding physiological discomfort associated with physical motion of the user that is not matched with environmental response in an a three-dimensional environment that is visible to the user.

In some embodiments, while the home menu user interface is associated with the first home menu position in the three-dimensional environment (e.g., prior to detecting the one or more inputs corresponding to the request to reposition the home menu user interface at the second home menu location), the computer system displays a second user interface at a respective position in the three-dimensional environment. In some embodiments, the second user interface is different from the first user interface, and the respective position of the second user interface is different from the second position of the first user interface. In some embodiments, the second user interface is displayed with a first respective simulated lighting effect at a first respective location on the second user interface that is outside of a respective subregion of the second user interface, wherein the respective subregion of the second user interface is a region in which a simulated lighting effect is not displayed (e.g., prevented from being displayed) when the second user interface is stationary relative to the three-dimensional environment. In some embodiments, the first respective simulated lighting effect displayed for the second user interface is different from the simulated lighting effect (e.g., the second or third simulated lighting effect) displayed for the first user interface while the first user interface is at the second position in the three-dimensional environment and the home menu user interface is at the first home menu location, in accordance with the first user interface having a different relative positioning to the first home menu location than the second user interface has to the first home menu location.

In some embodiments, after repositioning the home menu user interface at the second home menu position (e.g., while the home menu user interface remains associated with the second home menu position), the computer system displays (e.g., redisplaying or giving focus again to) the second user interface at the respective position, including displaying the second user interface with a second respective simulated lighting effect at a second respective location on the second user interface that is outside of the respective subregion of the second user interface. In some embodiments, the second respective simulated lighting effect displayed for the second user interface is different from the fourth simulated lighting effect displayed for the first user interface while the first user interface is at the second position in the three-dimensional environment and the home menu user interface is at the second home menu location, in accordance with the first user interface having a different relative positioning to the second home menu location than the second user interface has to the second home menu location.

For example, in FIG. 7L, after the light source 7042 and the light source 7044 are repositioned (e.g., due to redisplaying the user interface 7032 and/or the home user interface), the user interface 7050 is repositioned (e.g., in front of the user interface 7032), and the visual effect 7046 and the visual effect 7054 are displayed in the upper left corner and the lower right corner, respectively (e.g., locations that are outside of the region 7060, the region 7062, the region 7064, and the region 7066, shown in FIGS. 7G-7J, where visual effects are not displayed), and in circumstances where one or more other user interfaces are displayed, the visual effects on the one or more other user interfaces exhibit analogous behavior to the visual effects on the user interface 7050. Moving the respective simulated lighting effects of multiple user interfaces in a three-dimensional environment in accordance with changes in position of a home menu user interface of the three-dimensional environment (e.g., even without taking into account movement of the user interfaces themselves) causes the computer system to automatically use a consistent point of reference in providing visual feedback about the spatial relationships between the three-dimensional environment and different user interfaces therein, which further improves the user's context awareness of the three-dimensional environment and improves user physiological comfort by avoiding physiological discomfort associated with physical motion of the user that is not matched with environmental response in an a three-dimensional environment that is visible to the user.

In some embodiments, displaying the first user interface with the first simulated lighting effect at the first location on the first user interface (e.g., while the first user interface is at the first user interface in the three-dimensional environment) includes: while a viewpoint of a user has a first spatial relationship to the first user interface at the first position in the three-dimensional environment, displaying a first portion (e.g., a first extent) of the first simulated lighting effect; detecting movement of the viewpoint of the user relative to the first position in the three-dimensional environment; and, in response to detecting the movement of the viewpoint of the user, while the viewpoint of the user has a second spatial relationship to the first user interface at the first position in the three-dimensional environment, wherein the second spatial relationship is different from the first spatial relationship, displaying a second portion (e.g., a second extent) of the first simulated lighting effect, wherein the second portion is different from the first portion. In some embodiments, analogously, different portions of the second simulated lighting effect are displayed when the spatial relationship between the viewpoint of the user and the first user interface at the second position changes while the first user interface is displayed at the second position in the three-dimensional environment. In some embodiments, without movement of the first user interface relative to the three-dimensional environment, the first simulated lighting effect is maintained within the first subregion of the first user interface no matter the amount of movement of the viewpoint of the user.

For example, in FIG. 7I, the viewpoint of the user 7002 is moved (e.g., the user 7002 moves to a different position), and a second portion (e.g., extending up to the boundary of the region 7062) of the visual effect 7054 is displayed (e.g., that was not previously displayed, in FIG. 7H, when the user 7002 was at the original position before the movement of the viewpoint of the user). As described with reference to FIGS. 7E, in some embodiments, even if the user 7002 moves by a large amount and/or moves to an extreme viewing angle, the movement of the user 7002 (e.g., and/or a change in viewpoint of the user 7002) cannot cause the light source 7042 and the light source 7044, or the corresponding visual effects 7052 and 7054, to “flip.” Changing how much of a simulated lighting effect of a user interface is displayed in accordance with changes in viewpoint of a user relative to the user interface, rather than moving the simulated lighting effect in accordance with movement of the user interface relative to the three-dimensional environment, causes the computer system to automatically provide visual feedback about the user's current perspective relative to the three-dimensional environment and particularly the user interface that is distinct from visual feedback provided about the spatial relationship between the user interface and the three-dimensional environment, which improves the user's context awareness of the three-dimensional environment and improves user physiological comfort by avoiding physiological discomfort associated with physical motion of the user that is not matched with environmental response in an a three-dimensional environment that is visible to the user.

In some embodiments, the first simulated lighting effect, the second simulated lighting effect, and the third simulated lighting effect of the first user interface are displayed in accordance with a first set of one or more simulated light sources in the three-dimensional environment. In some embodiments, the first, second, and/or third simulated lighting effects are displayed in accordance with one or more physical light sources in a physical environment corresponding to the three-dimensional environment. For example, as shown in FIG. 7D, the visual effect 7052 corresponds to (e.g., has an appearance that depends on a (e.g., spatial) relationship of the visual effect 7052 to) the light source 7042, and the visual effect 7054 corresponds to (e.g., has an appearance that depends on a (e.g., spatial) relationship of the visual effect 7054 to) the light source 7044. Basing different simulated lighting effects of a user interface on the same simulated light source in the three-dimensional environment causes the computer system to automatically provide consistent visual feedback about the spatial relationship between the user interface and the three-dimensional environment, which improves the user's context awareness of the three-dimensional environment and improves user physiological comfort by avoiding physiological discomfort associated with physical motion of the user that is not matched with environmental response in an a three-dimensional environment that is visible to the user.

In some embodiments, the first simulated lighting effect, the second simulated lighting effect, and the third simulated lighting effect are displayed in accordance with two or more simulated light sources in the three-dimensional environment. In some embodiments, the first simulated lighting effect, the second simulated lighting effect and the third simulated lighting effect are displayed in accordance with the same two or more simulated light sources in the three-dimensional environment or different sets of simulated light sources in the three-dimensional environment. For example, in FIG. 7D, the visual effect 7052 corresponds to (e.g., has an appearance that depends on a (e.g., spatial) relationship of the visual effect 7052 to) the light source 7042 and/or the light source 7044, and the visual effect 7054 corresponds to (e.g., has an appearance that depends on a (e.g., spatial) relationship of the visual effect 7054 to) the light source 7044 and/or the light source 7042. Basing different simulated lighting effects of a user interface on the same plurality of simulated light sources in the three-dimensional environment causes the computer system to automatically provide consistent visual feedback about the spatial relationship between the user interface and the three-dimensional environment, which improves the user's context awareness of the three-dimensional environment and improves user physiological comfort by avoiding physiological discomfort associated with physical motion of the user that is not matched with environmental response in an a three-dimensional environment that is visible to the user.

In some embodiments, the computer system displays a third user interface in the three-dimensional environment. In some embodiments, the third user interface is different from the first user interface. In some embodiments, the respective position of the third user interface is different from the first position and from the second position of the first user interface. In some embodiments, the third user interface is displayed with a respective simulated lighting effect that is displayed in accordance with a second set of one or more simulated light sources in the three-dimensional environment, wherein the second set of one or more simulated light sources is different from the first set of one or more simulated light sources. In some embodiments, the respective simulated lighting effect is displayed at a location on the third user interface that is outside of a respective subregion of the third user interface, wherein the respective subregion of the third user interface is a region in which a simulated lighting effect is not displayed (e.g., prevented from being displayed) when the third user interface is stationary relative to the three-dimensional environment. For example, as described with reference to FIG. 7D, in some embodiments, the visual effect 7052 corresponds to a first light source (e.g., other than the light source 7042 and the light source 7044) and/or a second light source (e.g., other than the first light source, the light source 7042, and the light source 7044), and the visual effect 7054 corresponds to the second light source and/or the first light source. The first light source and the second light source are analogous to the light source 7042 and the light source 7044, respectively, but are positioned are predefined positions relative to the user interface 7050 (e.g., rather than the user interface 7032, as in the case of the light source 7042 and the light source 7044). Basing the simulated lighting effects of different user interfaces on different sets of simulated light sources in the three-dimensional environment causes the computer system to automatically provide customized and more context-relevant visual feedback about the spatial relationship between a respective user interface and the three-dimensional environment, which improves the user's context awareness of the three-dimensional environment and improves user physiological comfort by avoiding physiological discomfort associated with physical motion of the user that is not matched with environmental response in an a three-dimensional environment that is visible to the user.

In some embodiments, moving the first user interface from the first position in the three-dimensional environment to the second position in the three-dimensional environment moves the first user interface by a respective amount (e.g., a respective distance). In some embodiments, displaying the first user interface with the second simulated lighting effect at the second location on the first user interface (e.g., in accordance with the determination that the distance between the first position and the second position is less than the threshold distance) includes moving a simulated lighting effect from the first location on the first user interface to the second location on the first user interface by a first amount that is less than the respective amount of movement of the first user interface. In some embodiments, displaying the first user interface with the third simulated lighting effect at the third location on the first user interface (e.g., in accordance with the determination that the distance between the first position and the second position is at least the threshold distance) includes moving a simulated lighting effect from the first location on the first user interface to the third location on the first user interface by a second amount that is greater than the respective amount of movement of the first user interface (e.g., as described with reference to FIG. 7G). Moving a simulated lighting effect of a user interface less than the corresponding amount of movement of the user interface when the simulated lighting effect is moved within a same region of the user interface (e.g., a same edge or corner) due to the user interface being moved by less than a threshold amount, and more than the corresponding amount of movement of the user interface when the simulated lighting effect is moved to a different region of the user interface (e.g., an opposite edge or corner) past an intervening restricted region of the user interface due to the user interface being moved by more than the threshold amount, causes the computer system to automatically provide visual feedback about the movement and corresponding changes in spatial relationship between the user interface and the three-dimensional environment, which improves the user's context awareness of the three-dimensional environment and improves user physiological comfort by avoiding physiological discomfort associated with physical motion of the user that is not matched with environmental response in an a three-dimensional environment that is visible to the user.

In some embodiments, the first subregion of the first user interface includes a first corner region of the first user interface (e.g., a vertex or corner, optionally with a degree of roundedness, or other form of corner region), and the second subregion of the first use interface includes a second corner region of the first user interface, wherein the second corner region is different from (e.g., separate from) the first corner region (e.g., the first corner region includes a first corner of the first user interface, and the second corner region includes a different, second corner of the first user interface that is separated from the first corner by an edge, and the third subregion includes at least a portion of the edge). For example, in FIG. 7F, the visual effect 7052 is displayed in the first subregion (e.g., the upper left corner of the user interface 7050), and the region 7060, the third subregion, includes a portion of the top edge of the user interface 7050. In FIG. 7H, the visual effect 7052 is displayed in the second subregion (e.g., the upper right corner of the user interface 7050), and the region 7060 is located between the upper left corner of the user interface 7050 and the upper right corner of the user interface 7050. In accordance with movement of a user interface relative to the three-dimensional environment, moving a simulated lighting effect of the user interface within a same corner region of the user interface if the user interface is moved by less than a threshold amount, and past an edge of the user interface to a different corner region of the user interface if the user interface is moved by more than the threshold amount, causes the computer system to automatically provide visual feedback about the spatial relationship between the user interface and the three-dimensional environment, which improves the user's context awareness of the three-dimensional environment and improves user physiological comfort by avoiding physiological discomfort associated with physical motion of the user that is not matched with environmental response in an a three-dimensional environment that is visible to the user.

In some embodiments, moving the first user interface in response to detecting the event includes: prior to displaying the first user interface at the second position in the three-dimensional environment and with the second simulated lighting effect, displaying the first user interface moving through a plurality of intermediate positions (e.g., between the first position and the second position) in the three-dimensional environment; and, while displaying the first user interface moving through the plurality of intermediate positions in the three-dimensional environment, visually deemphasizing the first simulated lighting effect relative to the first user interface (e.g., ceasing to display the first simulated lighting effect, or displaying the first simulated lighting effect with reduced brightness, sharpness, opacity, size, and/or other visual property of the simulated lighting effect). For example, as described with reference to FIGS. 7E, in some embodiments, while the user interface 7050 is being repositioned, the visual effect 7052 and the visual effect 7054 are displayed with a different appearance (e.g., a different appearance such as a dimmer appearance, a lighter appearance, and/or a blurrier appearance, which visually deemphasizes the visual effect 7052 and the visual effect 7054). ISE the first user interface is visually deemphasized while being moved (e.g., while displayed as moving through the plurality of intermediate positions). Visually deemphasizing (e.g., fading) a simulated lighting effect of a user interface while moving the user interface relative to the three-dimensional environment causes the computer system to automatically give focus to the moving of the user interface, which improves the user's context awareness of what is occurring in the three-dimensional environment and improves user physiological comfort by avoiding physiological discomfort associated with physical motion of the user that is not matched with environmental response in an a three-dimensional environment that is visible to the user.

In some embodiments, while displaying the first user interface moving through the plurality of intermediate positions in the three-dimensional environment: the first simulated lighting effect is visually deemphasized by a first amount relative to the first simulated lighting effect prior to detecting the event; the first user interface is visually deemphasized by a second amount relative to the first user interface prior to detecting the event; and the first amount is more than the second amount. In some embodiments, the first simulated lighting effect is visually deemphasized entirely, in that the first simulated lighting effect is not displayed while the first user interface is displayed moving through the plurality of intermediate positions in the three-dimensional environment. For example, as described with reference to FIGS. 7E, in some embodiments, the user interface 7050 is dimmed, lightened, and/or blurred while the user interface 7050 is being repositioned, and the visual effect 7052 and the visual effect 7054 are dimmed, lightened, and/or blurred by a greater amount than the user interface 7050, while the user interface 7050 is being repositioned. In some embodiments, movement of a respective simulated lighting effect is not displayed (e.g., even if the respective simulated lighting effect is displayed on the first user interface) while the first user interface is being moved through at least some of the plurality of intermediate positions. Where a user interface is visually deemphasized while being moved in the three-dimensional environment, visually deemphasizing (e.g., fading) a simulated lighting effect of the user interface even more than the user interface itself is visually deemphasized causes the computer system to automatically give focus to the moving of the user interface, which improves the user's context awareness of what is occurring in the three-dimensional environment and improves user physiological comfort by avoiding physiological discomfort associated with physical motion of the user that is not matched with environmental response in an a three-dimensional environment that is visible to the user.

In some embodiments, detecting the event corresponding to the movement of the first user interface includes detecting an input directed to a move affordance for the first user interface (e.g., and movement of the input relative to the three-dimensional environment). In some embodiments, while detecting the input directed to the move affordance for the first user interface, the computer system visually deemphasizes the first user interface relative to the three-dimensional environment (e.g., visually deemphasizing the first simulated lighting effect relative to the first user interface while displaying the first user interface moving through the plurality of intermediate positions in the three-dimensional environment results in the first simulated lighting effect being visually deemphasized relative to the visually deemphasized first user interface). For example, as described with reference to FIGS. 7E, in some embodiments, the user interface 7050 is displayed with the different appearance (e.g., that visually deemphasizes the user interface 7050) in response to detecting a user input (e.g., a direct air gesture such as an air tap or air pinch at a location with which the user is interacting, an indirect air gesture such as an air pinch while attention of the user or gaze of the user is directed toward at a location with which the user is interacting, a tap input, a gaze input, a drag input, and/or another type of user input) directed to a move affordance (e.g., a grabber or other move and/or resize affordance) for the user interface 7050 (e.g., even if the user interface 7050 has not yet been repositioned). In some embodiments, in response to detecting the input directed to the move affordance for the first user interface, the computer system visually deemphasizes the first simulated lighting effect (e.g., relative to the three-dimensional environment and/or relative to the first user interface) (e.g., with or without the computer system visually deemphasizing the first user interface). In some embodiments, the first simulated lighting effect continues to be visually deemphasized while the input directed to the move affordance for the first user interface continues to be detected. Visually deemphasizing a user interface and/or visually deemphasizing a simulated lighting effect of the user interface starting from when an input directed to a move affordance for the user interface is detected causes the computer system to automatically provide visual feedback about what operation has been initiated and to give focus to the moving of the user interface, which improves the user's context awareness of what is occurring in the three-dimensional environment and improves user physiological comfort by avoiding physiological discomfort associated with physical motion of the user that is not matched with environmental response in an a three-dimensional environment that is visible to the user.

In some embodiments, the first simulated lighting effect, the second simulated lighting effect, and the third simulated lighting effect correspond to (e.g., are instances of) a respective type of lighting effect on the first user interface. In some embodiments, the computer system detects movement of a viewpoint of a user relative to the first user interface; and, in response to detecting the movement of the viewpoint of the user relative to the first user interface: while (e.g., in accordance with a determination that) the viewpoint of the user is at an angle relative to the first user interface that is within a threshold range of angles to the first user interface, the computer system displays the first user interface with a respective simulated lighting effect that is the respective type of simulated lighting effect; and, while (e.g., in accordance with a determination that) the viewpoint of the user is at an angle relative to the first user interface that is outside of the threshold range of angles, the computer system displays the first user interface without the respective type of simulated lighting effect. In some embodiments, the respective type of lighting effect on the first user interface (e.g., the first simulated lighting effect, the second simulated lighting effect, and the third simulated lighting effect) is displayed while the viewpoint of a user is at an angle relative to the first user interface that is within the threshold range of angles, and not displayed while the viewpoint of the user is at an angle relative to the first user interface that is outside of the threshold range of angles.

For example, as described with reference to FIG. 7I, in some embodiments, if the user 7002 moves such that the user interface 7050 is displayed at an extreme viewing angle (e.g., the user is looking almost directly at the left edge of the user interface 7050, which includes the visual effect 7054 and the region 7062, and can see very little of the “front” surface of the user interface 7050 that includes the text-entry field 7056, the button 7009 and the button 7011), the computer system 101 ceases to display the visual effect 7052 and the visual effect 7054 (e.g., and optionally, also the visual effect 7058) (e.g., to prevent any visual artifacts from displaying visual effects at an extreme viewing angle). In some embodiments, the respective type of lighting effect is visually deemphasized while the viewpoint of the user is at an angle relative to the first user interface that is outside of the threshold range of angles. In some embodiments, the first user interface is visually deemphasized (e.g., more or less so than the first simulated lighting effect), or ceases to be displayed, while the viewpoint of the user is at an angle relative to the first user interface that is outside of the threshold range of angles. Visually deemphasizing (e.g., fading) or ceasing to display a simulated lighting effect of a user interface and optionally visually deemphasizing or ceasing to display the user interface itself when the user interface is viewed from a viewpoint that is at too great an angle (e.g., of incidence) or outside of a threshold range of angles causes the computer system to automatically visually deemphasize elements in the three-dimensional environment having poor visibility from the user's current perspective and to provide visual feedback about the spatial relationship between the viewpoint of the user and the user interface, which improves the user's context awareness of the three-dimensional environment and improves user physiological comfort by avoiding physiological discomfort associated with physical motion of the user that is not matched with environmental response in an a three-dimensional environment that is visible to the user.

In some embodiments, the first user interface includes a first user interface element (e.g., a main window or platter) and a second user interface element within a region of the first user interface element (e.g., an affordance or control for the main window). In some embodiments, moving the first user interface in response to detecting the event includes: changing a simulated lighting effect corresponding to the first user interface element in a first manner (e.g., moving the simulated lighting effect between subregions of the first user interface element separated by one or more regions in which simulated lighting effects are not displayed when the first user interface element (or more generally, the first user interface) is stationary relative to the three-dimensional environment, as described in more detail herein with reference to method 900, and/or moving the simulated lighting effect by an amount corresponding to multiple types of movement such as movement of the first user interface element relative to the three-dimensional environment and movement of the viewpoint of the user relative to the first user interface, and/or movement in multiple directions such as laterally and vertically, as described in more detail herein with reference to method 1000). In some embodiments, moving the first user interface in response to detecting the event includes: changing a simulated lighting effect corresponding to the second user interface element in a second manner that is different from the first manner (e.g., moving the simulated lighting effect without restriction by one or more regions in which simulated lighting effects are not displayed when the second user interface element (or more generally, the first user interface) is stationary relative to the three-dimensional environment, in contrast to other features described with reference to method 900, moving the simulated lighting effect by an amount corresponding to some types of movement such as movement of the first user interface relative to the three-dimensional environment without regard to other types of movement such as movement of the viewpoint of the user relative to the first user interface, and/or moving the simulated lighting effect more based on movement in a first direction (e.g., laterally) than on movement in a second direction (e.g., vertically), as described in more detail herein with reference to method 1000).

For example, in FIGS. 7D-7E, the visual effect 7052 (e.g., a visual effect corresponding to a border or edge region of the user interface 7050) moves in a rightward direction (e.g., along the top edge of the user interface 7050, towards the upper right corner of the user interface 7050), and the visual effect 7058 (e.g., a visual effect corresponding to the text-entry field 7056 of the user interface 7050) moves in a leftward direction (e.g., along a bottom edge of the text-entry field 7056, towards a lower left corner of the text-entry field 7056). In FIGS. 7F-7G, the visual effect 7052 “flips” to the opposite side of the region 7060, but the visual effect 7058 continues to move in the leftward direction (e.g., does not “flip”). Where distinct simulated lighting effects are displayed for different portions of a user interface (e.g., a perimeter region of the user interface versus an affordance region within the user interface), changing or moving the distinct simulated lighting effects differently for the different portions of the user interface causes the computer system to automatically provide visual feedback distinguishing different elements having different properties and functions in the three-dimensional environment while providing visual feedback about the spatial relationships between the elements and the three-dimensional environment, which improves the user's context awareness of the three-dimensional environment and improves user physiological comfort by avoiding physiological discomfort associated with physical motion of the user that is not matched with environmental response in an a three-dimensional environment that is visible to the user.

In some embodiments, while displaying the first view of the three-dimensional environment, the first view of the three-dimensional environment including the first user interface at the first position in the three-dimensional environment, displaying the first user interface with a first simulated shadow at a first shadow location corresponding to the first user interface, wherein the first shadow location corresponds to a fourth subregion (e.g., a corner or edge) of the first user interface. In some embodiments, the first shadow location is within the fourth subregion of the first user interface (e.g., if the first simulated shadow is a shadow cast by another object onto the first user interface) or is in the three-dimensional environment adjacent to or within a threshold distance of the fourth subregion of the first user interface (e.g., if the first simulated shadow is a shadow cast by the first user interface into the three-dimensional environment). In some embodiments, moving the first user interface from the first position in the three-dimensional environment to the second position in the three-dimensional environment in response to detecting the event includes: in accordance with the determination that the distance between the first position and the second position is less than the threshold distance, displaying the first user interface with a second simulated shadow at a second shadow location corresponding to the first user interface, wherein the second shadow location is different from the first shadow location and wherein the second shadow location corresponds to (e.g., is within) the fourth subregion of the first user interface (e.g., the simulated shadow is adjusted slightly along the corner or edge of the first user interface); and, in accordance with the determination that the distance between the first position and the second position is at least the threshold distance, displaying the first user interface with a third simulated shadow at a third shadow location corresponding to the first user interface. In some embodiments, the third shadow location corresponding to the first user interface is different from the first shadow location and the second shadow location. In some embodiments, the third location is within a fifth subregion (e.g., a different corner or different edge than that of the first shadow location) of the first user interface, and the fifth subregion of the first user interface is different from the fourth subregion of the first user interface. In some embodiments, the first user interface includes a sixth subregion, between the fourth and fifth subregions of the first user interface, wherein the sixth subregion is a region in which a simulated shadow is not displayed (or in which the simulated shadow is prevented from being displayed) when the first user interface is stationary relative to the three-dimensional environment. In some embodiments, the fourth and fifth subregions of the first user interface have analogous properties to the first and second subregions, and the sixth subregion of the first user interface has analogous properties to the third subregion.

For example, as described with reference to FIG. 7D, in some embodiments, the visual effect 7046 and the visual effect 7054 are shadow effects applied to the user interface 7050. In FIGS. 7E and 7F, the user interface 7050 is moved to a position that is less than the threshold distance from the previous position, and the shadow effects of the visual effect 7052 and the visual effect 7054 are moved, but within the same subregion (e.g., the upper left corner and the lower right corner, respectively). In FIG. 7G, the user interface 7050 is moved to a position that is (e.g., or is more than) the threshold distance from the original position of the user interface 7050 (e.g., the position of the user interface 7050 in FIG. 7D), and the shadow effects of the visual effect 7052 and the visual effect 7054 “flip” to the upper right corner and the lower left corner, respectively. In some embodiments, while simulated lighting effects are optionally displayed at one or more locations on the first user interface, simulated shadows are displayed at one or more locations corresponding to, but not necessarily on, the first user interface (e.g., in regions of the three-dimensional environment outside of the first user interface, into which the first user interface appears to cast shadows). For a user interface having a simulated lighting effect, also displaying a simulated shadow for the user interface and moving the simulated shadow analogously to how the simulated lighting effect is moved in accordance with movement of the user interface relative to the three-dimensional environment, including moving the simulated shadow within a same region corresponding to the user interface (e.g., near a same edge or corner) if the user interface is moved by less than a threshold amount, rather than to a different region corresponding to the user interface (e.g., near an opposite edge or corner) past an intervening restricted region corresponding to the user interface if the user interface is moved by more than the threshold amount, and restricting display of simulated shadows in the restricted region while the user interface is stationary causes the computer system to automatically provide visual feedback about the spatial relationship between the user interface and the three-dimensional environment, which improves the user's context awareness of the three-dimensional environment and improves user physiological comfort by avoiding physiological discomfort associated with physical motion of the user that is not matched with environmental response in an a three-dimensional environment that is visible to the user.

In some embodiments, moving the first user interface in response to detecting the event includes: prior to displaying the first user interface at the second position in the three-dimensional environment (e.g., with the second simulated shadow and the second simulated lighting effect, or with the third simulated shadow and the third simulated lighting effect), displaying the first user interface moving through a plurality of intermediate positions (e.g., between the first position and the second position) in the three-dimensional environment; and, while displaying the first user interface moving through the plurality of intermediate positions in the three-dimensional environment, continuing to display a simulated shadow (e.g., the first simulated shadow, the second simulated shadow, the third simulated shadow, or one or more intermediate simulated shadows) corresponding to the first user interface (e.g., in contrast to visually deemphasizing or altogether ceasing to display a simulated lighting effect). In some embodiments, continuing to display a simulated shadow includes maintaining display of the first simulated shadow, optionally at the first shadow location. For example, as described with reference to FIGS. 7E, in some embodiments, the visual effect 7052 and the visual effect 7054 are shadow effects, and the shadow effects of the visual effect 7052 and the visual effect 7054 remain displayed while the user interface 7050 is being repositioned (e.g., even if the user interface 7050 is displayed with a reduced visual prominence while the user interface 7050 is being repositioned). Continuing to display a simulated shadow of a user interface while moving the user interface relative to the three-dimensional environment causes the computer system to automatically provide visual feedback about the spatial relationship between the user interface and the three-dimensional environment, which improves the user's context awareness of what is occurring in the three-dimensional environment and improves user physiological comfort by avoiding physiological discomfort associated with physical motion of the user that is not matched with environmental response in an a three-dimensional environment that is visible to the user.

In some embodiments, moving the first user interface in response to detecting the event includes: prior to displaying the first user interface at the second position in the three-dimensional environment and with the second simulated shadow (and with the second simulated lighting effect), displaying the first user interface moving through a plurality of intermediate positions (e.g., between the first position and the second position) in the three-dimensional environment; and, while displaying the first user interface moving through the plurality of intermediate positions in the three-dimensional environment, visually deemphasizing the first simulated shadow relative to the first user interface (e.g., ceasing to display the first simulated shadow, or displaying the first simulated shadow with reduced brightness, sharpness, opacity, size, and/or other visual property). For example, as described with reference to FIGS. 7E, where the visual effect 7052 and the visual effect 7054 are shadow effects, the visual effect 7052 and the visual effect 7054 are displayed with reduced visual prominence as the user interface 7050 is being repositioned. Visually deemphasizing a simulated shadow of a user interface while moving the user interface relative to the three-dimensional environment causes the computer system to automatically give focus to the moving of the user interface, which improves the user's context awareness of what is occurring in the three-dimensional environment and improves user physiological comfort by avoiding physiological discomfort associated with physical motion of the user that is not matched with environmental response in an a three-dimensional environment that is visible to the user.

In some embodiments, displaying the first user interface with the first simulated shadow at the first shadow location corresponding to the first user interface includes maintaining display of the first simulated shadow at the first shadow location as a viewpoint of a user moves relative to the first user interface while the first user interface is displayed at the first position in the three-dimensional environment (e.g., while a spatial relationship between the viewpoint of the user and the first user interface changes without the first user interface being moved relative to the three-dimensional environment). For example, as described with reference to FIG. 7I, in some embodiments, for certain types of visual effects (e.g., shadow effects), the visual effect 7052 and the visual effect 7054 are not updated to reflect changes in viewpoint of the user 7002. The visual effect 7052 and the visual effect 7054 in FIG. 7I would instead be displayed at the same locations on the user interface 7050 as in FIG. 7H. Maintaining a simulated shadow corresponding to a user interface at the same place even as a viewpoint of the user moves relative to the user interface (e.g., while the user interface stays at the same place in the three-dimensional environment) causes the computer system to automatically provide visual feedback about the spatial relationship between the user interface and the three-dimensional environment notwithstanding the user's current perspective relative to the three-dimensional environment, which improves the user's context awareness of the three-dimensional environment and improves user physiological comfort by avoiding physiological discomfort associated with physical motion of the user that is not matched with environmental response in an a three-dimensional environment that is visible to the user.

In some embodiments, a respective simulated shadow (e.g., the first simulated shadow, the second simulated shadow, the third simulated shadow, or other simulated shadow described herein) at a respective shadow location simulates occlusion of one or more light sources (e.g., real and/or virtual light sources) in the three-dimensional environment by a respective object at a respective object location (or a plurality of objects at respective object locations), and displaying the respective simulated shadow at the respective shadow location includes displaying the respective simulated shadow transitioning through a plurality of intermediate appearances corresponding to the respective object occluding the one or more light sources while moving into place at the respective object location (or a plurality of objects moving into place at their respective object locations) (e.g., by displaying a series of changes in one or more visual properties, such as increases in blur radius and/or transparency, of the respective simulated shadow consistent with the movement into place of the respective object (or plurality of objects)). For example, as described with reference to FIGS. 7E, in some embodiments, the computer system 101 displays the visual effect 7052 and/or the visual effect 7054 transitioning through a plurality of intermediate appearances corresponding to occlusion (e.g., by one or more user interface objects) of the light source 7042 and/or the light source 7044, as the user interface 7050 is repositioned. When initially displaying a simulated shadow that appears as if cast by an element in the three-dimensional environment, displaying an animated transition of the simulated shadow appearing as if gradually being cast as the element moves into place causes the computer system to automatically provide a smoother visual transition when newly displaying features in the three-dimensional environment, which improves the user's context awareness of the three-dimensional environment and improves user physiological comfort by avoiding physiological discomfort associated with physical motion of the user that is not matched with environmental response in an a three-dimensional environment that is visible to the user.

In some embodiments, the first user interface includes a first user interface element and a second user interface element; and displaying the first user interface with a respective simulated lighting effect (e.g., any of the first simulated lighting effect, the second simulated lighting effect, and the third simulated lighting effect) includes displaying the first user interface element with a first portion of the respective simulated lighting effect and displaying the second user interface element with a second portion of the respective simulated lighting effect (e.g., respective portions of a respective simulated lighting effect being generated based on a same set of one or more real and/or virtual light sources). For example, as described with reference to FIG. 7D, in some embodiments, visual effects (e.g., shadow effects) are applied to the button 7009 and the button 7011 in FIG. 7D. The visual effects applied to the button 7009 and the button 7011 have analogous behavior to the visual effect 7052 and the visual effect 7054 (e.g., as described with reference to FIGS. 7D-7L). When displaying a simulated lighting effect of a user interface, displaying distinct portions of the same simulated lighting effect for different elements of the user interface (e.g., based on the same one or more simulated light sources in the three-dimensional environment) causes the computer system to automatically provide consistent visual feedback about the spatial relationship between the user interface (as a whole, as well as elements of the user interface) and the three-dimensional environment, which improves the user's context awareness of the three-dimensional environment and improves user physiological comfort by avoiding physiological discomfort associated with physical motion of the user that is not matched with environmental response in an a three-dimensional environment that is visible to the user.

In some embodiments, moving the first user interface in response to detecting the event includes: displaying the first user interface moving into place at the second position in the three-dimensional environment (e.g., settling into the second position after the first user interface has been moved from the first position, optionally to within a threshold distance of the second position). In some embodiments, the first user interface is displayed moving into place at the second position in the three-dimensional environment after an end of the event (e.g., a user input) corresponding to the movement of the first user interface has been detected. In some embodiments, moving the first user interface in response to detecting the event includes: in accordance with the determination that the distance between the first position and the second position is less than the threshold distance: displaying an animation of the second simulated lighting effect moving (e.g., within the first subregion of the first user interface) into place at the second location on the first user interface (e.g., an animated transition that transforms the first simulated lighting effect at the first location on the first user interface into the second simulated lighting effect at the second location on the first user interface). In some embodiments, the animation of the second simulated lighting effect moving into place at the second location on the first user interface is displayed concurrently with displaying the first user interface moving into place at the second position in the three-dimensional environment. In some embodiments, moving the first user interface in response to detecting the event includes: in accordance with the determination that the distance between the first position and the second position is at least the threshold distance: displaying an animation of the third simulated lighting effect moving into place at the third location on the first user interface (e.g., an animated transition that transforms the first simulated lighting effect at the first location on the first user interface into the third simulated lighting effect at the third location on the first user interface), including displaying an animation of a simulated lighting effect moving through the third subregion of the first user interface while the first user interface is moving into place at the second position in the three-dimensional environment (e.g., movement of the simulated lighting effect through the third subregion occurs prior to the first user interface reaching the second position). In some embodiments, the animation of the third simulated lighting effect moving into place at the third location on the first user interface is displayed concurrently with displaying the first user interface moving into place at the second position in the three-dimensional environment.

For example, as described with reference to FIGS. 7E, in some embodiments, the computer system 101 displays an animated transition of the visual effect 7052 and/or the visual effect 7054 sliding into place (e.g., an animated transition of the visual effect 7052 and/or the visual effect 7054 sliding and/or expanding from the location in FIG. 7D, to the location in FIG. 7E). In some embodiments, in response to detecting an end of an input repositioning user interface 7050 from its position shown in FIG. 7D to its position shown in FIG. 7G (e.g., where magnitude and/or direction of movement of the user interface 7050 was based on magnitude and/or direction of movement of the input), the computer system 101 displays an animated transition of the visual effect 7052 and/or the visual effect 7054 moving from their positions shown in FIG. 7D (e.g., the visual effects having not moved during the input repositioning user interface 7050) to their positions shown in FIG. 7G. When moving the simulated lighting effect of a user interface in accordance with movement of the user interface to a new position in the three-dimensional environment, displaying an animated transition of the simulated lighting effect moving along the user interface after an event or input corresponding to (e.g., requesting) the movement of the user interface ends (e.g., (e.g., and while the user interface is still settling into place at the new position in the three-dimensional environment, but not during earlier movement of the user interface while the event or input was still being detected) causes the computer system to automatically reduce the computational burden of rendering the simulated lighting effect (e.g., when additional computational resources may be needed for the moving of the user interface) and to provide a smoother visual transition afterwards, which improves the user's context awareness of the three-dimensional environment and improves user physiological comfort by avoiding physiological discomfort associated with physical motion of the user that is not matched with environmental response in an a three-dimensional environment that is visible to the user.

In some embodiments, aspects/operations of methods 1000 and 1100 may be interchanged, substituted, and/or added between these methods. For example, the user interfaces, affordances, user interface elements, and controls of method 900 optionally have simulated lighting effects and/or simulated shadows that exhibit one or more behaviors described with reference to methods 1000 and 1100. For brevity, these details are not repeated here.

FIG. 10 is a flow diagram of an exemplary method 1000 for repositioning a shadow corresponding to a user interface as the user interface is reoriented, in accordance with some embodiments. In some embodiments, method 1000 is performed at a computer system (e.g., computer system 101 in FIG. 1A) that is in communication with a display generation component (e.g., display generation component 120 in FIGS. 1, 3, and 4 or display generation component 7100 in FIG. 7A) (e.g., a heads-up display, a display, a touchscreen, a projector, or other display device) and one or more sensors (e.g., one or more cameras (e.g., color sensors, infrared sensors, and/or other depth-sensing cameras), touch-sensitive surfaces, motion sensors, and/or orientation sensors). In some embodiments, the method 1000 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 1000 are, optionally, combined and/or the order of some operations is, optionally, changed.

The computer system displays (1002), via the display generation component, a first user interface (e.g., the user interface 7050 in FIG. 7F) in a first view of a three-dimensional environment. The first user interface has a simulated three-dimensional effect (e.g., a simulated lighting effect and/or a simulated shadow effect) (e.g., the visual effect 7058 corresponding to the text-entry field 7056 of the user interface 7050, in FIG. 7F) while the first view of the three-dimensional environment is visible, and the first user interface has a first spatial relationship to a viewpoint of a user.

The computer system detects (1004) an input corresponding to a request to change the viewpoint of the user to have a second spatial relationship to the first user interface (e.g., based on physical movement about a physical space of the user, for a head mounted device, this could include as a user walking to the right or left or shifting their head up, down, to the right, or to the left, or tilting their head up or down or to the right or to the left; for a handheld device this could include moving or tilting the device in the physical space; and for either type of device, this could include requesting virtual movement such as a request to shift or tilt a viewpoint relative to the first user interface). In some embodiments, the second spatial relationship is different from the first spatial relationship (e.g., the user 7002 rotates the viewpoint away from the representation 7014′ of the physical object 7014 in FIG. 7F, to a new viewpoint that faces the representation 7006′ of the physical wall 7006 in FIG. 7G), and a first portion of the input (e.g., the rotation of the user 7002 in FIGS. 7F-7G) corresponds to a respective amount of change in the viewpoint and a second portion that follows the first portion (e.g., the rotation of the user 7002 in FIGS. 7G-7H) corresponds to the respective amount of change in the viewpoint.

In response to detecting the first portion of the input (e.g., a rotation of the direction that the user 7002 is facing from a first direction in FIG. 7F to a second direction in FIG. 7G) (1006): the computer system displays (1008) a second view of the three-dimensional environment different from the first view of the three-dimensional environment (e.g., the view displayed in FIG. 7G is different from the view displayed in FIG. 7F); and the computer system changes (1010) the simulated three-dimensional effect by a first amount (e.g., in FIG. 7G, the visual effect 7052 expands by a first amount).

In response to detecting the second portion of the input (e.g., a continued rotation of the direction that the user 7002 is facing from the second direction in FIG. 7G to a third direction in FIG. 7H) (1012): the computer system displays (1014) a third view of the three-dimensional environment that is different from the first view of the three-dimensional environment and from the second view of the three-dimensional environment (e.g., the view displayed in FIG. 7H is different from the view displayed in both FIG. 7G and FIG. 7F); and the computer system changes (1016) the simulated three-dimensional effect by a second amount. The second amount is different from the first amount (e.g., as shown in FIG. 7H and described below above in greater detail, the visual effect 7058 expands by a second amount that is different from the first amount shown in FIG. 7G).

In some embodiments, the first portion of the change in viewpoint and the second portion of the change in viewpoint include the same amount and same type of (e.g., translational and/or rotational change) change in viewpoint. In some embodiments, the simulated three-dimensional effect is changed at a faster rate during the first portion of the input as compared to the second portion of the input. For example, the simulated three-dimensional effect is changed by the first amount, and at a rate that has a first relationship to a rate of change of the first portion of the change in viewpoint; and the simulated three-dimensional effect is changed by the second amount, and at a rate that has a second relationship to a rate of change of the second portion of the change in viewpoint, wherein the second relationship is different from the first relationship.

Displaying a user interface in a three-dimensional environment with a simulated three-dimensional effect (e.g., with a simulated lighting effect, such as specular reflection, and/or a simulated shadow), and changing the simulated three-dimensional effect in accordance with movement of a viewpoint of a user relative to the user interface, by changing (e.g., moving) the simulated three-dimensional effect by different amounts (e.g., progressively less or more) as the movement of the viewpoint relative to the user interface progresses causes the computer system to automatically provide visual feedback about the spatial relationship between the user interface and the three-dimensional environment and, in the case of moving the simulated three-dimensional effect progressively less as the movement of the viewpoint progresses, reduces motion and parallax in the three-dimensional environment, which improves the user's context awareness of the three-dimensional environment and improves user physiological comfort by avoiding physiological discomfort associated with physical motion of the user that is not matched with environmental response in an a three-dimensional environment that is visible to the user.

In some embodiments, the respective amount of change in the viewpoint includes a respective amount of movement in a first direction (e.g., a lateral direction such as left or right) and the respective amount of movement in a second direction (e.g., a vertical direction such as up or down) that is perpendicular to the first direction. In some embodiments, changing the simulated three-dimensional effect by a respective amount (e.g., the first amount or the second amount) includes changing the simulated three-dimensional effect in the first direction (e.g., in accordance with the respective amount of movement of the viewpoint in the first direction) by an amount that is greater than an amount of change in the simulated three-dimensional effect in the second direction (e.g., in accordance with the respective amount of movement of the viewpoint in the second direction). In some embodiments, for the same amount of movement of the viewpoint in a lateral direction and in a vertical direction, the amount of change in the simulated three-dimensional effect is greater in the lateral direction than in the vertical direction. For example, in FIG. 7G, the visual effect 7058 expands in a horizontal direction (e.g., leftward, along the bottom edge of the text-entry field 7056), and the visual effect 7058 does not change in a vertical direction. Changing a simulated three-dimensional effect of a user interface in accordance with movement of a viewpoint of a user relative to the user interface more for movement of the viewpoint in one direction than for movement of the viewpoint in a different direction causes the computer system to automatically provide visual feedback about the spatial relationship between the user interface and the three-dimensional environment while reducing motion and parallax in the three-dimensional environment, which improves the user's context awareness of the three-dimensional environment and improves user physiological comfort by avoiding physiological discomfort associated with physical motion of the user that is not matched with environmental response in an a three-dimensional environment that is visible to the user.

In some embodiments, the amount of change in the simulated three-dimensional effect in the second direction is zero. For example, in FIG. 7G, the visual effect 7058 expands in a horizontal direction (e.g., leftward, along the bottom edge of the text-entry field 7056), and the visual effect 7058 does not change in a vertical direction. Changing a simulated three-dimensional effect of a user interface in accordance with movement of a viewpoint of a user relative to the user interface in one direction, ignoring movement of the viewpoint in a different direction, causes the computer system to automatically provide visual feedback about the spatial relationship between the user interface and the three-dimensional environment while reducing motion and parallax in the three-dimensional environment, which improves the user's context awareness of the three-dimensional environment and improves user physiological comfort by avoiding physiological discomfort associated with physical motion of the user that is not matched with environmental response in an a three-dimensional environment that is visible to the user.

In some embodiments, displaying the simulated three-dimensional effect of the first user interface includes displaying a simulated shadow associated with the first user interface. In some embodiments, changing the simulated three-dimensional effect includes changing position, size, opacity, amount of blurring, brightness, and/or other visual property of the simulated shadow. For example, as described with reference to FIG. 7D, in some embodiments, the visual effect 7058 (e.g., that is applied to the text-entry field 7056) is or includes a shadow effect. Displaying a user interface in a three-dimensional environment with a simulated three-dimensional effect that includes a simulated shadow, and changing the simulated three-dimensional effect in accordance with movement of a viewpoint of a user relative to the user interface causes the computer system to automatically provide visual feedback about the spatial relationship between the user interface and the three-dimensional environment, which improves the user's context awareness of the three-dimensional environment and improves user physiological comfort by avoiding physiological discomfort associated with physical motion of the user that is not matched with environmental response in an a three-dimensional environment that is visible to the user.

In some embodiments, displaying the simulated three-dimensional effect of the first user interface includes displaying a simulated lighting effect (e.g., specular highlight) associated with the first user interface. In some embodiments, changing the simulated three-dimensional effect includes changing position, orientation, size, brightness, and/or other visual property of the simulated lighting effect. In some embodiments, the simulated lighting effect is a simulated lighting effect having features and/or behavior as described herein with reference to method 900. For example, as described with reference to FIG. 7D, in some embodiments, the visual effect 7058 (e.g., that is applied to the text-entry field 7056) is or includes a reflection and/or glow effect. Displaying a user interface in a three-dimensional environment with a simulated three-dimensional effect that includes a simulated lighting effect (e.g., specular reflection), and changing the simulated three-dimensional effect in accordance with movement of a viewpoint of a user relative to the user interface causes the computer system to automatically provide visual feedback about the spatial relationship between the user interface and the three-dimensional environment, which improves the user's context awareness of the three-dimensional environment and improves user physiological comfort by avoiding physiological discomfort associated with physical motion of the user that is not matched with environmental response in an a three-dimensional environment that is visible to the user.

In some embodiments, displaying the simulated three-dimensional effect of the first user interface includes displaying a first simulated visual effect (e.g., a simulated shadow effect) and displaying a second simulated visual effect (e.g., a simulated lighting effect such as specular reflection). In some embodiments, changing the simulated three-dimensional effect by the first amount (e.g., in response to detecting the first portion of the input) includes changing the first simulated visual effect based on a first amount of progression along a respective animation curve and changing the second simulated visual effect based on the first amount of progression along the respective animation curve. In some embodiments, changing the simulated three-dimensional effect by the second amount (e.g., in response to detecting the second portion of the input) includes changing the first simulated visual effect based on a second amount of progression along the respective animation curve and changing the second simulated visual effect based on the second amount of progression along the respective animation curve. In some embodiments, the first and second simulated visual effects are changed by corresponding amounts in response to a same respective portion of the input, in accordance with progression along the same respective animation curve. In some embodiments, the first simulated visual effect is a simulated lighting effect having features and/or behavior as described herein with reference to method 900. In some embodiments, the second simulated visual effect is a simulated shadow having features and/or behavior as described herein with reference to method 1100.

For example, as described with reference to FIG. 7L, in some embodiments, the visual effect 7058 includes a plurality of visual effect types (e.g., a reflection effect in combination with a shadow effect). The reflection effect and the shadow effect are changed and/or updated by the same first amount along the animation curve, in response to a first amount of movement of the user interface 7050 (e.g., a first portion of movement of the user interface 7050) and/or of the viewpoint of the user 7002, and the reflection effect and the shadow effect are changed and/or updated by the same second amount (e.g., that is optionally different from the first amount) along the animation curve, in response to a second amount of movement of the user interface 7050 (e.g., a second portion of movement of the user interface 7050, that follows the first portion of movement) and/or of the viewpoint of the user 7002. Displaying a user interface in a three-dimensional environment with a simulated three-dimensional effect that includes both a simulated lighting effect (e.g., specular reflection) and a simulated shadow, and changing both the simulated lighting effect and the simulated shadow in accordance with movement of a viewpoint of a user relative to the user interface using a same animation curve causes the computer system to automatically provide enhanced visual feedback about the spatial relationship between the user interface and the three-dimensional environment, which improves the user's context awareness of the three-dimensional environment and improves user physiological comfort by avoiding physiological discomfort associated with physical motion of the user that is not matched with environmental response in an a three-dimensional environment that is visible to the user.

In some embodiments, the first user interface includes a first activatable control, and the simulated three-dimensional effect is a first simulated three-dimensional effect that corresponds to the first activatable control. For example, as described with reference to FIG. 7D, in some embodiments, a visual effect is applied to the button 7009 and/or the button 7011 (e.g., activatable controls). Displaying an activatable control in a user interface in a three-dimensional environment with a simulated three-dimensional effect (e.g., with a simulated lighting effect and/or a simulated shadow), and changing the simulated three-dimensional effect for the activatable control in accordance with movement of a viewpoint of a user relative to the encompassing user interface causes the computer system to automatically provide visual feedback about the spatial relationship between the user interface and the three-dimensional environment, which improves the user's context awareness of the three-dimensional environment and improves user physiological comfort by avoiding physiological discomfort associated with physical motion of the user that is not matched with environmental response in an a three-dimensional environment that is visible to the user.

In some embodiments, the first user interface includes a second activatable control that is displayed with a second simulated three-dimensional effect corresponding to the second activatable control while the first view of the three-dimensional environment is visible. In some embodiments, in response to detecting the first portion of the input: the computer system changes the second simulated three-dimensional effect by a third amount (e.g., in conjunction with displaying the second view of the three-dimensional environment and changing the first simulated three-dimensional effect by the first amount). In some embodiments, in response to detecting the second portion of the input: the computer system changes the second simulated three-dimensional effect by a fourth amount, wherein the fourth amount is different from the third amount (e.g., in conjunction with displaying the third view of the three-dimensional environment and changing the first simulated three-dimensional effect by the second amount). In some embodiments, a plurality of activatable controls in the first user interface are displayed with respective simulated three-dimensional effects. For example, as described with reference to FIG. 7D, in some embodiments, visual effects are applied to both the button 7009 and the button 7011. The visual effects behave in an analogous fashion to the visual effect 7052 and the visual effect 7054 (e.g., the appearance, location and/or size of the visual effect changes in accordance with movement of the user interface 7050). Displaying multiple activatable controls in a user interface in a three-dimensional environment with respective simulated three-dimensional effects (e.g., with a simulated lighting effect and/or a simulated shadow), and changing the respective simulated three-dimensional effects for the activatable controls, in accordance with movement of a viewpoint of a user relative to the encompassing user interface, by different amounts as the movement of the viewpoint relative to the user interface progresses, causes the computer system to automatically provide visual feedback about the spatial relationship between the user interface and the three-dimensional environment and, in the case of moving the respective simulated three-dimensional effects progressively less as the movement of the viewpoint progresses, reduces motion and parallax in the three-dimensional environment, which improves the user's context awareness of the three-dimensional environment and improves user physiological comfort by avoiding physiological discomfort associated with physical motion of the user that is not matched with environmental response in an a three-dimensional environment that is visible to the user.

In some embodiments, changing the first simulated three-dimensional effect corresponding to the first activatable control in response to detecting the first portion of the input and in response to detecting the second portion of the input changes the first simulated three-dimensional effect in a first manner (e.g., in accordance with one or more first types of changes in simulated three-dimensional effect). In some embodiments, the computer system displays a respective simulated three-dimensional effect corresponding to the first user interface (e.g., corresponding to the first user interface as a whole or to a main region of the first user interface, such as an application window or platter of the first user interface, in contrast to an auxiliary region of the first user interface, such as an activatable control of the first user interface) while the first view of the three-dimensional environment is visible, wherein the respective simulated three-dimensional effect is distinct from the first simulated three-dimensional effect corresponding to the first activatable control (e.g., and distinct from the second three-dimensional effect corresponding to the second activatable control). In some embodiments, in response to detecting the first portion of the input: the computer system changes the respective simulated three-dimensional effect corresponding to the first user interface in a second manner that is different from the first manner (e.g., in accordance with one or more second types of change in simulated three-dimensional effect, different from the one or more first types of change); and, in response to detecting the second portion of the input: the computer system changes the respective simulated three-dimensional effect corresponding to the first user interface in the second manner.

In some embodiments, the first manner of changing a simulated three-dimensional effect changes the simulated three-dimensional effect based on movement of the viewpoint of the user relative to the user interface or user interface element (e.g., activatable control, content entry field, or other affordance) of the user interface without changing the simulated three-dimensional effect based on movement of the user interface relative to the three-dimensional environment, whereas the second manner of changing the simulated three-dimensional effect changes the simulated three-dimensional effect based both on movement of the viewpoint of the user relative to the user interface or user interface element and on movement of the user interface relative to the three-dimensional environment. In some embodiments, the first manner of changing a simulated three-dimensional effect includes changing the simulated three-dimensional effect based on movement of the viewpoint of the user in a first direction (e.g., lateral movement) relative to the user interface without changing the simulated three-dimensional effect based on movement of the viewpoint of the user in a second, different direction (e.g., vertical movement) relative to the user interface, whereas the second manner of changing the simulated three-dimensional effect includes changing the simulated three-dimensional effect based both on movement of the viewpoint of the user in the first direction and on movement of the viewpoint of the user in the second direction.

For example, in FIGS. 7D and 7E, the user interface 7050 is repositioned, and the visual effect 7052 changes in a first manner (e.g., the visual effect 7052 moves to a new position that is further to the right, along the top edge of the user interface 7050, and further up, along the left edge of the user interface 7050), while the visual effect 7058 changes in a different manner (e.g., the visual effect 7058 does not change vertically along the right edge of the text entry field 7056, but expands to the left, along the bottom edge of the text-entry field 7056). Displaying a user interface in a three-dimensional environment with a simulated three-dimensional effect (e.g., with a simulated lighting effect and/or a simulated shadow) that changes in a different way in accordance with movement of a viewpoint of a user relative to the user interface than the way a respective simulated three-dimensional effect for an activatable control in the user interface changes causes the computer system to automatically provide visual feedback indicating the type of a particular element and by extension what interactions are available for the particular element, while providing visual feedback about the spatial relationship between the user interface and the three-dimensional environment, which improves the user's context awareness of the three-dimensional environment and improves user physiological comfort by avoiding physiological discomfort associated with physical motion of the user that is not matched with environmental response in an a three-dimensional environment that is visible to the user.

In some embodiments, while displaying the first user interface at a first position in the three-dimensional environment with a respective spatial relationship to the viewpoint of the user, the computer system detects one or more inputs. In some embodiments, in response to detecting the one or more inputs: in accordance with a determination that the one or more inputs include an input corresponding to a request to change the viewpoint of the user to have a changed spatial relationship to the first user interface that is different from the respective spatial relationship, the computer system: displays the first user interface (e.g., in a corresponding view of the three-dimensional environment) in accordance with the changed spatial relationship to the viewpoint of the user; changes the first simulated three-dimensional effect corresponding to the first activatable control in accordance with the changed spatial relationship to the viewpoint of the user; and changes the respective simulated three-dimensional effect corresponding to the first user interface in accordance with the changed spatial relationship to the viewpoint of the user. In some embodiments, in response to detecting the one or more inputs: in accordance with a determination that the one or more inputs include an input corresponding to a request to reposition the first user interface to a second position in the three-dimensional environment, the computer system: displays the first user interface at the second position in the three-dimensional environment; and changes the respective simulated three-dimensional effect corresponding to the first user interface in accordance with repositioning the first user interface without changing the first simulated three-dimensional effect corresponding to the first activatable control in accordance with the repositioning of the first user interface.

In some embodiments, in response to the one or more inputs including an input both corresponding to a request to change the viewpoint of the user to have a changed spatial relationship to the first user interface and corresponding to a request to reposition the first user interface to a second position in the three-dimensional environment (or respective such inputs), the first simulated three-dimensional effect corresponding to the first activatable control is changed in accordance with the changed spatial relationship of the first user interface to the viewpoint of the user yet without regard to the repositioning of the first user interface to the second position, whereas the respective simulated three-dimensional effect corresponding to the first user interface is changed both in accordance with the changed spatial relationship of the first user interface to the viewpoint of the user and in accordance with the repositioning of the first user interface to the second position.

For example, as described with reference to FIG. 7I, in some embodiments, the visual effect 7058 changes in appearance when the viewpoint of the user 7002 changes (e.g., and does not change due to the user interface 7050 being repositioned), whereas the visual effect 7052 and the visual effect 7054 change in appearance when the viewpoint of the user 7002 changes (e.g., and/or the user interface 7050 is repositioned). Displaying a user interface in a three-dimensional environment with a simulated three-dimensional effect that changes in accordance with both movement of a viewpoint of a user relative to the user interface as well as movement of the user interface relative to the three-dimensional environment, in contrast to a respective simulated three-dimensional effect for an activatable control in the user interface that changes in accordance with movement of the viewpoint of the user relative to the user interface, ignoring movement of the user interface relative to the three-dimensional environment, causes the computer system to automatically reduce motion and parallax in the three-dimensional environment while providing visual feedback about the spatial relationship between the user interface and the three-dimensional environment, which improves the user's context awareness of the three-dimensional environment and improves user physiological comfort by avoiding physiological discomfort associated with physical motion of the user that is not matched with environmental response in an a three-dimensional environment that is visible to the user.

In some embodiments, changing the first simulated three-dimensional effect corresponding to the first activatable control in the first manner includes changing the first simulated three-dimensional effect in accordance with movement of the viewpoint of the user in a first direction relative to the first user interface (e.g., lateral movement, such as to the left and/or right) without regard to movement of the viewpoint of the user in a second direction relative to the first user interface, wherein the second direction (e.g., vertical movement, such as up or down) is different from (and optionally perpendicular to) the first direction. In some embodiments, changing a simulated three-dimensional effect in accordance with movement of the viewpoint of the user includes displaying the simulated three-dimensional effect changing in a direction that is based on one or more (e.g., less than all, or all) directions of the movement of the viewpoint, displaying the simulated three-dimensional effect changing by a magnitude that is based on a magnitude of the movement of the viewpoint, and/or displaying the simulated three-dimensional effect changing with a rate of change that is based on a rate of change of the movement of the viewpoint. In some embodiments, changing the respective simulated three-dimensional effect in the second manner includes changing the respective simulated three-dimensional effect in accordance with movement of the viewpoint of the user in the first direction relative to the first user interface and in accordance with movement of the viewpoint of the user in the second direction relative to the first user interface (e.g., displaying the simulated three-dimensional effect changing in a direction that is based on multiple directions of the movement of the viewpoint, displaying the simulated three-dimensional effect changing by a magnitude that is based on a magnitude of the movement of the viewpoint, and/or displaying the simulated three-dimensional effect changing with a rate of change that is based on a rate of change of the movement of the viewpoint).

For example, as described with reference to FIG. 7I, in some embodiments, the visual effect 7058 changes in appearance in accordance with a change in viewpoint of the user in a first direction (e.g., a horizontal direction) but does not change in accordance with a change in viewpoint of the user in a second direction different from the first direction (e.g., a vertical direction). In contrast, the visual effect 7052 and the visual effect 7054 change in appearance in accordance with a change in viewpoint of the user in the first direction, and in accordance with a change in viewpoint of the user in the second direction. Displaying a user interface in a three-dimensional environment with a simulated three-dimensional effect that changes in accordance with movement of a viewpoint of a user relative to the user interface in multiple directions, in contrast to a respective simulated three-dimensional effect for an activatable control in the user interface that changes in accordance with movement of the viewpoint of the user relative to the user interface in only some of the multiple directions (e.g., ignoring movement of the viewpoint of the user relative to the user interface in other directions of the multiple directions), causes the computer system to automatically reduce motion and parallax in the three-dimensional environment while providing visual feedback about the spatial relationship between the user interface and the three-dimensional environment, which improves the user's context awareness of the three-dimensional environment and improves user physiological comfort by avoiding physiological discomfort associated with physical motion of the user that is not matched with environmental response in an a three-dimensional environment that is visible to the user.

In some embodiments, aspects/operations of methods 900 and 1100 may be interchanged, substituted, and/or added between these methods. For example, the user interfaces, affordances, user interface elements, and controls of method 1000 optionally have simulated lighting effects and/or simulated shadows that exhibit one or more behaviors described with reference to methods 900 and 1100. For brevity, these details are not repeated here.

FIG. 11 is a flow diagram of an exemplary method 1100 for repositioning a shadow corresponding to a user interface as the user interface is reoriented, in accordance with some embodiments. In some embodiments, method 1100 is performed at a computer system (e.g., computer system 101 in FIG. 1A) that is in communication with a display generation component (e.g., display generation component 120 in FIGS. 1, 3, and 4 or display generation component 7100 in FIG. 7A) (e.g., a heads-up display, a display, a touchscreen, a projector, or other display device) and one or more sensors (e.g., one or more cameras (e.g., color sensors, infrared sensors, and/or other depth-sensing cameras), touch-sensitive surfaces, motion sensors, and/or orientation sensors). In some embodiments, the method 1100 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 1100 are, optionally, combined and/or the order of some operations is, optionally, changed.

While a first view of a three-dimensional environment is visible via the display generation component, the computer system displays (1102), a first user interface object (e.g., the user interface 8002 in FIG. 8A, and/or the grabber 8004 that corresponds to the user interface 8002) with a first orientation (e.g., substantially parallel to the plane of the display generation component 7100 of the computer system 101) and at a first object position in the three-dimensional environment, and displaying a first simulated shadow (e.g., the shadow 8006 in FIG. 8A), corresponding to the first user interface object, at a first shadow position in the three-dimensional environment. The first simulated shadow at the first shadow position has a first spatial relationship to the first user interface object (e.g., the shadow 8006 is directly beneath the user interface 8002, as shown in the side view of FIG. 8A);

The computer system detects (1104) a user input (e.g., the user's attention 8010 directed to the grabber 8004, in combination with a predefined gesture, as shown in FIGS. 8C and 8D) directed to the first user interface object (e.g., the grabber 8004 that corresponds to the user interface 8002).

In response to detecting the user input, the computer system changes (1106) an orientation of the first user interface object from the first orientation to a second orientation (e.g., the position of the first user interface is defined as a position of a central point of the first user interface, and the first user interface is reoriented (e.g., rotated) about an axis that runs through the central point of the first user interface) (e.g., the user interface 8002 is reoriented such that the bottom edge of the user interface 8002 moves closer to the viewpoint of the user 7002, and the top edge of the user interface 8002 moves further from the viewpoint of the user 7002, as shown in the side view of FIGS. 8D), including: displaying (1108) the first user interface object with the second orientation (e.g., and at the first object position in the three-dimensional environment); and displaying (1110) the first simulated shadow at a second shadow position in the three-dimensional environment. The second shadow position in the first view of the three-dimensional environment is different from the first shadow position in the first view of the three-dimensional environment (e.g., in FIGS. 8D, the shadow 8006 moves closer the viewpoint of the user 7002, to a location that is different from the original location of the shadow 8006 (e.g., the location of the shadow 8006 in FIG. 8A) represented by the outline 8012. The first simulated shadow at the second shadow position has a second spatial relationship to the first user interface object, and the second spatial relationship is different from the first spatial relationship (e.g., in FIGS. 8D, the shadow 8006 moves to a position that is closer to the viewpoint of the user 7002, while the (e.g., center point, or location of a central point of the) user interface 8002 does not move relative to the viewpoint of the user 7002).

When displaying a simulated shadow for a user interface object in a three-dimensional environment, changing a spatial relationship between the simulated shadow and the user interface object in accordance with changes in the orientation (e.g., amount of tilt relative to a vertical direction) of the user interface object relative to the three-dimensional environment, such as by shifting the simulated shadow relative to the user interface object to exaggerate the position of the simulated shadow relative to one or more light sources in the three-dimensional environment, causes the computer system to automatically provide improved visual feedback about the spatial relationship between the user interface object and the three-dimensional environment, which improves the user's context awareness of the three-dimensional environment and improves user physiological comfort by avoiding physiological discomfort associated with physical motion of the user that is not matched with environmental response in an a three-dimensional environment that is visible to the user.

In some embodiments, the computer system displays the first simulated shadow at the second shadow position in the three-dimensional environment without changing a size of the first simulated shadow. For example, as described with reference to FIGS. 8D, and as shown by the shadow 8006 having the same size in both FIGS. 8C and 8D, in some embodiments, the shadow 8006 changes position without changing in size. Maintaining the size of a simulated shadow while changing a spatial relationship between the simulated shadow and a corresponding user interface object in accordance with changes in the orientation (e.g., tilting) of the user interface object relative to the three-dimensional environment causes the computer system to automatically provide improved visual feedback about the spatial relationship between the user interface object and the three-dimensional environment, which improves the user's context awareness of the three-dimensional environment and improves user physiological comfort by avoiding physiological discomfort associated with physical motion of the user that is not matched with environmental response in an a three-dimensional environment that is visible to the user.

In some embodiments, in response to detecting the user input: the computer system displays the first user interface object (e.g., with the second orientation) at a second object position in the first view of the three-dimensional environment. In some embodiments, the second object position is the same as the first object position (e.g., the first user interface object is tilted without being repositioned). In some embodiments, the second object position is different from the first object position (e.g., the first user interface object is repositioned in addition to being tilted). In some embodiments, a degree of change (e.g., a linear distance, angular distance, or other absolute or relative change) between the first object position and the second object position of the first user interface object is different from (e.g., greater than or less than) a degree of change (e.g., a linear distance, angular distance, or other absolute or relative change) between the first shadow position and the second shadow position of the first simulated shadow. In some embodiments, in accordance with changing the orientation of the first user interface object (e.g., from the first orientation to the second orientation), the first simulated shadow moves closer to or further from the viewpoint of the user more or less than would be the case for changes in object position of the first user interface object without changes in orientation of the first user interface object. For example, in FIGS. 8D, the linear distance of a central point of the user interface 8002 (e.g., represented by the thinner set of dotted lines in the side view) from the viewpoint of the user 7002 is different from (e.g., greater than) the linear distance of the shadow 8006 from the viewpoint of the user 7002 (e.g., as shown in the side view, the position of the shadow 8006, is further forward and closer to the user 7002, than the user interface 8002). Changing a spatial relationship between a simulated shadow and a corresponding user interface object in a three-dimensional environment in accordance with changes in the orientation (e.g., tilting) of the user interface object relative to the three-dimensional environment by changing the depth (e.g., distance from a viewpoint of the user) of the simulated shadow relative to a depth of the user interface object causes the computer system to automatically provide improved visual feedback about the spatial relationship between the user interface object and the three-dimensional environment, which improves the user's context awareness of the three-dimensional environment and improves user physiological comfort by avoiding physiological discomfort associated with physical motion of the user that is not matched with environmental response in an a three-dimensional environment that is visible to the user.

In some embodiments, displaying the first simulated shadow at a second shadow position in the three-dimensional environment includes: when (e.g., in accordance with a determination that) the changing of the orientation of the first user interface object from the first orientation to the second orientation includes rotation (e.g., tilting) of the first user interface object in a first direction (e.g., that changes an angle of incidence between a surface, such as a front surface, of the first user interface object and a reference location, such as the location of a real or simulated light source), repositioning the first simulated shadow in a third direction corresponding to the first direction; and, when (e.g., in accordance with a determination that) the changing of the orientation of the first user interface object from the first orientation to the second orientation includes rotation of the first user interface object in a second direction that is different from the first direction, repositioning the first simulated shadow in a fourth direction corresponding to the second direction, wherein the fourth direction is different from the third direction. For example, as described with reference to FIG. 8J, in some embodiments, tilting the user interface 8002 in a first direction causes the shadow 8006 to move in a first direction, and tilting the user interface 8002 in an opposite direction causes the shadow 8006 to move in a different (e.g., opposite) direction. Changing a spatial relationship between a simulated shadow and a corresponding user interface object in a three-dimensional environment in accordance with changes in the orientation (e.g., tilting) of the user interface object relative to the three-dimensional environment by moving the simulated shadow in a direction that is based on a direction of the change in orientation of the user interface object (e.g., moving the simulated shadow forward as the object is tilted to lean backward, or other relationship between the directions) causes the computer system to automatically provide improved visual feedback about the spatial relationship between the user interface object and the three-dimensional environment, which improves the user's context awareness of the three-dimensional environment and improves user physiological comfort by avoiding physiological discomfort associated with physical motion of the user that is not matched with environmental response in an a three-dimensional environment that is visible to the user.

In some embodiments, displaying the first simulated shadow at a second shadow position in the three-dimensional environment includes: when (e.g., in accordance with a determination that) the changing of the orientation of the first user interface object from the first orientation to the second orientation includes a first magnitude of rotation (e.g., tilting) of the first user interface object (e.g., that changes an angle of incidence between a surface, such as a front surface, of the first user interface object and a reference location, such as the location of a real or simulated light source), displaying a first magnitude of change in spatial relationship between the first simulated shadow and the first user interface object; and, when (e.g., in accordance with a determination that) the changing of the orientation of the first user interface object from the first orientation to the second orientation includes a second magnitude of rotation of the first user interface object, displaying a second magnitude of change in spatial relationship between the first simulated shadow and the first user interface object, wherein the second magnitude of rotation is different from the first magnitude of rotation, and the second magnitude of change in spatial relationship is different from the first magnitude of change in spatial relationship. For example, in FIGS. 8C-8E, the shadow 8006 moves proportionally to the amount by which the user interface 8002 is reoriented (e.g., tilted). In FIGS. 8D, the user interface 8002 is reoriented by a small amount, and the shadow 8006 moves a small distance from the original position of the shadow 8006 that is represented by the outline 8012. In FIGS. 8E, the user interface 8002 has been reoriented by a greater amount, and the shadow 8006 is moved by a greater distance than in FIG. 8D. Changing a spatial relationship between a simulated shadow and a corresponding user interface object in a three-dimensional environment in accordance with changes in the orientation (e.g., tilting) of the user interface object relative to the three-dimensional environment by displaying a magnitude of change in the simulated shadow that is based on a magnitude of the change in orientation of the user interface object (e.g., moving the simulated shadow more as the object is tilted more, or other relationship between the magnitudes) causes the computer system to automatically provide improved visual feedback about the spatial relationship between the user interface object and the three-dimensional environment, which improves the user's context awareness of the three-dimensional environment and improves user physiological comfort by avoiding physiological discomfort associated with physical motion of the user that is not matched with environmental response in an a three-dimensional environment that is visible to the user.

In some embodiments, changing the orientation of the first user interface object from the first orientation to the second orientation includes transitioning the first user interface object through a plurality of intermediate orientations between the first orientation and the second orientation. In some embodiments, while transitioning the first user interface object through the plurality of intermediate orientations between the first orientation and the second orientation, the computer system moves the first simulated shadow through a plurality of intermediate shadow positions between the first shadow position associated with the first spatial relationship (corresponding to the first user interface object having the first orientation) and the second shadow position associated with the second spatial relationship (corresponding to the first user interface object having the second orientation), as the first user interface object transitions through the plurality of intermediate orientations between the first orientation and the second orientation. For example, the first simulated shadow is transitioned through a sequence of intermediate shadow positions so as to transition through a sequence of intermediate spatial relationships with the first user interface object, between the first spatial relationship and the second spatial relationship. For example, in FIGS. 8C-8D, the user interface 8002 is reoriented to an intermediate orientation and the shadow 8006 is moved to an intermediate position. In FIGS. 8D-8E, the user interface 8002 is reoriented to a second orientation (e.g., is further reoriented in the same direction as in FIGS. 8C-8D), and the shadow 8006 is moved to a second position (e.g., is further moved in the same direction as in FIGS. 8C-8D). Changing a spatial relationship between a simulated shadow and a corresponding user interface object in a three-dimensional environment gradually in accordance with a magnitude of change in the orientation (e.g., tilting) of the user interface object relative to the three-dimensional environment progressing causes the computer system to automatically provide improved visual feedback about the spatial relationship between the user interface object and the three-dimensional environment, which improves the user's context awareness of the three-dimensional environment and improves user physiological comfort by avoiding physiological discomfort associated with physical motion of the user that is not matched with environmental response in an a three-dimensional environment that is visible to the user.

In some embodiments, in response to detecting the user input: the computer system moves the first user interface object from the first object position to a second object position that is different from the first object position (e.g., the user input directed to the first user interface object corresponds to a request to move the first user interface object relative to the three-dimensional environment, such as by including movement in one or more directions). In some embodiments, moving the first user interface object from the first object position to the second object position is performed in conjunction with, and in some embodiments concurrently with, changing the orientation of the first user interface object from the first orientation to the second orientation. For example, as described with reference to FIG. 8G, in some embodiments the user 7002 repositions (e.g., changes a position of) the user interface 8002 without intentionally adjusting an orientation of the user interface 8002 (e.g., and optionally the computer system 101 automatically reorients the user interface 8002, if necessary). Changing a spatial relationship between a simulated shadow for a user interface object in a three-dimensional environment in accordance with changes in the orientation (e.g., tilting) of the user interface object relative to the three-dimensional environment, such as by shifting the simulated shadow relative to the user interface object to exaggerate the position of the simulated shadow relative to one or more light sources in the three-dimensional environment, as the user interface object is moved relative to the three-dimensional environment causes the computer system to automatically provide improved visual feedback about the spatial relationship between the user interface object and the three-dimensional environment, which improves the user's context awareness of the three-dimensional environment and improves user physiological comfort by avoiding physiological discomfort associated with physical motion of the user that is not matched with environmental response in an a three-dimensional environment that is visible to the user.

In some embodiments, changing the orientation of the first user interface object from the first orientation to the second orientation is performed automatically in accordance with the moving of the first user interface object from the first object position to the second object position (e.g., the orientation of the first user interface object is dependent on (e.g., a function of) the position of the first user interface object). For example, in FIG. 7G, the user interface 8002 is automatically reoriented when the user interface 8002 is moved to a position where it would enter the region 8016 (e.g., such that the user interface 8002 is substantially tangential to a circle defined by the region 8016). Automatically changing the orientation (e.g., tilting) of a user interface object relative to a three-dimensional environment as the user interface object is moved relative to the three-dimensional environment causes the computer system to automatically provide improved visual feedback about the spatial relationship between the user interface object and the three-dimensional environment consistent with a user's current perspective, which improves the user's context awareness of the three-dimensional environment and improves user physiological comfort by avoiding physiological discomfort associated with physical motion of the user that is not matched with environmental response in an a three-dimensional environment that is visible to the user.

In some embodiments, the computer system displays the first user interface object with the first orientation in accordance with displaying the first user interface object at the first object position at a first distance from a viewpoint of a user; and the computer system changes the orientation of the first user interface object from the first orientation to the second orientation in accordance with displaying the first user interface object at a second distance from the viewpoint of the user, wherein the second distance is different from the first distance. For example, changing the orientation of the first user interface object includes tilting a respective portion (e.g., the bottom, top, left, or right side) of the first user interface object toward a viewpoint of the user more as the first user interface object is moved closer to, or alternatively further from, the viewpoint of the user. For example, in FIG. 7G, the user interface 8002 is displayed with the first orientation (e.g., substantially parallel to the plane of the display generation component 7100 of the computer system 101) when displayed at the location represented by the outline 8014. The user interface 8002 is displayed with the second orientation (e.g., is tilted up or down, depending on the relative position of the user interface 8002 relative to viewpoint of the user 7002), when the user interface 8002 is moved closer to the viewpoint of the user 7002). Changing the orientation (e.g., tilting) of a user interface object relative to a three-dimensional environment based on a distance between a viewpoint of a user and the user interface object in the three-dimensional environment causes the computer system to automatically improve visibility of the user interface object from the user's current perspective and to provide improved visual feedback about the spatial relationship between the user's current perspective and the user interface object, which improves the user's context awareness of the three-dimensional environment and improves user physiological comfort by avoiding physiological discomfort associated with physical motion of the user that is not matched with environmental response in an a three-dimensional environment that is visible to the user.

In some embodiments, while the first simulated shadow has the first spatial relationship to the first user interface object with the first orientation, the first simulated shadow is displayed at a respective location relative to the first user interface object. In some embodiments, while the first simulated shadow has the second spatial relationship to the first user interface object with the second orientation, the first simulated shadow is displayed in front of the respective location relative to the first user interface object (e.g., closer to a viewpoint of a user). For example, in FIGS. 8E, the shadow 8006 is displayed at a location that is in front of (e.g., closer to the viewpoint of the user 7002) the original location at which the shadow 8006 was displayed (e.g., as represented by the outline 8012). Changing a spatial relationship between a simulated shadow and a corresponding user interface object in a three-dimensional environment in accordance with changes in the orientation (e.g., tilting) of the user interface object relative to the three-dimensional environment by moving the simulated shadow forward relative to the user interface object (e.g., so that the simulated shadow is closer to a front edge of the user interface object or is in front of the user interface object) causes the computer system to automatically provide improved visual feedback about the spatial relationship between the user interface object and the three-dimensional environment, which improves the user's context awareness of the three-dimensional environment and improves user physiological comfort by avoiding physiological discomfort associated with physical motion of the user that is not matched with environmental response in an a three-dimensional environment that is visible to the user.

In some embodiments, the first simulated shadow displayed at the first shadow position has a respective thickness (e.g., a dimension of the first shadow in a z-direction that extends forward and backward from a viewpoint of the user), and the first simulated shadow displayed at the second shadow position has the respective thickness (e.g., the same respective thickness) (e.g., the first simulated shadow is repositioned in the three-dimensional environment to have a different spatial relationship to the first user interface object as the orientation of the first user interface object is changed, without changing in thickness). For example, in FIGS. 8D and 8E, the shadow 8006 has the same width and thickness as in FIG. 8A, even though the user interface 8002 in FIGS. 8D and 8E has a different orientation from the user interface 8002 in FIG. 8A (e.g., and even though the shadow 8006, if a real shadow cast by a real object (e.g., with the same dimensions and orientation as the user interface 8002, and based on the same lighting provided by the lighting sources 8008), would change in width and/or thickness). Maintaining a thickness of a simulated shadow when changing a spatial relationship between the simulated shadow and a corresponding user interface object in a three-dimensional environment in accordance with changes in the orientation (e.g., tilting) of the user interface object relative to the three-dimensional environment causes the computer system to automatically reduce the computational burden of rendering the simulated shadow (e.g., when additional computational resources may be needed for the changing of the orientation of the user interface object) and to provide improved visual feedback about the spatial relationship between the user interface object and the three-dimensional environment, which improves the user's context awareness of the three-dimensional environment and improves user physiological comfort by avoiding physiological discomfort associated with physical motion of the user that is not matched with environmental response in an a three-dimensional environment that is visible to the user.

In some embodiments, in response to detecting the user input, the computer system changes an appearance of the first simulated shadow (e.g., from a first appearance (e.g., a first selection-dependent appearance) to a second appearance (e.g., a second selection-dependent appearance) that is different from the first appearance in opacity, degree of blurring, brightness, and/or other visual property) while maintaining display of the first user interface object with the first orientation and at the first object position. For example, as described with reference to FIG. 8C, in response to detecting the user's attention 8010 directed to the grabber 8004 (e.g., that corresponds to the user interface 8002) in combination with a predefined gesture (e.g., represented by the hand of the user in FIG. 8C), the shadow 8006 has a third appearance that is different from the appearance of the shadow 8006 in both FIG. 8A and FIG. 8B. Changing an appearance of a simulated shadow for a user interface object in a three-dimensional environment based on whether an input selecting the user interface object to move the user interface object is being detected (e.g., whether or not the user interface object is in fact being moved) indicates which part of the three-dimensional environment is currently the target of user interaction and the type of interaction that is occurring, which provides improved visual feedback about a state of the computer system.

In some embodiments, the computer system detects an end of the user input; and, in response to detecting the end of the user input, the computer system at least partially reverses the changing of the appearance of the first simulated shadow (e.g., from a third appearance (e.g., a third selection-dependent appearance, optionally the same as the second appearance) to a fourth appearance (e.g., a fourth selection-dependent appearance, optionally the same as the first appearance) that is different from the third appearance in opacity, degree of blurring, brightness, and/or other visual property) while maintaining display of the first user interface object with a respective orientation and at a respective object position (e.g., maintaining the same orientation (e.g., the second orientation) and object position of the first user interface object just before and just after detecting the end of the user input). In some embodiments, the fourth appearance of the first simulated shadow includes changes to the third appearance the first simulated shadow that at least partially reverse some or all of the changes to the first appearance of the first simulated shadow that resulted in the second appearance of the first simulated shadow (e.g., at least partially reversing changes in opacity, degree of blurring, brightness, and/or other visual property). For example, in FIGS. 8E, the predefined gesture is no longer detected, so the shadow 8006 is displayed with an appearance indicative of the user's attention 8010 being directed to the grabber 8004 (e.g., the same appearance as in FIG. 8B), whereas in FIG. 8F, the user's attention 8010 is no longer directed to the grabber 8004 or the user interface 8002, and the shadow 8006 is displayed with the default appearance (e.g., the same appearance as in FIG. 8A). The user interface 8002 remains in the adjusted orientation (e.g., the orientation that resulted from the user reorienting the user interface 8002 in FIGS. 8C-8E). Reversing changes in appearance of a simulated shadow for a user interface object in a three-dimensional environment based on whether the end of an input selecting the user interface object to move the user interface object has been detected (e.g., whether or not the user interface object was in fact moved) indicates which part of the three-dimensional environment has ceased to be the target of user interaction and optionally the type of interaction that occurred, which provides improved visual feedback about a state of the computer system.

In some embodiments, the user input directed to the first user interface object includes an air gesture (e.g., an air tap, air pinch, or other air gesture). For example, in FIG. 8C, the user input includes the user's attention 8010 directed to the grabber 8004 in combination with a predefined gesture (e.g., shown by the hand of the user 7002). This is further described with reference to FIG. 8C, wherein the predefined gesture is an air tap, an air pinch, or another air gesture. Changing a spatial relationship between a simulated shadow and a user interface object in a three-dimensional environment in accordance with changes in the orientation (e.g., amount of tilt relative to a vertical direction) of the user interface object relative to the three-dimensional environment in response to an air gesture reduces the number and extent of inputs needed to interact with the user interface object, particularly if the user interface object is beyond a user's reach.

In some embodiments, prior to detecting the user input directed to the first user interface object, displaying the first simulated shadow at the first shadow position includes: while attention of a user is not directed to the first user interface object, displaying the first simulated shadow with a first appearance (e.g., a first attention-dependent appearance); and, while the attention of the user is directed to the first user interface object, displaying the first simulated shadow with a second appearance (e.g., a second attention-dependent appearance) that is different from the first appearance (e.g., visually emphasized, or deemphasized, in opacity, degree of blurring, brightness, and/or other visual property). In some embodiments, the set of attention-dependent appearances (e.g., including the first and second attention-dependent appearances) is the same as or different from the set of selection-dependent appearances of the first simulated shadow (e.g., including the first, second, third, and fourth selection-dependent appearances). For example, in FIG. 8B, the computer system 101 detects the user's attention 8010 directed to the user interface 8002, and the shadow 8006 is displayed with a different appearance (e.g., as compared to the appearance of the shadow in FIG. 8A). Changing an appearance of a simulated shadow for a user interface object in a three-dimensional environment based on whether a user's attention is directed to the user interface object indicates which part of the three-dimensional environment currently has focus for further interaction, which provides improved visual feedback about a state of the computer system.

In some embodiments, prior to detecting the user input directed to the first user interface object, the computer system displays the first simulated shadow at the first shadow position includes displaying the first simulated shadow with a respective appearance. In some embodiments, while detecting the user input directed to the first user interface object (e.g., while changing the orientation of the first user interface object in response to detecting the user input), the computer system changes one or more visual properties of the respective appearance of the first simulated shadow (e.g., changing opacity, degree of blurring, brightness, and/or other visual property), including displaying the first simulated shadow with the changed one or more visual properties of the respective appearance (e.g., the changed opacity, degree of blurring, brightness, and/or other visual property) as the first simulated shadow is moved from the first shadow position to the second shadow position. In some embodiments, the first simulated shadow is displayed with the changed appearance while detecting the user input directed to the first user interface object, whether or not the orientation of the first user interface is being changed. For example, as described with reference to FIGS. 8D, in some embodiments, the shadow 8006 has a fourth appearance (e.g., that is different from the appearance in FIGS. 8A, 8B, and/or 8C), and maintains the fourth appearance while the user interface 8002 is being repositioned, reoriented, and/or resized. Changing an appearance of a simulated shadow for a user interface object in a three-dimensional environment while the user interface object is being moved relative to the three-dimensional environment indicates which parts of the three-dimensional environment collectively are currently the target of user interaction and the type of interaction that is occurring, which provides improved visual feedback about a state of the computer system.

In some embodiments, the computer system detects an input corresponding to a request to move the first user interface object relative to the three-dimensional environment (e.g., to reposition the first user interface object from the first object position to a second or other object position in the three-dimensional environment). In some embodiments, in response to detecting the input corresponding to the request to move the first user interface object relative to the three-dimensional environment, the computer system: moves the first user interface object relative to the three-dimensional environment; and visually deemphasizes the first simulated shadow corresponding to the first user interface object as a distance between the first user interface object and a respective plane in the three-dimensional environment changes (e.g., and in accordance with a determination that the distance between the first user interface object and the respective plane is less than a threshold distance), wherein visually deemphasizing the first simulated shadow includes changing one or more visual properties of the first simulated shadow (e.g., increasing or decreasing opacity, degree of blurring, size, brightness, and/or other visual property). In some embodiments, the respective plane is a reference plane in the three-dimensional environment, such as the floor or a surface of a reference object below, behind, above, or in front of the first user interface object, or a plane of the viewpoint of the user, or other plane. In some embodiments, the first simulated shadow continues to be displayed at a location on the respective plane (e.g., a location that is adjusted in accordance with tilting of the first user interface object) as the first user interface object is moved away from the respective plane (e.g., the first simulated shadow continues to be displayed on a surface below the first user interface object as the first user interface object is moved upward above the surface).

For example, in FIG. 8L, the shadow 8006 is displayed with a different appearance (e.g., dimmer or blurrier) as compared to the shadow 8006 in FIG. 8J or 8K, as the user interface 8002 is repositioned in a vertical direction (e.g., further from the surface 8000). Visually deemphasizing (e.g., fading) a simulated shadow for a user interface object based on a distance between the user interface object and a respective plane (e.g., a floor or other reference surface below the user interface object) (e.g., including progressively visually deemphasizing the simulated shadow as the distance increases) causes the computer system to automatically give focus to the moving of the user interface object and provide visual feedback about the spatial relationship between the user interface object and the three-dimensional environment, which improves the user's context awareness of the three-dimensional environment and improves user physiological comfort by avoiding physiological discomfort associated with physical motion of the user that is not matched with environmental response in an a three-dimensional environment that is visible to the user.

In some embodiments, visually deemphasizing the first simulated shadow includes, in accordance with a determination that the distance between the first user interface object and the respective plane is greater than a threshold distance, ceasing to display the first simulated shadow. For example, in FIG. 8M, the shadow 8006 ceases to be displayed once the user interface 8002 is repositioned beyond a threshold height H_{Th} in the vertical direction (e.g., further from the surface 8000). After visually deemphasizing (e.g., fading) a simulated shadow for a user interface object based on a distance between the user interface object and a respective plane (e.g., a floor or other reference surface below the user interface object), ceasing to display the simulated shadow altogether if the user interface object is moved more than a threshold distance from the respective plane (e.g., on which the simulated shadow was displayed) causes the computer system to automatically give focus to the moving of the user interface object and provide visual feedback about the spatial relationship between the user interface object and the three-dimensional environment, which improves the user's context awareness of the three-dimensional environment and improves user physiological comfort by avoiding physiological discomfort associated with physical motion of the user that is not matched with environmental response in an a three-dimensional environment that is visible to the user.

In some embodiments, aspects/operations of methods 900 and 1000 may be interchanged, substituted, and/or added between these methods. For example, the simulated shadows of method 1100 are optionally displayed with, and exhibit the behavior described herein with respect to movement of, the user interfaces and/or affordances, controls, and elements of methods 900 and 1000. For brevity, these details are not repeated here.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

What is claimed is:

1. A method, comprising:
at a computer system that is in communication with a display generation component and one or more sensors:
while a first view of a three-dimensional environment is visible via the display generation component, displaying a first user interface object with a first orientation and at a first object position in the three-dimensional environment, and displaying a first simulated shadow, corresponding to the first user interface object, at a first shadow position in the three-dimensional environment, wherein the first simulated shadow at the first shadow position has a first spatial relationship to the first user interface object;
detecting a user input directed to the first user interface object; and
in response to detecting the user input, changing an orientation of the first user interface object from the first orientation to a second orientation, including:
displaying the first user interface object with the second orientation; and
displaying the first simulated shadow at a second shadow position in the three-dimensional environment, wherein:
the second shadow position in the first view of the three-dimensional environment is different from the first shadow position in the first view of the three-dimensional environment;
the first simulated shadow at the second shadow position has a second spatial relationship to the first user interface object; and
the second spatial relationship is different from the first spatial relationship.

2. The method of claim 1, including displaying the first simulated shadow at the second shadow position in the three-dimensional environment without changing a size of the first simulated shadow.

3. The method of claim 1, including:
in response to detecting the user input:
displaying the first user interface object at a second object position in the first view of the three-dimensional environment;
wherein:
a degree of change between the first object position and the second object position of the first user interface object is different from a degree of change between the first shadow position and the second shadow position of the first simulated shadow.

4. The method of claim 1, wherein displaying the first simulated shadow at a second shadow position in the three-dimensional environment includes:
when the changing of the orientation of the first user interface object from the first orientation to the second orientation includes rotation of the first user interface object in a first direction, repositioning the first simulated shadow in a third direction corresponding to the first direction; and
when the changing of the orientation of the first user interface object from the first orientation to the second orientation includes rotation of the first user interface object in a second direction that is different from the first direction, repositioning the first simulated shadow in a fourth direction corresponding to the second direction, wherein the fourth direction is different from the third direction.

5. The method of claim 1, wherein displaying the first simulated shadow at a second shadow position in the three-dimensional environment includes:
when the changing of the orientation of the first user interface object from the first orientation to the second orientation includes a first magnitude of rotation of the first user interface object, displaying a first magnitude of change in spatial relationship between the first simulated shadow and the first user interface object; and
when the changing of the orientation of the first user interface object from the first orientation to the second orientation includes a second magnitude of rotation of the first user interface object, displaying a second magnitude of change in spatial relationship between the first simulated shadow and the first user interface object, wherein the second magnitude of rotation is different from the first magnitude of rotation, and the second magnitude of change in spatial relationship is different from the first magnitude of change in spatial relationship.

6. The method of claim 5, wherein changing the orientation of the first user interface object from the first orientation to the second orientation includes transitioning the first user interface object through a plurality of intermediate orientations between the first orientation and the second orientation, and the method includes:
while transitioning the first user interface object through the plurality of intermediate orientations between the first orientation and the second orientation, moving the first simulated shadow through a plurality of intermediate shadow positions in accordance with between the first shadow position associated with the first spatial relationship and the second shadow position associated with the second spatial relationship.

7. The method of claim 1, including:
in response to detecting the user input:
moving the first user interface object from the first object position to a second object position that is different from the first object position.

8. The method of claim 7, wherein changing the orientation of the first user interface object from the first orientation to the second orientation is performed automatically in accordance with the moving of the first user interface object from the first object position to the second object position.

9. The method of claim 1, including:
displaying the first user interface object with the first orientation in accordance with displaying the first user interface object at the first object position at a first distance from a viewpoint of a user; and
changing the orientation of the first user interface object from the first orientation to the second orientation in accordance with displaying the first user interface object at a second distance from the viewpoint of the user, wherein the second distance is different from the first distance.

10. The method of claim 1, wherein:
while the first simulated shadow has the first spatial relationship to the first user interface object with the first orientation, the first simulated shadow is displayed at a respective location relative to the first user interface object; and
while the first simulated shadow has the second spatial relationship to the first user interface object with the second orientation, the first simulated shadow is displayed in front of the respective location relative to the first user interface object.

11. The method of claim 1, wherein the first simulated shadow displayed at the first shadow position has a respective thickness, and the first simulated shadow displayed at the second shadow position has the respective thickness.

12. The method of claim 1, including, in response to detecting the user input, changing an appearance of the first simulated shadow while maintaining display of the first user interface object with the first orientation and at the first object position.

13. The method of claim 12, including:
detecting an end of the user input; and
in response to detecting the end of the user input, at least partially reversing the changing of the appearance of the first simulated shadow while maintaining display of the first user interface object with a respective orientation and at a respective object position.

14. The method of claim 1, wherein the user input directed to the first user interface object includes an air gesture.

15. The method of claim 1, wherein:
prior to detecting the user input directed to the first user interface object, displaying the first simulated shadow at the first shadow position includes:
while attention of a user is not directed to the first user interface object, displaying the first simulated shadow with a first appearance; and
while the attention of the user is directed to the first user interface object, displaying the first simulated shadow with a second appearance that is different from the first appearance.

16. The method of claim 1, including:
prior to detecting the user input directed to the first user interface object, displaying the first simulated shadow at the first shadow position includes displaying the first simulated shadow with a respective appearance; and
while detecting the user input directed to the first user interface object, changing one or more visual properties of the respective appearance of the first simulated shadow, including displaying the first simulated shadow with the changed one or more visual properties of the respective appearance as the first simulated shadow is moved from the first shadow position to the second shadow position.

17. The method of claim 1, including:
detecting an input corresponding to a request to move the first user interface object relative to the three-dimensional environment; and
in response to detecting the input corresponding to the request to move the first user interface object relative to the three-dimensional environment:
moving the first user interface object relative to the three-dimensional environment; and
visually deemphasizing the first simulated shadow corresponding to the first user interface object as a distance between the first user interface object and a respective plane in the three-dimensional environment changes, wherein visually deemphasizing the first simulated shadow includes changing one or more visual properties of the first simulated shadow.

18. The method of claim 17, wherein visually deemphasizing the first simulated shadow includes, in accordance with a determination that the distance between the first user interface object and the respective plane is greater than a threshold distance, ceasing to display the first simulated shadow.

19. A non-transitory computer-readable storage medium storing one or more programs configured to be executed by one or more processors of a computer system that is in communication with a display generation component and one or more sensors, the one or more programs including instructions for:
while a first view of a three-dimensional environment is visible via the display generation component, displaying a first user interface object with a first orientation and at a first object position in the three-dimensional environment, and displaying a first simulated shadow, corresponding to the first user interface object, at a first shadow position in the three-dimensional environment, wherein the first simulated shadow at the first shadow position has a first spatial relationship to the first user interface object;
detecting a user input directed to the first user interface object; and
in response to detecting the user input, changing an orientation of the first user interface object from the first orientation to a second orientation, including:
displaying the first user interface object with the second orientation; and
displaying the first simulated shadow at a second shadow position in the three-dimensional environment, wherein:
the second shadow position in the first view of the three-dimensional environment is different from the first shadow position in the first view of the three-dimensional environment;
the first simulated shadow at the second shadow position has a second spatial relationship to the first user interface object; and
the second spatial relationship is different from the first spatial relationship.

20. A computer system that is in communication with a display generation component and one or more sensors, the computer system comprising:
one or more processors; and
memory storing one or more programs configured to be executed by the one or more processors, the one or more programs including instructions for:
while a first view of a three-dimensional environment is visible via the display generation component, displaying a first user interface object with a first orientation and at a first object position in the three-dimensional environment, and displaying a first simulated shadow, corresponding to the first user interface object, at a first shadow position in the three-dimensional environment, wherein the first simulated shadow at the first shadow position has a first spatial relationship to the first user interface object;
detecting a user input directed to the first user interface object; and
in response to detecting the user input, changing an orientation of the first user interface object from the first orientation to a second orientation, including:
displaying the first user interface object with the second orientation; and
displaying the first simulated shadow at a second shadow position in the three-dimensional environment, wherein:
the second shadow position in the first view of the three-dimensional environment is different from the first shadow position in the first view of the three-dimensional environment;
the first simulated shadow at the second shadow position has a second spatial relationship to the first user interface object; and
the second spatial relationship is different from the first spatial relationship.
